(19) United States
(12) Patent Application Publication
(10) Pub. No.: US 2016/0171537 A1
(43) Pub. Date: Jun. 16, 2016

(54) Systems and Methods for Mapping Advertising Targeting Criteria to User Targets Using Information Aggregated from Multiple Information Sources

(71) Applicant: Connectivity, Inc., Burbank, CA (US)

(72) Inventors: Emad Joseph Fanous, Burbank, CA (US); Matthew D. Booth, Altadena, CA (US)

(73) Assignee: Connectivity, Inc.

(21) Appl. No.: 14/588,256

(22) Filed: Dec. 31, 2014

Related U.S. Application Data
(60) Provisional application No. 62/090,839, filed on Dec. 11, 2014.

(51) Int. Cl. G06Q 30/02

(52) U.S. Cl. CPC G06Q 30/0255

(57) ABSTRACT

Customer Insight (CI) systems in accordance with various embodiments of the invention gather information sets from multiple remote information sources and can merge the information sets to identify authoritative information describing the named entity. In several embodiments, the information sets and/or the authoritative information are identified using geographic location information associated with the information sets. In many embodiments, the CI systems identify relationship information within the merged information sets and use the relationship information to identify customers of businesses. Once identified, merged and/or authoritative information sets describing customers can be used to build customer lists, typical customer profiles, and best customer profiles. In addition, the CI system can utilize information describing customers to automatically generate advertising targeting data and online advertising campaigns.

### CROSS-REFERENCE TO RELATED APPLICATIONS

The present application claims priority under 35 U.S.C. §119(e) to U.S. Provisional Patent Application Ser. No. 62/090,839 entitled “Customer Relationship Management System with Automatic Customer List Generation and Advertising Targeting” filed Dec. 11, 2014. The disclosure of U.S. Provisional Patent Application Ser. No. 62/090,839 is hereby incorporated by reference in its entirety.

### FIELD OF THE INVENTION

The present invention generally relates to customer insight systems, customer list generation, advertising targeting, business reputation management, and generation of automated campaign messages and more specifically to the mapping of location based advertising targets to user targeting data.

### BACKGROUND

Location based advertising is commonly considered to be a form of advertising that integrates mobile advertising with location based services. A location based advertising system can target specific advertisements to users located in specific locations. Common techniques for determining user location include reports of user location obtained from mobile devices that include the capability to determine location, and/or determining location based upon an IP address associated with a user. Location based advertisements can be pushed to users of computing devices in specific locations or can be provided to users of computing devices that express an interest in a specific location (e.g. providing a search query referencing a geographic location to a search engine).

Many leading advertising platforms provide advertisers with Application Programming Interfaces (APIs) that enable advertisers to target advertising to specific segments of an audience accessible via the advertising platform. The ADWORDS advertising platform provided by Google, Inc. of Mountain View, Calif. enables advertisers to target customers based upon geographic locations chosen by an advertiser. Targeting can be performed based upon a customer's physical location, or locations of interest to the customer that can be determined based upon the customer viewing a web page related to a geographic location and/or providing a search query to a search engine related to a specific geographic location. Amongst the targeting options provided by the ADWORDS advertising platform is the ability to target advertisements based upon a customer being located within a radius of a specified geographic location. The ADWORDS advertising platform may serve advertisements based upon an estimated approximate physical location determined using a person's past physical location. Other advertising platforms that have access to audience location information also provide the ability to target advertising based upon the physical location of a user.

### SUMMARY OF THE INVENTION

Customer Insight (CI) systems in accordance with various embodiments of the invention gather information sets from multiple remote information sources and can merge the information sets to identify authoritative information describing the named entity. In several embodiments, the information sets and/or the authoritative information are identified using geographic location information associated with the information sets. In many embodiments, the CI systems identify relationship information within the merged information sets and use the relationship information to identify customers of businesses. Once identified, merged and/or authoritative information sets describing customers can be used to build customer lists, typical customer profiles, and best customer profiles. In addition, the CI system can utilize information describing customers to automatically generate advertising targeting data and online advertising campaigns.

One embodiment of the method of the invention includes receiving information using the customer insight system, where the received information includes: advertising targeting information defining at least one targeting criterion; and information identifying a specific service configured to present programmatic advertisements targeted toward individual users of the service that are identified using user identifiers. In addition, the method includes: merging information sets gathered by a customer insight system from multiple remote information sources to create merged information sets for given named entities, where the merged information sets are associated with specific named entities in a customer database maintained by the customer insight system, where the merged information sets associated with a specific named entity in the customer database include characteristic data describing the specific named entity and the characteristic data includes user identifiers for users of the specific service; identifying, using the customer insight system, named entities in the customer database satisfying the at least one targeting criterion; retrieving characteristic data describing the named entities in the customer database identified as satisfying the at least one targeting criterion using the customer insight system; determining at least one user identifier for a user of the specific service from the retrieved characteristic data using the customer insight system; and generating user targeting data for an online advertising campaign on the specific service based upon the at least one user identifier for a user of the specific service using the customer insight system.

In a further embodiment, retrieving characteristic data describing the named entities in the customer database includes retrieving characteristic data describing at least one user identifier for a user of the specific service selected from the group consisting of: a user identity on a service associated with one of the identified named entities; a mobile phone number associated with one of the identified named entities; and an email address associated with one of the identified named entities.

In another embodiment, generating user targeting data for an online advertising campaign on the specific service using the at least one user identifier for a user of the specific service includes generating at least one piece of user targeting data selected from the group consisting of: a user identity on the service, a user ID, a value generated using a mobile phone number associated with one of the identified named entities; and a value generated using an email address associated with one of the identified named entities.

In a still further embodiment, the at least one targeting criterion includes a location criterion identifying a specific location. In addition, characteristic data describing named entities in the customer database includes geographic location information, and identifying named entities in the customer database satisfying the location criterion includes identifying relationships between named entities in the customer database and the specific location based upon the merged information sets for a particular named entity including characteristic data including geographic location information corresponding to the specific location.

In still another embodiment, the geographic location information is at least one piece of geographic location information selected from the group consisting of: a country, a state, a residential address, an employment address, a ZIP code, an IP address, a Global Positioning System measurement, cell tower IDs, a list of MAC addresses for WIFI access points, a geocode, a location history reported by a mobile device, a location history associated with a MAC address used by a mobile device, registering at a specific location via a location based service, a search query related to a specific location, a search query bounded to a specified geographic location, a navigation request, a transportation record generated by a shared ride service, a transaction record associated with a specific geographic location and a URL corresponding to a specific geographic location.

In a yet further embodiment, identifying relationships between named entities in the customer database and the specific location further includes identifying named entities in the customer database that are likely to be present at the specific location at a future time using the customer insight system.

In yet another embodiment, identifying named entities in the customer database that are likely to be present at the specific location at a future time includes: retrieving characteristic data describing residential addresses of the identified named entities from the customer database; retrieving characteristic data describing geographic location information indicating locations of the identified named entities from the customer database at times within a specific time period; identifying named entities from the customer database as having a relationship with the specific location when at least on condition is satisfied from the group consisting of: a residential address of a named entity corresponds to the specific location; and the geographic location information indicates that a named entity was located within the specific location during the specific time period.

In a further embodiment again, the at least one targeting criterion includes a demographic criterion identifying a specific demographic. In addition, the characteristic data describing named entities in the customer database includes demographic information; and identifying named entities in the customer database satisfying the demographic criterion includes: retrieving characteristic data describing demographic information concerning specific named entities from the customer database; and identifying specific named entities that are within the specific demographic based upon the retrieved characteristic data.

In another embodiment again, the characteristic data describing demographic information concerning specific named entities retrieved from the customer database includes characteristic data describing at least one characteristic of a named entity selected from the group consisting of language, age, and gender.

In a further additional embodiment, the characteristic data describing demographic information concerning specific named entities retrieved from the customer database includes characteristic data describing at least one interest of a named entity.

In another additional embodiment, the at least one targeting criterion includes a keyword criterion identifying a specific keyword. In addition, characteristic data describing named entities in the customer database includes at least one keyword, and identifying named entities in the customer database satisfying the keyword criterion includes identifying specific entities that are described by characteristic data that includes the specific keyword.

In a still yet further embodiment, the characteristic data that includes the specific keywords includes characteristic data selected from the group consisting of characteristic data having values describing interests of the identified named entities; and characteristic data having values describing activities performed by the identified named entities.

In still yet another embodiment, identifying named entities in the customer database satisfying the at least one targeting criterion further includes filtering named entities in accordance with at least one filtering criterion.

In a still further embodiment again, the at least one filtering criterion is selected from the group consisting of a score, an average transaction value, a transaction frequency, and a residential address.

In still another embodiment again, merging information sets gathered by a customer insight system from multiple remote information sources to create merged information sets for given named entities includes: obtaining at least one initial piece of identifying information for a given named entity using the customer insight system; and building an identifying information set based on the at least one initial piece of identifying information using the customer insight system by gathering additional identifying information that describes characteristics of the given named entity from a plurality of information sources, where the identifying information set includes geographic location information. In addition the merging of information sets includes repeatedly: querying a plurality of remote information sources using the customer insight system, where queries provided to the plurality of remote information sources contain at least the geographic location information included in the identifying information set; receiving at least one information set from the plurality of remote information sources using the customer insight system, where the at least one received information set includes characteristic data describing at least the given named entity and the characteristic data includes geographic location information; and merging at least a subset of the received at least one information set with the identifying information set for the given named entity to create merged information sets for the given named entity that are stored in the feeds database using the customer insight system, where the customer insight system merges at least one given information set with the identifying information set for the given named entity based upon a comparison of geographic location information included in the at least one given information set and geographic location information included within the identifying information set.

In a still further additional embodiment, merging information sets gathered by a customer insight system from multiple remote information sources to create merged information sets for given named entities further includes: selecting characteristic data from the merged information sets to be used in an authoritative information set for the given named entity using the customer insight system, where the customer insight system selects at least one piece of characteristic data as part of an authoritative information set based upon at least one factor including a comparison of geographic location information associated with each of a plurality of different pieces of characteristic data that provide conflicting descriptions of a specific characteristic of the given named entity; and storing the authoritative information set in a production database using the customer insight system, wherein the production database stores authoritative information sets for a plurality of named entities generated using the merged information sets for the plurality of named entities maintained in the feeds database.

In still another additional embodiment, the customer insight system selects at least one piece of characteristic data as part of the authoritative information set based upon at least one factor including: counting the number of times a characteristic data value is repeated within the merged information sets for the given named entity using the customer insight system; and weighting the counts of the number of times a characteristic data value is repeated within the merged information sets for the given named entity based upon scores of the relative reliability of remote information sources of the characteristic data within the merged information sets using the customer insight system, where the customer insight system maintains and updates the scores of the relative reliability of remote information sources over successive query operations.

In a yet further embodiment again, the customer insight system merges at least one given information set with the identifying information set for the given named entity based upon a comparison of geographic location information included in the at least one given information set and geographic location information included within the identifying information set by: determining at least one distance between the geographic location information included in the at least one given information set and the geographic location information included within the identifying information set using the customer insight system; and comparing the determined at least on distance to a threshold for merging information sets using the customer insight system.

In yet another embodiment again, determining at least one distance using the customer insight system includes generating geographic coordinates from the geographic location information included in the at least one given information set and the geographic location information included within the identifying information set.

In a yet further additional embodiment, the identifying information set includes at least one name, at least one address, and at least one phone number for the given named entity.

In yet another additional embodiment, the geographic location information included in the identifying information set includes at least one piece of information selected from the group consisting of an address, a geographic coordinate, a latitude and longitude coordinate pair, and relative location information.

In a further additional embodiment again, selecting characteristic data from the merged information sets to be used in the authoritative information set further includes selecting a first piece of characteristic data from a first information set received from a first remote information source and a second piece of characteristic data describing a different characteristic of the given named entity from a second remote information source using the customer insight system.

In another additional embodiment again, the feeds database and the production database include named entity type definitions for different types of entities; and each type definition include a base set of characteristic data fields.

In another further embodiment, the named entity type definitions include at least one named entity type definition selected from the group consisting of a business named entity, a person named entity, a location named entity, a customer entity, an event entity, a brand entity, and an object named entity.

In still another further embodiment, the remote information sources include at least one remote information source selected from the group consisting of a search engine service, an online directory, a review website, a website, a server log, an email service, a messaging service, and a social media service.

In yet another further embodiment, the merged information sets of a given named entity in the feeds database include at least one piece of information selected from the group consisting of: scrapes of web pages containing descriptions of a named entity; email messages obtained from email accounts associated with a named entity; phone logs for telephone accounts associated with a named entity; reviews associated with a named entity; checkins via location based social media services; likes, follows, and/or followers of user identities on social media services associated with a named entity; mentions of a named entity in posts to social media services; mobile application data from mobile devices associated with a named entity; and server logs of servers associated with a named entity.

In another further embodiment again, the at least one targeting criterion includes a plurality of targeting criteria selected from the group consisting of a location criterion, a demographic criterion, and a keyword criterion.

Another further additional embodiment also includes outputting the user targeting information as part of an online advertising campaign built using the customer insight system to at least one advertising network selected from the group consisting of a display advertising network, a search advertising network, a social media service advertising network, and a location based advertising network using the customer insight system.

A customer insight system in accordance with an embodiment of the invention includes: at least one processing unit; and a memory storing a customer insight application. In addition, the customer insight application directs the at least one processing unit to receive information including: advertising targeting information defining at least one targeting criterion; and information identifying a specific service configured to present programmatic advertisements targeted toward individual users of the service that are identified using user identifiers. The customer insight application also directs the at least one processing unit to: merge information sets gathered from multiple remote information sources to create merged information sets for given named entities, where the merged information sets are associated with specific named entities in a customer database, where the merged information sets associated with a specific named entity in the customer database include characteristic data describing the specific named entity and the characteristic data includes user identifiers for users of the specific service; identify named entities in the customer database satisfying the at least one targeting criterion; retrieve characteristic data describing the named entities in the customer database identified as satisfying the at least one targeting criterion; determine at least one user identifier for a user of the specific service from the retrieved characteristic data; and generate user targeting data for an online advertising campaign on the specific service based upon the at least one user identifier for a user of the specific service.

### BRIEF DESCRIPTION OF THE DRAWINGS

FIG. 1 is a network diagram illustrating a customer insight (CI) system in accordance with an embodiment of the invention.

FIG. 2A is a flow chart illustrating a process for building an advertising campaign using a CI system in accordance with an embodiment of the invention.

FIG. 2 is a flow chart illustrating a high level process for implementing a CI system in accordance with an embodiment of the invention.

FIG. 3 is a conceptual illustration of a CI system in accordance with an embodiment of the invention.

FIG. 4 is a flow chart illustrating a process for gathering business information in accordance with an embodiment of the invention.

FIG. 5 is a flow chart illustrating a process for gathering consumer information in accordance with an embodiment of the invention.

FIG. 6 is a flow chart illustrating a process for gathering transaction information in accordance with an embodiment of the invention.

FIG. 7 is a flow chart illustrating a process for gathering information on things, events, and/or locations in accordance with an embodiment of the invention.

FIG. 8 is a flow chart illustrating a process for merging information sets in accordance with an embodiment of the invention.

FIG. 9 is a conceptual illustration demonstrating an example of merging information sets in accordance with an embodiment of the invention.

FIG. 10 is a flow chart illustrating a process for merging information sets using geographic location information in accordance with an embodiment of the invention.

FIG. 11 is a conceptual illustration demonstrating an example of merging information sets using geographic location information in accordance with an embodiment of the invention.

FIG. 12 is a flow chart illustrating a process for generating authoritative information sets for entities in accordance with an embodiment of the invention.

FIG. 13 is a conceptual illustration demonstrating an example of generating an authoritative information set from several merged information sets in accordance with an embodiment of the invention.

FIG. 14 is a flow chart illustrating a process for generating and scheduling batches of crawls for information that take into account received input from other CI system operations in accordance with an embodiment of the invention.

FIG. 15 is a flow chart illustrating a process for identifying relationships between entities in accordance with an embodiment of the invention.

FIG. 16 is a flow chart illustrating a process for identifying current and/or potential customers in accordance with an embodiment of the invention.

FIG. 17 is a flow chart illustrating a process for generating advertising targeting data in accordance with an embodiment of the invention.

FIG. 18 conceptually illustrates a user interface that enables a user to access a customer profile of a customer of a business in accordance with an embodiment of the invention.

FIG. 19A conceptually illustrates a flow chart illustrating a process for generating typical customer profiles in accordance with an embodiment of the invention.

FIG. 19B conceptually illustrates a user interface that includes a customer analysis page showing a typical customer profile in accordance with an embodiment of the invention.

FIG. 20 conceptually illustrates a user interface that includes a map view within a customer analysis page in accordance with an embodiment of the invention.

FIG. 20A is a flow chart that conceptually illustrates a process for scoring customers of businesses in accordance with an embodiment of the invention.

FIG. 20B is a screen shot that illustrates an example of a customer list interface that presents scores and limited summaries of customers of a customer list.

FIG. 20C is a flow chart that conceptually illustrates a process for estimating transaction values of customer interactions in accordance with an embodiment of the invention.

FIG. 20D is a screen shot that illustrates a customer analytics overview that includes an aggregated transaction indicator.

FIG. 21 conceptually illustrates a user interface that includes an automated campaign message generation interface in accordance with an embodiment of the invention.

FIG. 21A is a flow chart conceptually illustrating a process for generating demographic targeting data using a CI system in accordance with an embodiment of the invention.

FIG. 21B is a flow chart conceptually illustrating a process for generating location targeting data using a CI system in accordance with an embodiment of the invention.

FIG. 21C is a flow chart conceptually illustrating a process for generating user targeting data using a CI system in accordance with an embodiment of the invention.

FIG. 21D is a flow chart conceptually illustrating a process for generating keyword targeting data that targets specific interests expressed by users of a service using a CI system in accordance with an embodiment of the invention.

FIG. 21E is a flow chart conceptually illustrating a process for generating keyword targeting data that targets users of a service that are expressing interest in a competing business using a CI system in accordance with an embodiment of the invention.

FIG. 21F is a flow chart conceptually illustrating a process for automatically generating an advertising campaign for a business using posts published by a user of a service that are related to the business using a CI system in accordance with an embodiment of the invention.

FIG. 21G is a flow chart illustration a process for mapping advertising targeting criteria to user targeting data on specific services that provide the ability to present programmatic advertisements targeted to individual users of the service in accordance with an embodiment of the invention.

FIG. 21H is a flow chart illustration a process for identifying named entities that match a location criterion and generating user targeting data that targets the identified named entities in accordance with an embodiment of the invention.

FIG. 21I is a flow chart illustration a process for predicting whether a named entity is likely to be present within a targeted geographic location in accordance with an embodiment of the invention.

FIG. 21J is a flow chart illustration a process for comparing the similarity of location histories in accordance with embodiments of the invention.

FIG. 21K is a flow chart illustration a process for determining user targeting data based upon characteristic data describing a targeted named entity in accordance with an embodiment of the invention.

FIG. 22 conceptually illustrates a user interface with a business listing review interface in accordance with an embodiment of the invention.

FIG. 23A conceptually illustrates a user interface with a business listing correction interface in accordance with an embodiment of the invention.

FIG. 23B conceptually illustrates a flow chart illustrating a process for correcting business listing information in accordance with an embodiment of the invention.

FIG. 24 conceptually illustrates a user interface with a business listing review interface after correction of business listings in accordance with an embodiment of the invention.

FIG. 25 conceptually illustrates a user interface with a reputation management interface in accordance with an embodiment of the invention.

FIG. 26 conceptually illustrates a user interface with a customer feedback interface in accordance with an embodiment of the invention.

FIG. 27 conceptually illustrates an architecture of a scheduler process server in accordance with an embodiment of the invention.

FIG. 28 conceptually illustrates an architecture of a crawler process server in accordance with an embodiment of the invention.

FIG. 29 conceptually illustrates an architecture of a merge process server in accordance with an embodiment of the invention.

FIG. 30 conceptually illustrates an architecture of a production process server in accordance with an embodiment of the invention.

FIG. 31 conceptually illustrates an architecture of a relation process server in accordance with an embodiment of the invention.

FIG. 32 conceptually illustrates an architecture of a web server in accordance with an embodiment of the invention.

FIG. 33 conceptually illustrates an architecture of a customer process server in accordance with an embodiment of the invention.

FIG. 34 conceptually illustrates an architecture of a targeting process server in accordance with an embodiment of the invention.

### DETAILED DESCRIPTION

Turning now to the drawings, customer relationship management (CRM) systems and/or customer insight (CI) systems configured to automatically generate advertising targeting information by advertising targeting criterion to user targets on specific services in accordance with embodiments of the invention are illustrated. The CI systems of several embodiments gather information concerning named entities including the user identities of consumers on different online services including (but not limited to) social media services, email services, and/or messaging services. In a number of embodiments, a CI system can use information gathered concerning named entities to automatically generate advertising targeting data and/or an advertising campaign targeting user of specific services. In certain embodiments, the targeting criteria include (but are not limited to) demographic criteria, location criteria, and/or keyword criteria.

Specific combinations of advertising targeting data can be generated by the CI system and utilized to generate campaigns for different types for advertising networks. For example, demographic, location, and/or keyword targeting data can be generated by the CI system from information gathered about consumers and utilized to generate targeted search advertising campaigns. Similarly, demographic, location, and/or keyword targeting data can be generated and utilized to create display advertising campaigns. In several embodiments, demographic, location and/or keyword targeting data can be generated and utilized to create social media advertising campaigns. CI systems can also be utilized to generate specific user targeting information that can be used to generate advertising campaigns for advertising networks that can target advertising to specific users of a service (e.g. social media services, and/or email services). In many embodiments, location targeting data can be generated to assist with the targeting of location based advertising campaigns. In several embodiments, the CI system can identify a specific service that a customer has utilized to interact with a business and utilize the same service to deliver an advertising message to the customer. As can readily be appreciated, the specific advertising targeting data utilized in the generation of an advertising campaign typically depends upon the capabilities that a specific advertising network has to target advertising. In a number of embodiments, CI systems can develop multiple advertising campaigns that are provided by multiple advertising networks to target users of different services and/or based upon different targeting criterion appropriate to each of the advertising networks. Various processes that can be performed by a CI system in the automatic generation of an advertising targeting data and/or advertising campaigns include (but are not limited to) the automated generation of customer lists, building profiles for typical customers of businesses, generation of advertising targeting information, and/or automated generation of campaign messages for identified customers of businesses. In order to enable these and additional functionalities, CI systems in accordance with several embodiments of the invention gather information from information sources, merge the gathered information, and relate merged information sets for businesses and consumers.

In many embodiments, the CI systems gather information from information sources on named entities including (but not limited to) consumers, businesses, transactions, locations, and things. The information sources can include (but are not limited to) websites, consumer devices, public directories, domain registrations, public records, merchant terminals, merchant-run or third-party loyalty programs, and additional sources that are discussed below. The gathered information can include (but is not limited to) attribute values for names, addresses, phone numbers, reviews, connections, dates, purchases, sales, and/or prices associated with entities. The gathered information can also include social media postings by consumers. In addition, CI systems in accordance with several embodiments of the invention can collect information regarding the transactions between consumers and businesses. CI systems can also perform further operations on the gathered consumer, business, and/or transaction information to produce insights into customers of businesses.

In several embodiments the CI systems merge gathered information sets according to the sets' similarity to particular consumers or businesses. When several sets of information gathered from information sources are similar enough that they can be said to refer to the same person or business, the CI systems can merge the several sets of information. For example, the CI systems can merge information sets from several social media profiles where they pass certain thresholds of similarity. The CI systems can also merge information sets from several online directories that contain listings that are determined to refer to the same business.

In a number of embodiments, CI systems can use geographic coordinates (referred to herein as “geocodes”) to assist in merging information sets, relating information sets, and/or other information management operations. For instance, where an information source provides an address, or where the information includes location metadata, a CI system can convert these addresses or location metadata into geographic coordinates. The geocodes can be used to assess whether information sets refer to the same location, or whether a consumer is interacting with a business. In some embodiments, geocodes correspond to latitude and longitude. In other embodiments, any of a variety of representations of geographic location information appropriate to the requirements of specific applications can be utilized for the encoding of geocodes.

In various embodiments, CI systems generate authoritative information sets from merged sets of information. An authoritative information set is a CI system's most accurate description of a named entity (e.g., the correct name, address, and phone number of a business or a consumer). The authoritative information set can also be the information set with the most complete description of the named entity including data aggregated from all of the merged information sets. CI systems can generate authoritative information sets using several techniques. In multiple embodiments, CI systems rate information sources for accuracy and size. A CI system can also consider how many times pieces of information are repeated across information sources (e.g., when multiple information sources provide the same name, address, or phone number for a consumer or business). In addition, CI systems can balance the ratings of sources against the repetition of information across sources. For instance, a CI system may select a piece of information that is repeated relatively infrequently, where the piece of information comes from a particularly trustworthy source. Based on at least one of the above described techniques, a CI system can identify an authoritative information set for a given named entity.

In several embodiments, CI systems dynamically update merged and authoritative information sets in response to queries for information. When a CI system receives a query for information, the CI system can respond by presenting the most up to date information from the merged and/or authoritative information sets. CI systems in accordance with certain embodiments of the intervention also update scheduled gathering of information to include specific crawling operations for information associated with received user queries. The crawls themselves can be performed using any of a variety techniques including (but not limited to) populating a set of URL templates with appropriate keywords drawn from a user query and/or additional characteristic data discovered by crawls executed in response to a user query. For instance, when users query for listings of businesses, a CI system can present listings from merged information sets associated with the queried business and also update the continuous gathering of information to include specific crawls for any updated information related to the businesses identified by the queries.

When used herein, the term “information set” can include structured data and/or unstructured data as required for varying embodiments of the invention. Information sets that include structured data can include elements that are tagged and/or parsed into specific fields. As an example, an authoritative information set for a person can include data parsed into specific fields, such as (but not limited to) name, address, phone number, and/or various status flags. Unstructured data can include freeform text and/or keywords. For instance, a merged information set for a business can include several keywords that trigger search hits for the business's name but are stored in an unstructured manner. Some embodiments include parsing operations to convert free form information into a structured information set. Such parsing operations may be performed as part of information gathering and/or crawling operations. Moreover, information sets can be the output of processes in accordance with embodiments of the invention, such as during parsing operations. Alternatively, information sets can be the input to processes in accordance with embodiments of the invention, such as during merging and/or authoritative information set generation. Different embodiments can use unstructured and/or structured information sets as inputs and/or outputs to varying processes and/or operations.

In multiple embodiments, CI systems relate merged and authoritative information sets for businesses and consumers. By relating the information sets, the CI systems can identify customers of businesses. In many embodiments, gathered transaction information can also be used to identify that a consumer has become a customer of a business. Additional sources of relationship data can include loyalty programs, point of sale systems, advertising network data, call tracking lines, phone records, emails between entities, and electronic contacts. Alternatively, or in addition to using transaction information, CI systems can compare geocodes generated from consumer and business information to identify when a consumer has become a customer of a business. For example, CI systems can use metadata within social media postings by consumers to identify when consumers have visited and/or transacted within the premises of businesses. Additionally, techniques similar to those used to merge information sets belonging to the same named entity can be used to relate information sets belonging to different entities. Establishing relationships between consumers and businesses can enable CI systems in accordance with a number of embodiments of the invention to provide powerful analytic functionalities.

In various embodiments, CI systems can use related information sets, merged information sets, and/or authoritative information sets to generate customer lists for businesses. The CI systems can present customer lists to users through web interface(s) or a phone or tablet “mobile” app. Customer lists can also be used in conjunction with other functionalities provided by the CI systems, such as linking customer lists with customer profiles generated from information sets.

In many embodiments, CI systems can produce customer profiles for consumers based on their interactions with businesses. The customer profiles can contain information including (but not limited to) transaction histories, various spending ratings, and/or demographic details regarding a customer. When used in conjunction with the automated customer lists, the customer profiles can enable a CI system to generate targeted advertising information for use in advertising networks. In addition, CI systems can also analyze the profiles of customers of a specific business in order to generate a typical customer profile(s) for the business. A typical customer profile can include information such as (but not limited to) geographic location, demographic information, and/or financial and economic data for the typical customer of the business and/or the profile of the typical best customer of the business. In some embodiments, the typical customer profile can also include but is not limited to one or more of the following pieces of information: gender balance, home ownership rates, education levels, annual household income, relationship status, number of children for the typical customer of the business, interests, and/or proximity to business from either home or work. The typical customer profiles can further be used in performing look-alike advertising targeting and/or 1:1 advertising targeting that leverages the known information about customers of a business to find potential or existing customers. By targeting a businesses' best customers, the CI system can increase the frequency with which the best customers patronize the business.

In various embodiments, CI systems use customer profile data to generate maps indicating geographic concentrations of a business's customers. A CI system can use the association between a customer list and the underlying geographic data from the merged and/or authoritative information sets for consumers to identify geographic concentrations of customers. In several embodiments, CI systems can generate automated campaign messages for use in marketing campaigns to customers identified in the automated customer lists based on triggers or characteristics of the customers. These automated campaign messages can be targeted toward customers that, for example, have not transacted with a business for a period of time (a trigger) or to customers that fit certain segmentation rules (characteristics). The automated campaign messages are directed to customers using interfaces provided by the CI systems. The automated campaign messages are transmitted through the interfaces of the CI systems to various channels including (but not limited to) social media sites, Internet messengers, and/or emails. However, customers often do not wish to be sent messages on channels on which they have not interacted with a business. The CI systems of many embodiments restrict the transmission of automated campaign messages based on the interactions customers have had with businesses. The CI systems of these embodiments can limit transmission of automated campaign messages to channels on which customers have interacted with businesses (e.g., only sending a message over a social media website when a customer has interacted with a business on the social media website). Additional types of automated campaign messages and conditions for their generation are discussed below.

CI systems in accordance with a number of embodiments of the invention may not expose all of the information the CI systems have gathered. CI systems can gather more information than the users of the CI systems have rights to access. Often, the users of the CI systems are merchants seeking information on customers associated with businesses. Merchant users often do not have rights to access certain otherwise public information gathered by the CI systems. For instance, minors may post information to social media websites, but sharing of information associated with minors is restricted in many legal jurisdictions. Accordingly, CI systems can restrict access to certain gathered information in order to comply with legal requirements and to respect other privacy considerations. In addition, the CI systems can comply with any legal requirements placed upon the gathering and storing of information in the legal jurisdictions in which they are implemented.

Having discussed a brief overview of the operations and functionalities CI systems in accordance with many embodiments of the invention, a more detailed discussion of system and methods for CI systems in accordance with embodiments of the invention follows below.

### Network Architectures for Customer Insight Management Systems

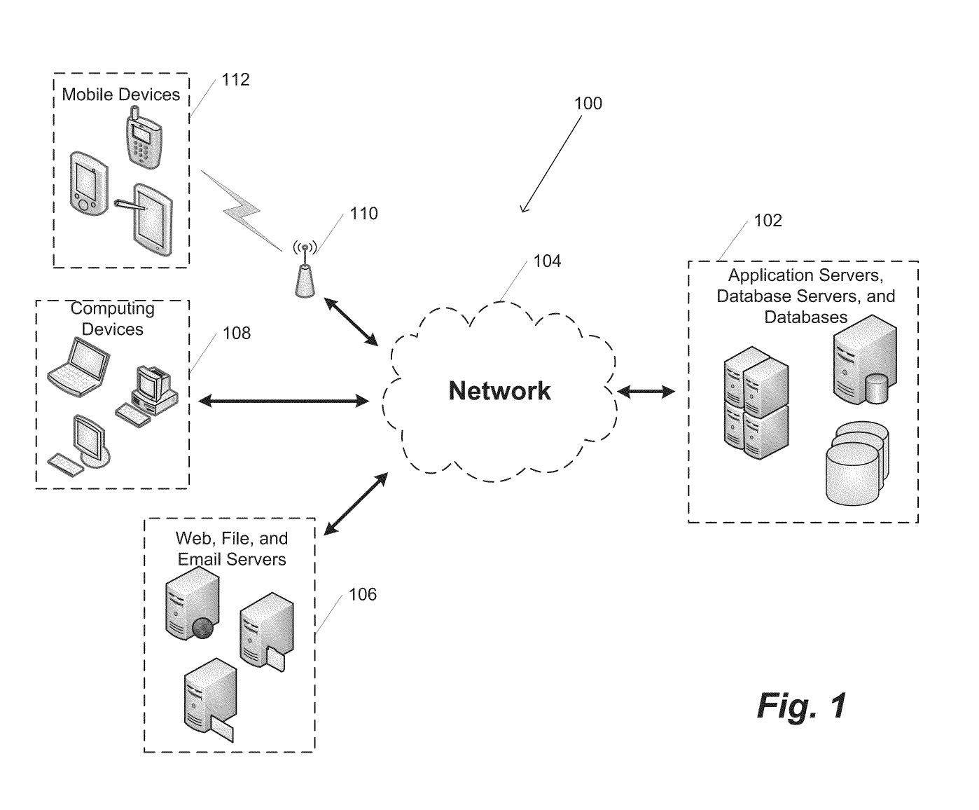

A network architecture for a customer insight system for gathering, relating, and presenting business and consumer information in accordance with an embodiment of the invention is illustrated in FIG. 1. System 100 includes a CI management system 102 that includes application servers, database servers, and databases. The CI management system 102 can communicate over network 104 with several groups of devices in order to acquire, relate, and present information. The groups of devices include (but are not limited to) web, file, and/or email servers 106, computing devices 108, and/or mobile devices 112. These groups of devices can serve as both information sources and points of user contact. For instance, a web server from web, file, and/or email servers 106 can serve an information source for CI management system 102 while a computing device 108 can serve as a terminal from which a merchant can make queries to the CI management system 102. Merchants (i.e., owners of businesses) are one class of users of a CI management system 102 in accordance with embodiments of the invention. Merchants can interact with CI management system 102 to access gathered, related, and presented information. In other embodiments, a CI system can support other classes of users including (but not limited to) administrators, analyzers, advertising campaign managers, and/or consumers.

As illustrated in FIG. 1, CI management system 102 includes application servers, database servers, and databases. In various embodiments, CI management system 102 can include varying numbers and types of devices. For instance, CI management system 102 can be implemented as a single computing device where the single computing device has sufficient storage, networking, and/or computing power. However, CI management system 102 may also be implemented using multiple computing devices of various types and multiple locations. While CI management system 102 is shown including application servers, database servers, and databases, a person skilled in the art will recognize that the invention is not limited to the devices shown in FIG. 1 and can include additional types of computing devices (e.g., web servers, and/or cloud storage systems).

In the embodiment illustrated in FIG. 1, network 104 is the Internet. CI management system 102 communicates with mobile devices 112 through network 104 and over a wireless connection 110. Wireless connection 110 can be (but is not limited to) a 4G connection, a cellular network, a Wi-Fi network, and/or any other wireless data communication link appropriate to the requirements of specific applications. CI management system 102 communicates directly with computing devices 108 and web, file, and/or email servers 106 through network 104. Other embodiments may use other networks, such as Ethernet or virtual networks, to communicate between devices. A person skilled in the art will recognize that the invention is not limited to the network types shown in FIG. 1 and can include additional types of networks (e.g., intranets, virtual networks, mobile networks, and/or other networks appropriate to the requirements of specific applications).

In many embodiments, CI management system 102 can gather information from information sources over network 104. These information sources include web, file, and/or email servers 106, computing devices 108, and/or mobile devices 112. Web, file, and/or email servers 106 can include numerous source types, such as (but not limited to) newspaper websites, social media websites, social network websites, blogs, vertical information sites, travel guides, local search sites, internet yellow pages, entertainment guides, city guides, radio websites, television station websites, best of websites, business databases, consumer databases, consumer directory sites, marketing sites, deal and offer websites, coupon sites, coupon applications, general search engines, online encyclopedias, events sites, community sites, specialty websites, corporate websites, magazines, shopping sites, ecommerce sites, classifieds, phone number directories, domain directories, specially marked up sites, opt-in single sign on sites, social aggregation sites, music websites, TV websites, movie sites, social bookmarking sites, discussion sites, APIs, photo sharing sites, social sharing sites, review sites, app directories, app review sites, job listings, business card sites, personal websites, business websites, voicemail recordings converted to text, reverse picture lookups and matching services and websites, instant messaging lookup and/or directory sites, real estate information sites, Q&A sites, digital content stores, political and/or campaign information sites, check-in sites and/or apps, and/or mobile apps. Web, file, and/or email servers 106 can also include any addressable IP location or URL that contains consumer or business information.

Computing devices 108 include end machines (e.g., desktop computers, laptop computers, and/or virtual machines) that contain or provide consumer or business information. CI management system 102 may receive information from these machines via an email or may request this information directly where a consumer agrees to provides the information. Computing devices 108 can also serve as an information source in a similar manner to those listed above with respect to web, file, and/or email servers 106.

Mobile devices 112 are devices (e.g., cellular phones, laptop computers, smart phones, and/or tablet computers) that can contain or provide information. Mobile devices 112 typically provide richer geographic location information than computing devices 108 or web, file, and/or email servers 106 as many mobile devices 112 include Global Position System (GPS) hardware (e.g., a GPS receiver and/or a GPS antenna). In addition, information gathered from mobile devices often has metadata tags with geocodes that reveal, for instance, where a picture received from a mobile device was taken. In several embodiments, CI management system 102 can take advantage of the rich information provided by mobile devices 112 in order to relate consumer information to business information. For instance, the CI management system 102 can use the GPS data provided by the mobile devices to identify that a consumer has transacted with a business.

Although a specific architecture is shown in FIG. 1, different architectures involving electronic devices and network communications can be utilized to implement CI systems to perform operations and provide functionalities in accordance with embodiments of the invention. The manner in which information gathered and merged by CI systems can be utilized to automatically generate advertising targeting data, advertising creatives and/or build online advertising campaigns in accordance with various embodiments of the invention is discussed below.

### Building Advertising Campaigns

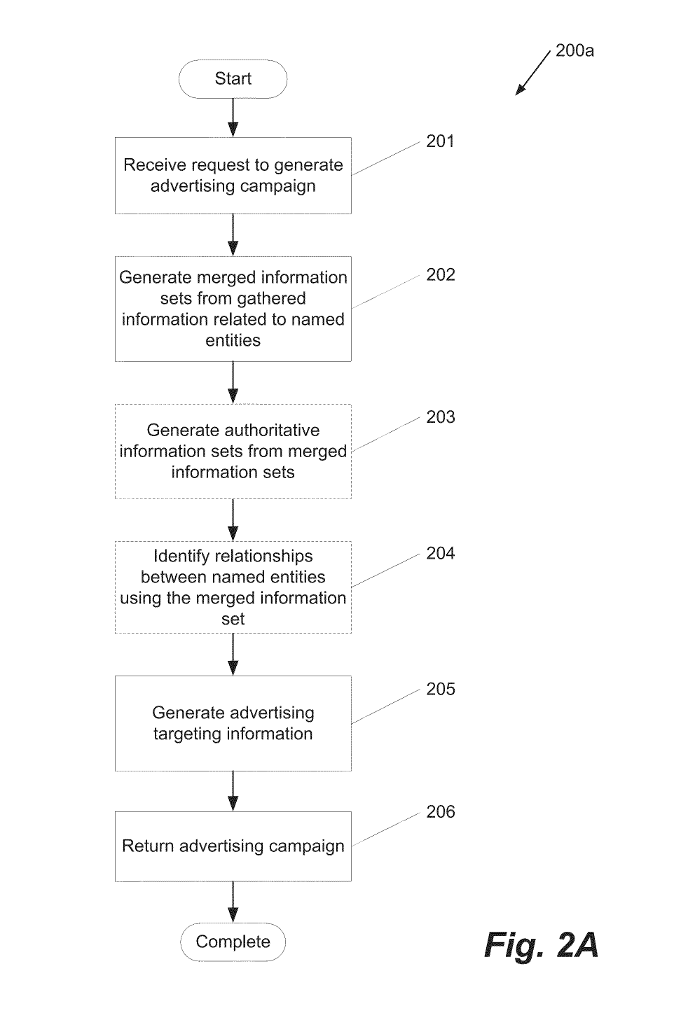

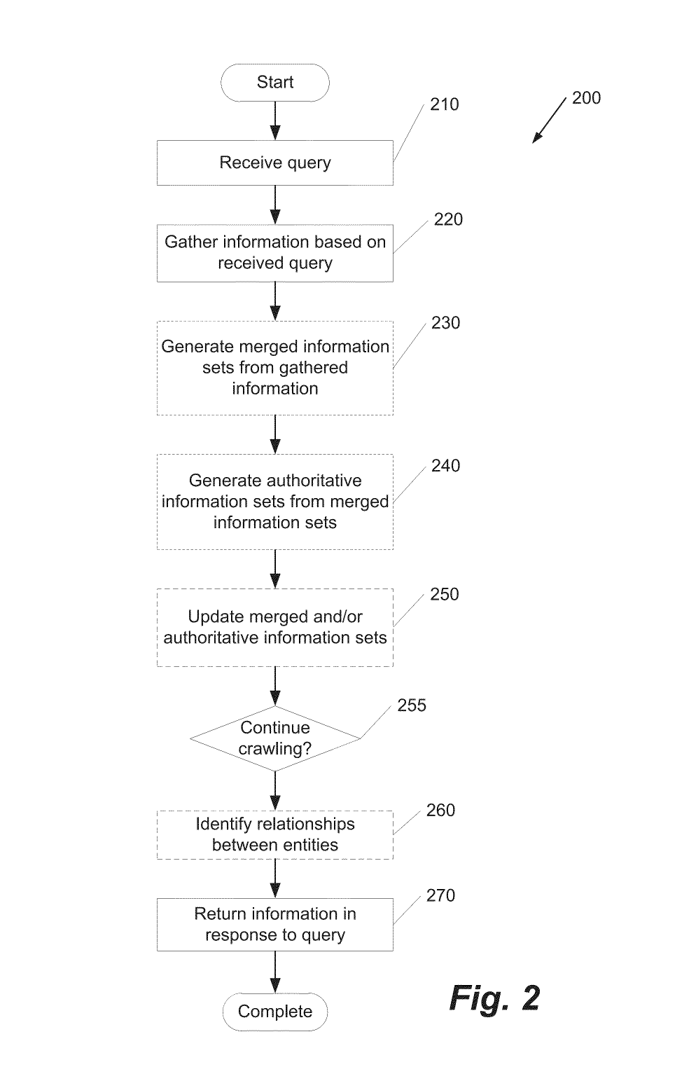

A process for building an advertising campaign using a CI system in accordance with an embodiment of the invention is illustrated in FIG. 2A. The process 200a includes receiving (201) a request to generate an advertising campaign. The request may involve building a campaign with respect to a specific named entity and/or may include targeting criteria. The request may also identify specific services on which a user wishes to conduct an advertising campaign. Where the request includes a reference to a specific named entity, the named entity is typically a named entity in the feeds database corresponding to a specific business. However, advertising campaigns can be generated with respect to any named entity for which merged information sets and/or authoritative information is contained within the CI system that describes relationships between the named entity and other named entities. Targeting criteria can include (but are not limited to) location targeting criteria (e.g. specific ZIP codes and/or cities) demographic targeting criteria, and/or keyword targeting criteria. A single type of targeting criterion can be provided and/or combinations of different types of targeting criterion can be provided. Where targeting criteria are provided, the CI system maps the targeting criteria to user targeting data with respect to specific services using merged information sets and/or authoritative information sets contained within the CI system concerning named entities corresponding to individual consumers.

In many instances, merged information sets are gathered (202) with respect to the named entity that is the subject of the advertising campaign and/or the named entities that are the targets of the advertising campaign and an authoritative information set may be (optionally) generated (203) from the merged information sets with respect to each of the named entities. Merging processes are typically performed to update the merged information sets related to the named entities. However, many CI systems in accordance with embodiments of the invention separate gathering and merging information sets and the generation of advertising targeting data.

Relationships between the named entity that is the subject of the advertising campaign and/or named entities that are the targets of the campaign and other named entities are (optionally) identified (204). In many instances, the identified relationships are relationships between named entities corresponding to customers of the business that is the subject of the advertising campaign. However, CI systems can be configured to identify relationships between any of a variety of different types of named entities as appropriate to the requirements of specific applications including relationships between businesses and relationships between consumers/customers.

Advertising targeting data is automatically generated (205) using characteristic data in the merged and/or authoritative information sets describing the named entities. As discussed further below, CI systems can generate any of a variety of advertising targeting data including (but not limited to) demographic targeting data, location targeting data, user targeting data, and keyword targeting data. In many embodiments, the CI system generates user targeting data based upon provided targeting criterion. The generation of specific types of targeting data and the use of combinations of different types of targeting data in different advertising campaigns in accordance with embodiments of the invention is discussed further below.

In addition to generating advertising targeting data, CI systems can facilitate the building of complete programmatic advertising campaigns. In many embodiments, the CI system can automatically generate creatives from data in the merged and/or authoritative information sets describing the named entities corresponding to a business, its customers, and/or its potential customers. In several embodiments, content used in the automated generation of creatives includes (but is not limited to) customer posts to specific services and/or the CI system can build an advertising campaign using promoted posts from customers on the services that published the posts. The process 200a completes by returning (206) information that can be utilized to generate one or more advertising campaigns.

Although specific processes for automatically generating information that can be utilized to generate one or more advertising campaigns are described with reference to FIG. 2A, any of a variety of processes can be utilized to generate advertising targeting data, advertising creatives, and/or complete programmatic advertising campaigns as appropriate to the requirements of specific applications in accordance with embodiments of the invention. As can readily be appreciated, the ability of CI systems to automatically generate information that can be utilized to generate one or more advertising campaigns is often heavily reliant on the ability of the CI system to merge information sets associated with named entities from many remote information sources. Therefore, an extensive discussion of the merging of information sets, the generation of authoritative information sets, and the identification of relationships between named entities from the merged information sets and/or authoritative information sets is provided below before returning again to the topic of automatically generating advertising targeting data, advertising creatives, and/or programmatic advertising campaigns.

### Overview of Operations of Customer Insight Systems

FIG. 2 conceptually illustrates a process 200 performed by CI systems in accordance with embodiments of the invention in generating and returning customer relationship information and/or customer insight information in response to queries. In a number of embodiments, the process 200 is performed by a CI management system in accordance with the embodiment described above in connection with FIG. 1. The process 200 includes receiving (210) a query for information. The query may be for a customer list, information about a customer, information about a business, or any other functionality provided by the CI system. Typically, the query is received from a user of the CI system. Often, the user is a merchant or business owner, who uses the returned information to assess the merchant's customers. The CI systems can generate and return information on numerous types of entities; including (but not limited to) a consumer, a business, a transaction, a thing, a customer, and/or a location.

The process 200 can gather (220) information based on received queries and/or scheduled crawls. The queries typically contain information that suggests certain relevant entities. For instance, the query may contain an attribute value (e.g., a name, an address, or a phone number) associated with a named entity. When the query includes such attribute values, the process 200 can gather information based on the included attribute values. In numerous embodiments, the gathering may be performed via crawler processes, which are discussed further below. For instance, process 200 may gather the information via web crawling operations using attribute values of queries as search terms.

The gathered information can then optionally be used in a series of information management operations. These information management operations can be used in order to identify named entities and characteristic data for said named entities from the gathered information. In some embodiments, an initial identifying information set is gathered prior to further operations. This initial identifying information set can include basic identification information, such as (but not limited to) name, address, and/or phone numbers. The initial identifying information set can be used in querying remote information sources for information utilizing characteristic data in the initial identifying information. Typically, the identifying information set will include characteristic data likely to uniquely identify a particular named entity. One example of such uniquely identifying information is a cellular phone number. Cellular phone numbers often are used by only a single named entity, whereas characteristic data such as landline phone numbers could overlap with multiple named entities. Embodiments of the invention can utilize various combinations of identifying information to assist in gathering information sets as required based on available information for particular named entities.

The process 200 optionally generates (230) merged information sets for at least one entity from gathered information. In several embodiments, the merging of information may be continuously performed as a background process. A merged information set contains information from multiple sources that refers to the same named entity (e.g., a consumer, a business, a transaction, a thing, a customer, and/or a location). The generation (230) of merged information sets includes gathering sets of information from information sources and merging gathered information sets when they are of sufficient similarity according to certain thresholds of similarity. The gathered information can include (but is not limited to) standard identity information, such as names, addresses, and phone numbers for various entities. The information sources can include numerous types of sources as discussed above. Similarity thresholds can serve to verify that gathered information sets refer to the same named entity (e.g., a same person or business). In numerous embodiments, the similarity is assessed by comparing the attribute values (e.g., names, addresses, and/or phone numbers) of sets of gathered information. In other embodiments a variety of pieces of identifying information can be used in determining whether to merge information sets from different sources of data in accordance with embodiments of the invention.

As an example of merging gathered information sets, assume that a directory website and a social media website both yield information sets indicating that a person named “Jon D. Doe” lives at “555 Smith St. in California”. The data points of “Jon D. Doe” and “555 Smith St. in California” from the directory website comprise a first information set. The data points of “Jon D. Doe” and “555 Smith St. in California” from the social media website comprise a second information set. Because the directory website information set and the social media website information set are sufficiently similar, the process 200 can merge the two information sets. Once merged, a CI system can identify that the first information set from the directory website and the second information set from the social media website refer to the same person. In which case, CI system can assign a common unique identifier to the merged information sets.

The process 200 optionally generates (240) authoritative information sets from merged information sets and/or gathered information. The generation (240) of authoritative information sets can be continuously performed as a background process. In numerous embodiments, the CI systems can use authoritative information sets as the most reliable sets of information for a named entity. CI systems in accordance with several embodiments of the invention may use measures of reliability to determine what information to use for authoritative sets when gathered information does not match (e.g., when two merged information sets contain different information, such as different phone numbers). In various embodiments, the CI systems may maintain various ratings or scores for information sources, such as (but not limited to) accuracy and size ratings. In combination with these ratings, a CI system can select the most commonly listed information as influenced by the size and accuracy ratings for the information sources.

As an example of comparing source ratings, assume that a CI system according to an embodiment of the invention is retrieving information from a high size, high accuracy rating directory website and a low size, low accuracy rating advertising website. If the directory website lists Jon D. Doe's phone number as (555) 123-4567 and the advertising website lists Jon D. Doe's phone number as (555) 321-4567, then the CI system in this example will have higher accuracy and size ratings for the directory website listing and use (555) 123-4567 as the phone number for an authoritative information set for Jon D. Doe.

The process 200 optionally updates (250) merged and/or authoritative information sets based on gathered information. Previous crawls could have resulted in stored merged and/or authoritative information sets for entities. The continuous gathering and crawling process can result in a need to update previously stored information. Publically available information, particularly that available via the Internet, has a tendency to degrade in quality over time. Due to people moving, businesses closing, and erroneous data entry; information only gets less reliable with time. Accordingly, the information gathered in connection with received queries is used to update merged and/or authoritative information sets. For instance, when a query involves a particular business, information gathered for that business can be used to update the merged information sets for that business. In embodiments where authoritative and merged information sets are maintained, updating a merged information set may result in a recalculation of an associated authoritative information set. As an example, if a person's account name on a highly reputable search website has changed, the authoritative and merged information sets may both be updated due to the weight of highly reputable search website as an information source.

The process can decide whether to continue crawling (255). Process 200 may stop crawling once crawling operations cease returning information that is different than previous crawls. For instance, once queries on a certain set of attributes for a named entity cease returning different results for the named entity, the process will cease crawling for a time. In addition, process 200 may stop crawling when an indication that a user of the CI system can stopped looking at a particular named entity for which crawls and/or gathering operations are being performed.

The process 200 optionally identifies (260) relationships between different named entities. In some embodiments, the process 200 may use the information in the merged and/or authoritative information sets in order to relate the entities represented by the information sets. By relating the entities, the CI systems can identify customers of businesses. CI systems can use gathered transaction information to identify that a consumer has become a customer of a business. Alternatively, or in addition to using transaction information, CI systems can compare geocodes generated and/or gathered from entity information to identify when consumers have become customers of businesses. For example, CI systems may use metadata within social media postings by consumers to identify social media postings made within premises of businesses (e.g., when a consumer checks-in at a restaurant). Establishing relationships between consumers and businesses enables a CI system of to identify customers of businesses. Customer identification enables numerous powerful customer insight functionalities that will be discussed in detail below.

The process 200 returns (270) information in response to queries. The information returned can take many forms. In several embodiments, the returned information can include (but is not limited to) data from merged information sets, data from authoritative information sets, customer lists for businesses identified from the relationships between consumers and businesses. Alternatively, or in addition to the returned information discussed above, CI systems can return information describing relationships between gathered information (e.g., information that identifies customers of businesses). In many embodiments, CI systems can produce customer profiles for consumers based on their interactions with businesses. The customer profiles can contain transaction histories, various spending ratings, and/or details regarding a customer. The process 200 can return customer profiles in response to queries. CI systems can analyze the customer profiles in order to generate typical customer profiles for a given businesses. Typical customer profiles can indicate ranges of demographic, financial, and economic data for typical customers of businesses. The process 200 can return the customer profiles or typical customer profiles in response to queries. The process 200 of numerous embodiments can also return maps indicating geographic concentrations of customers for businesses generated from the customer profiles. Further capabilities of the CI systems of multiple embodiments are discussed in more detail below.

While the operations described as part of process 200 were presented in the order as they appeared in the embodiment illustrated in FIG. 2, various embodiments of the invention perform the operations of process 200 in different orders as required to implement the invention. For instance, in some embodiments, gathering information, merging sets, relating information sets, and generating authoritative sets is performed continuously independently of whether any information is presented in response to user queries. Various servers and databases that can be utilized in the implementation of a CI system in accordance with embodiments of the invention are discussed further below.

### Servers and Databases of Customer Insight Systems

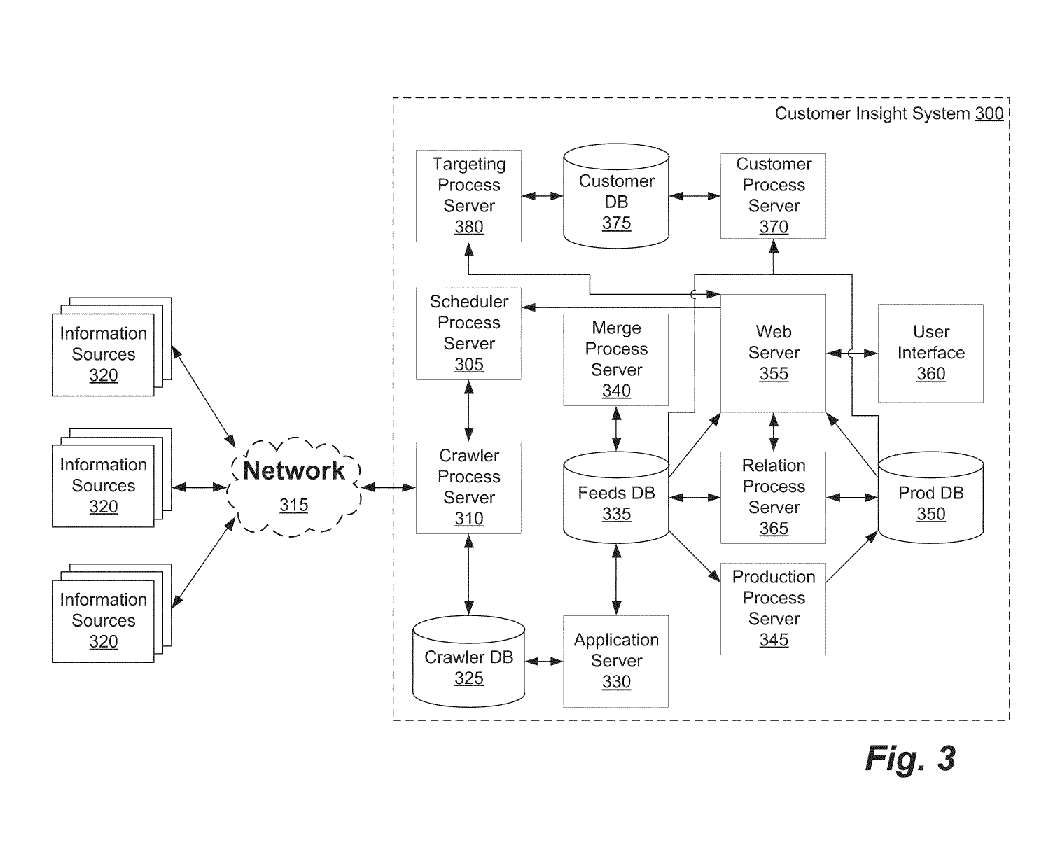

A customer insight (CI) system in accordance with an embodiment of the invention is illustrated in FIG. 3. The CI system 300 communicates with network 315 and information sources 320 to provide customer insight functionality. As shown in FIG. 3. CI system 300 includes several servers and databases. These servers and databases operate in concert to enable the operations and functionalities of CI system 300. The servers of CI system 300 can include a scheduler process server 305, an application server 330, a merge process server 340, a production process server 345, a web server 355, a relation process server 370, and/or a targeting process server 380. The databases of the CI system 300 can include at least one crawler database 325, at least one feeds database 335, at least one production database 350, and/or at least one customer database 375. While certain embodiments described herein are described as including only singular instances of the databases of the CI system 300, other embodiments may include several instances of the databases. In addition, the CI system 300 can provide a user interface 360. User interface 360 is a conceptual representation of functionality provided by web server 350 and/or applications that communicate with application servers within the CI system 300. While the specific embodiment shown in FIG. 3 includes the illustrated servers and databases; other embodiments of the invention may include more, fewer, and/or different servers and databases.

The scheduler process server 305 controls how the crawler process server 310 queries information sources 320 over network 315. The scheduler process server 305 can prioritize different searches based on several factors. Higher priority can be given to real-time information requests received from web server 355. Real-time information requests can occur when a user queries information about a named entity directly. A real-time information request can also be inferred from attributes contained within a query. Attributes within a query can include (but are not limited to) a name, an address, and/or a phone number associated with an entity. When a real-time information request is received, the scheduler process server 305 can instruct the crawler process server 310 to update the priority of scheduled information crawling based on attributes within or inferred from the real-time information request. The scheduler process server 305 can also instruct the crawler process server 310 to perform lower priority, batch gathering of information, Batch gathering can relate to old information that is need of updating, or simply lower priority crawls. In several embodiments, the CI system 300 only stores gathered information for a particular period of time (e.g., between six to twelve months) and deletes information that has been stored for a time exceeding the particular period of time.

The crawler process server 310 can gather information from information sources 320. As discussed above, the crawler process server 310 can receive instructions from the scheduler process server 305 concerning information for which to search and the priority in which to execute searches. The crawler process server 310 interacts with network 315 to reach information sources 320, In the embodiment illustrated in FIG. 3, network 315 is the Internet. The Internet can encompass many types of network connections, such as wireless connections, 4G connections, cellular networks, Ethernets, and/or Wi-Fi networks. Other embodiments may utilize other networks in addition to or in the alternative to the Internet. These other networks can include (but are not limited to) intranets, virtual networks, and/or mobile networks. Persons of ordinary skill in the art will recognize that CI systems in accordance with various embodiments of the invention can utilize any system of electronic communication to acquire information from information sources.

Information sources 320 can be any network addressable source of information. Information sources 320 can include web, file, and/or email servers, computing devices, and/or mobile devices, Examples of information sources 320 include (but are not limited to) newspaper websites, social media websites, social network websites, blogs, vertical information sites, travel guides, local search sites, internet yellow pages, entertainment guides, city guides, radio websites, television station websites, best of websites, business databases, consumer databases, consumer directory sites, marketing sites, deal and offer websites, coupon sites, coupon applications, general search engines, online encyclopedias, events sites, community sites, specialty websites, corporate websites, magazines, shopping sites, ecommerce sites, classifieds, phone number directories, domain directories, specially marked up sites, opt-in single sign on sites, social aggregation sites, music websites, TV websites, movie sites, social bookmarking sites, discussion sites, APIs, photo sharing sites, social sharing sites, review sites, app directories, app review sites, job listings, business card sites, personal websites, business websites, voicemail recordings converted to text, reverse picture lookups and matching services and websites, instant messaging lookup and/or directory sites, real estate information sites, Q&A sites, digital content stores, political and/or campaign information sites, check-in sites and/or apps, and/or mobile apps. The gathered information can include (but is not limited to) standard identity information, such as the name, address, and/or phone numbers of various businesses and consumers along with transaction information such as purchases and prices. The crawler process server 310 can gather different types of information (e.g., consumer, business, and/or transaction information) from the information sources 320 according to different processes.

The information gathered by the crawler process server 310 is stored in at least one crawler database 325. The crawler database 325 can store raw crawled data before it is parsed or merged into other forms of data. An application server 330 can perform initial parsing of the raw data in the crawler database 325. Parsed data can be stored in the feeds database 335. In a number of embodiments, the application server 330 additionally stores the parsed information in container files according to the information types collected. For instance, a container file for business information categorizes gathered information as belonging to certain attribute values, such as a name, an address, and/or a phone number. Various embodiments of the invention provide for many different ways to containerize gathered information.

The merge process server 340 merges information sets stored in order to build merged information sets for entities. Merged information sets are dusters of information from different information sources that are sufficiently similar to be considered to be referring to the same entity (e.g., two profiles for the same person from two different social media websites). Information sets in the feeds database 335 are merged where they are sufficiently similar according to certain thresholds of similarity. The thresholds of similarity can serve to verify that gathered information sets refer to the same entity. In multiple embodiments, the similarity is assessed by comparing the names, addresses, and phone numbers of sets of gathered information. In some embodiments, the merge process server 340 scores information sets for similarity to other information sets based on the attribute values stored in the information sets. The merge process server 340 may also merge information sets where the names, addresses, or phone numbers within evaluated information sets vary by limited permutations or small values. In some embodiments, the merge process server 340 assigns a same common unique identifier to merged information sets. For example, all merged information sets for a person named “Jon D. Doe” could be assigned a common unique identifier.

The production process server 345 can generate authoritative information sets for entities using information from the merged information sets stored in the feeds database 335. An authoritative information set is the CI system's 300 most accurate description of a named entity. The production process server 345 generates authoritative information sets using several techniques. In numerous embodiments, the production process server 345 rates information sources for accuracy and size. The production process server 345 can also consider how many times a piece of information is repeated across information sources. The production process server 345 can assess the ratings of the sources of information and also measure how often information is repeated across a merged information set. In addition, the production process server 345 of some embodiments balances the ratings of sources against the repetition of information across sources. For instance, the production process server 345 may select a piece of information for use in an authoritative information set, where the piece of information is repeated relatively infrequently but the piece of information comes from a particularly trustworthy source. Based on at least one of these techniques, the production process server 345 identifies authoritative information sets for named entities. Once authoritative information sets are created, they are stored in the production database 350.

The relation process server 365 can generate and/or infer relationships between entities. The relation process server 365 can use merged and authoritative information sets for different named entities such as (but not limited to) businesses, location, events, and consumers in order to generate relationship information. Through generating relationship information, the relation process server 365 provides many of the customer insight functionalities of the CI system 300. In many embodiments, the relation process server 365 uses gathered transaction information to identify relationships between entities. Alternatively, or in addition to using transaction information, the relation process server 365 of several embodiments compares geocodes generated from consumer and business information to identify relationships between entities. For example, the relation process server 365 of a number of embodiments uses metadata within social media postings by consumers to identify when consumers have transacted within the premises of businesses. In addition, the relation process server 365 can use reviews posted by consumers and social media check-ins as the basis of relating consumers to businesses. In addition, the relation process server 365 can also identify relationships between other types of entities, such as (but not limited to) relationships between consumers (e.g. who a person's friends are), relationships between businesses (e.g., business to business transactions), and relationships between locations and consumers (e.g., where a person frequents or lives). In many embodiments, the relation process server 365 stores the generated relationship information with merged and authoritative information sets in the feeds database 335 and/or the production database 350.

Once the relation process server 365 has generated relationship information, the relationship information can be used to provide customer insight functionalities. In many embodiments, the customer process server 370 can utilize relationship information, transaction information, merged information sets, and/or authoritative information sets to automatically identify current and/or potential customers of businesses. Typically, the customer process server 370 stores the identified customers in the customer database 375. In addition, the customer process server 370 of many embodiments can generate customer lists from the identified customers. The customer lists in several embodiments are presented to users through the user interface 360.

The targeting process server 380 of many embodiments produces advertising targeting data from previously identified customers. The advertising targeting data can be the basis for advertising campaigns that leverage the known information about customers in CI systems in accordance with embodiments of the invention. In addition, the targeting process server 380 of many embodiments can produce customer profiles for consumers based on their interactions with certain businesses. The customer profiles contain transaction histories, various spending ratings, and details regarding a customer. The targeting process server 380 can analyze the customer profiles for businesses in order to generate typical customer profiles for the businesses. The targeting process server 380 can further leverage known customer information to performed look-alike targeting and 1:1 targeting to allow discovery of new customers for targeting based on what is known about existing customers. Thereby, the targeting process server 380 can identify potential customers for a business for which advertising should be targeted. From the various identified and generated customer information, the targeting process server 380 can generate advertising targeting data. In some embodiments, the targeting process server 380 can further segment the generated advertising targeting data into more narrow categories of targeting.

Many of the functionalities of the targeting process server 380 and the other servers can be accessed through the web server 355. The web server 355 can use the merged information sets stored in the feeds database 335, the authoritative information sets stored in the production database 350, and the relationships established by the relation process server 365 to provide customer insight functionalities through the user interface 360. For instance, the web server 355 can return information from the feeds database 335 and the production database 350 in response to user queries. The web server 355 can also provide users access to the relationship information established by the relation process server 365.

The user interface 360 of various embodiments is the channel by which users can access the customer insight functions provided by the web server 355. For instance, automated campaign message services are run through the user interface 360 (as opposed to through private emails of the users of CI system 300). The web server 355 of some embodiments also updates the scheduler process server 305 in response to user queries received from the user interface 360 so that queried information is as current as possible and that future information gathering reflects queried information.

While the servers and databases of CI system 300 are shown as separate entities in the embodiment illustrated in FIG. 3, other embodiments may combine or distribute servers and databases. For instance, the databases used to implement CI systems in accordance with embodiments of the invention can be implemented remotely via cloud technology and/or include multiple, physically or virtually separated databases. Alternatively, the databases can be combined into a single data management system. Some of the servers may be implemented as virtual machines and/or as physical machines. In addition, the servers may be implemented using multiple servers to serve as a single process server. For instance, several process servers may be used to implement crawler process server 310. In multiple embodiments, the process servers can be implemented as software modules running on computing devices (e.g., multiple different servers implemented on the same physical or virtual machine). Persons having ordinary skill in the art will understand that the invention is not limited to the specific implementation illustrated in FIG. 3.

### Processes for Gathering Information for Use in Customer Insight Systems

In many embodiments, the CI systems gather information from information sources describing named entities. The gathered information can include (but is not limited to) attribute values for names, addresses, phone numbers, reviews, connections, dates, prices, transactions, and interests. The gathered information can also include social media and other website postings and the associated metadata of the social media postings of consumers. The gathering process is typically performed by a crawler process server. The following discussion details the various gathering processes that can be performed by crawler process servers in accordance with embodiments of the invention.

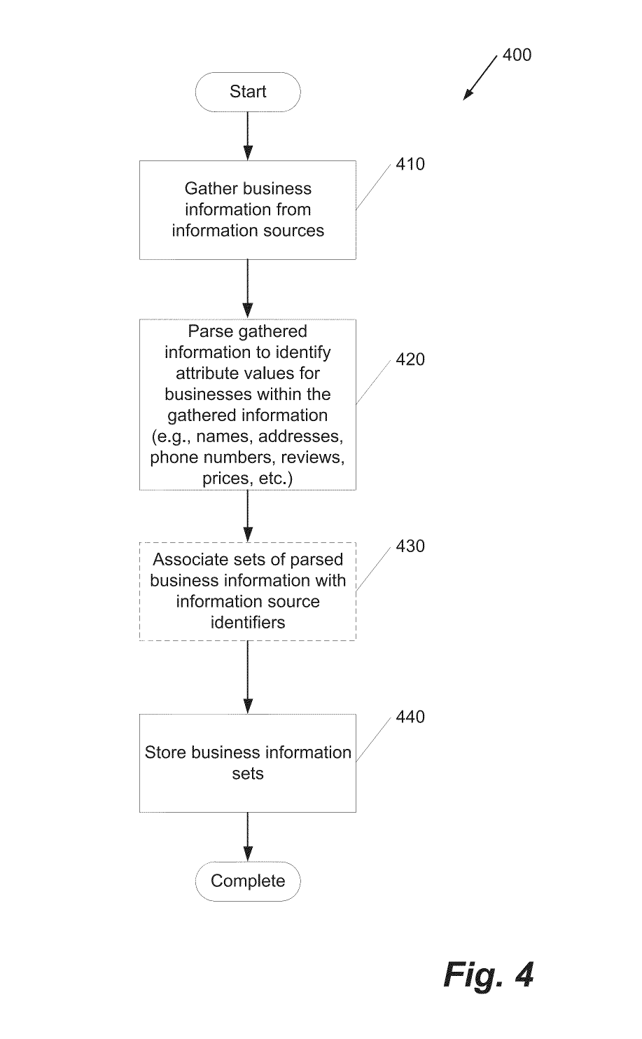

A process performed by a CI system to gather business information in accordance with an embodiment of the invention is illustrated in FIG. 4. Process 400 includes gathering (410) business information from information sources. The information sources can include, but are not limited to, websites, mobile devices, public directories, domain registrations, public records. In a number of embodiments the process 400 specifically targets business listings information, which can include (but are not limited to) listed names, addresses, phone numbers, and hours of operation. Business information listings can be found in many websites. Gathered business information can be provided to users for correction. Information relating to reviews of businesses and postings by consumers related to businesses can also be gathered. In addition, gathered information can include pricing information for businesses, such as menus or deals. As can readily be appreciated, any of a variety of information can be gathered as appropriate to the requirements of the invention.

Gathered business information can be parsed (420) to identify attribute values for businesses within the gathered information (e.g., names, addresses, phone numbers, and/or hours of operations). In some embodiments, the parsing process additionally involves storing the parsed information in container files according to the information types collected. For instance, a container file for business information can categorize information relating to the business such as the business's name, address, phone numbers, hours, prices, and/or reviews. In many embodiments, parsed and containerized business information is stored in a crawler database. As can be appreciated, any of a variety of information can be gathered and parsed as appropriate to the requirements of specific applications in accordance with embodiments of the invention.

Sets of parsed business information can optionally be associated (430) with source identifiers. Association with source identifiers is not necessary, where the information already includes a source identifier provided by the information source. However, when information sources do not provide source identifiers, associations between parsed information sets and source identifiers can be generated. In multiple embodiments, the generated source identifier for an information set is the URL from which the information set was gathered.

In numerous embodiments, the business information sets are (440) in a feeds database. The business information sets are initially stored unmerged (e.g., not associated with other business information sets). Further merge processing can be performed in order to identify clusters of business information sets that describe the same businesses. In some embodiments, gathered information includes information that is relevant to both consumer entities and business entities. For instance, reviews of businesses posted by consumers are stored as both business information and as consumer information (e.g., a review for the business and a review by the consumer).

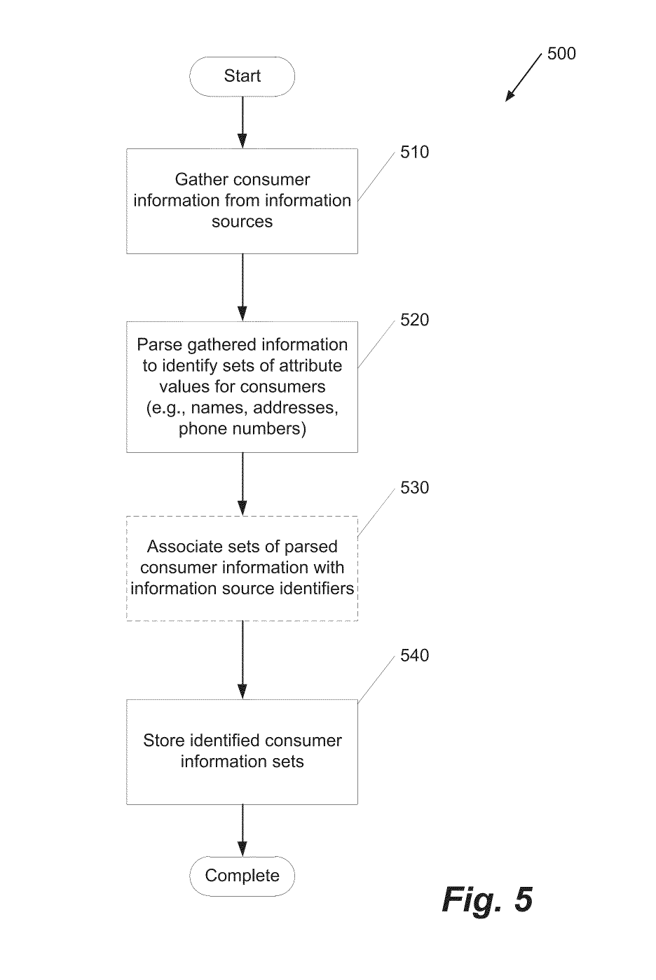

A process performed by a CI system to gather consumer information in accordance with an embodiment of the invention is illustrated in FIG. 5. Process 500 includes gathering (510) consumer information from information sources. Information sources for consumer information can include (but are not limited to) landline phone records, mobile phone records, email messages, web data, loyalty systems, discount programs, point of sale systems, credit card gateways, and/or credit card records from merchants. The email messages can be of the form of “to” messages, “from” messages, “cc” messages, in the body of emails, and/or in the signature lines of emails. Web data can be posted reviews, social media “checkins”, social media “likes”, social media follow operations, and/or “mentions”. Mentions typically include hyperlink information that links content in a message to other sites or data associated with the linked content or can be text “mentioning” the business (i.e. “I just had the best coffee at Joe's Coffee House”). In a number of embodiments, information gathering specifically targets social media postings and social media information generated and posted by consumers. Social media postings can be of particular relevance to CI systems in accordance with embodiments of the invention as they can include location information metadata that can be used to relate consumer activity to businesses. For example, when a consumer checks in, or when a consumer “likes” something, the CI systems can take advantage of this information to identify when a consumer has become a customer of a business (and how often they are a customer of the business). Additionally, gathered information can come from websites the consumer may have visited or posted anything on (i.e. questions & answers, product review sites, vertical sites, niche or special interest sites, charity sites, etc).

Gathered consumer information can be parsed (520) to identify attribute values for consumers within the gathered information. In numerous embodiments, the parsing process additionally involves storing the parsed information in container files according to the information types collected. For instance, a container file for consumer information can categorize information relating to the consumer such as the consumer's names, addresses, phone numbers, relatives, friends, owned properties, and/or income. In multiple embodiments, parsed and containerized consumer information can be stored in a crawler database. As can readily be appreciated, any of a variety of information can be gathered as appropriate to the requirements of the invention.

Sets of parsed consumer information can optionally be associated (530) with source identifiers. Association with source identifiers is not necessary, where the information already includes a source identifier provided by the information source. For instance, information gathered from major social media websites will include social media website specific source identifiers. However, when information sources do not provide source identifiers, associations between parsed information sets and source identifiers can be generated. In some embodiments, the generated source identifier for an information set is the URL from which the information set was gathered.

In numerous embodiments, the consumer information sets are stored (540) in a feeds database. The consumer information sets are initially stored unmerged (e.g., not associated with other consumer information sets). Further merge processing can be performed in order to identify clusters of consumer information sets that describe the same consumers. In some embodiments, gathered information includes information that is relevant to both business entities and consumer entities. For instance, reviews of businesses posted by consumers can be stored as both consumer information and as business information (e.g., a review for the business and a review by the consumer).

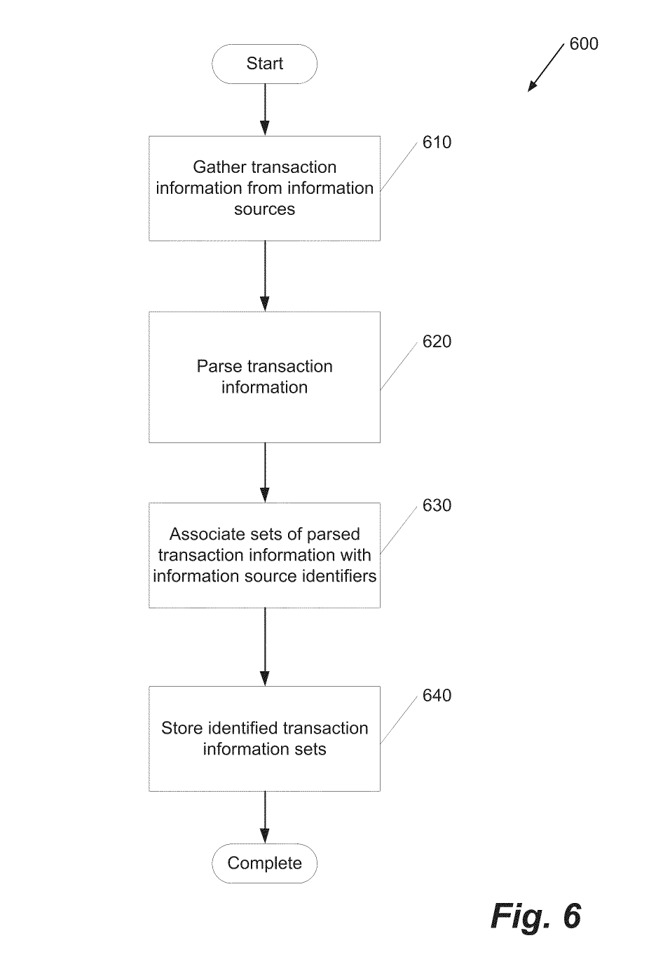

A process performed by a CI system in gathering transaction information between entities (e.g., purchases by consumers from businesses) in accordance with an embodiment of the invention is illustrated in FIG. 6. Process 600 includes gathering (610) transaction information from information sources. The information sources can include, but are not limited to, websites, consumer devices, public directories, domain registrations, public records, and credit bureaus. In some embodiments the process 600 specifically targets credit gateways as information sources. Credit gateways provide anonymized transaction data. For instance, credit gateways can indicate that a purchase happened at a business, but may not identify what consumer made the purchase. In addition, the average spending by consumer can be gathered from credit gateways. In addition, the process 600 can gather the average spending over a period of time at a business and provide that information for customer insight functions. Numerous embodiments can infer the spending habits of customers of businesses using combinations of gathered transaction information and gathered consumer information when the specific data for a transaction with a specific customer is unavailable.

Furthermore, merchants can be a source of transaction information. For instance, a merchant can provide credit card records utilizing login credentials supplied by the merchant to access the data through crawling. In addition, some embodiments provide for the use of optical character recognition (OCR) scans of paper records or pictures of paper records from businesses and merchants. The scans can indicate transactions, such as credit card purchases. Moreover, where merchants have applications or systems that customers interact with during transactions, several embodiments provide for application programming interface (API) integrations with these applications or systems.

Gathered transaction information can be parsed (620) to identify attribute values for transactions within the gathered information. The identified attribute values for transactions can include (but are not limited to) times, dates, amounts, parties, any deals present, what was purchased, related recommendations, and/or frequencies of transactions. In many embodiments, the parsing process additionally involves storing the parsed information in container files according to the information types collected. For instance, a container file for transaction information can categorize information relating to the transaction such as the transaction's time, date, amount, and/or parties to the transaction. In numerous embodiments, parsed and containerized transaction information can be stored in a crawler database. As can readily be appreciated, any of a variety of information can be gathered as appropriate to the requirements of the invention.

Sets of parsed transaction information can be associated with source identifiers. Association with source identifiers is not necessary, where the information already includes a source identifier provided by the information source. For instance, information gathered from credit bureaus can often include source identifiers provided by the credit bureaus. However, when information sources do not provide source identifiers, associations between parsed information sets and source identifiers can be generated. In various embodiments, the generated source identifier for an information set is the URL from which the transaction information set was gathered.

In several embodiments, transaction information sets are stored (640) in a feeds database. The transaction information sets are initially stored unmerged (e.g., not associated with other information sets). Further merge and relationship processing can performed in order to identify previously stored information sets with which to associate the transaction information sets. For instance, merge and relationship processing may be necessary to associate collected transaction information sets with particular consumers or businesses. In numerous embodiments, each transaction information set is merged and related to at least two other information sets (e.g., related to a consumer information set and a business information set where the consumer transacted with the business).

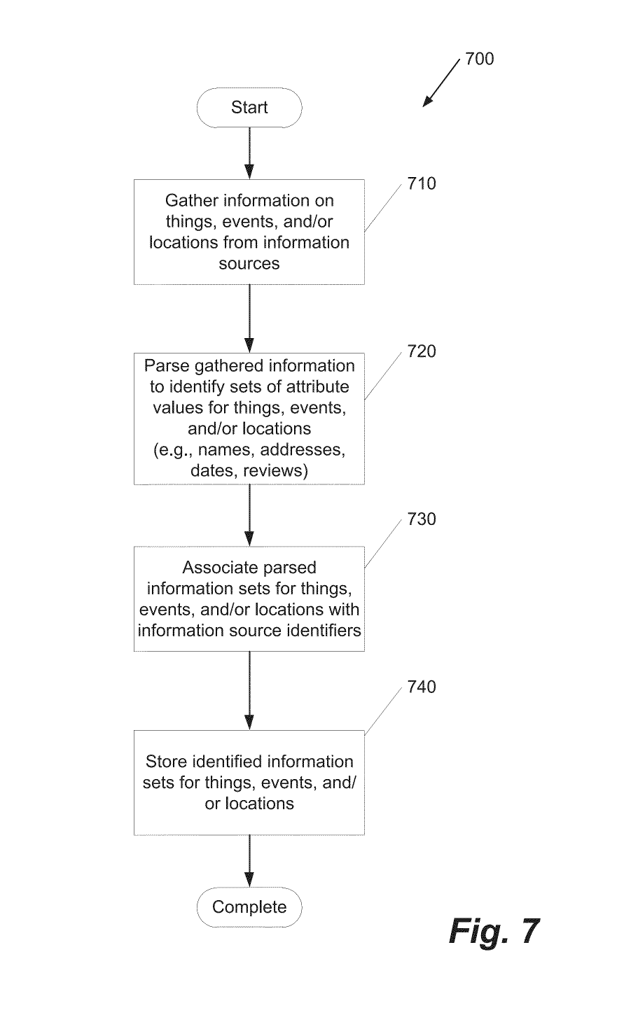

A process performed by a CI system in gathering information on things, events, and/or locations in accordance with an embodiment of the invention is illustrated in FIG. 7. CI systems in accordance with embodiments of the invention can gather general information on entities that are not strictly consumers, businesses, and their transactions. For instance, information on things, such as emergent trends in media can be gathered. Also, information on events such as major concerts, movies, or conventions can be gathered. In addition, information on locations such as stadiums, convention centers, parks, and/or major public transportation hubs can be gathered. Moreover, information regarding brands and the interactions of other entities with the brands can be gathered. Brand information can include (but is not limited to) purchases, likes, mentions, and/or comments by consumers with respect to a brand. Process 700 includes gathering (710) information on things, events, and/or locations from information sources. The information sources can include, but are not limited to, websites, consumer devices, public directories, domain registrations, and public records. As can readily be appreciated, certain named entities such as (but not limited to) brands do not have locations. Accordingly, information sets concerning such named entities are merged without using geographic location information and/or disregarding any geographic location information that may be associated with the merged information sets during the merge process.

Gathered information on things, events, and/or locations can be parsed (720) to identify attribute values for information on things, events, and/or locations within the gathered information. The identified attribute values can include (but are not limited to) times, dates, addresses, viewers, ratings, and/or sizes. In many embodiments, the parsing process additionally involves storing the parsed information in container files according to the information types collected. For instance, a container file for information on things, events, and/or locations can categorize information relating to the information on things, events, and/or locations. In a number of embodiments, parsed and containerized information on things, events, and/or locations can be stored in a crawler database. As can readily be appreciated, any of a variety of information can be gathered as appropriate to the requirements of the invention.

Sets of parsed information on things, events, and/or locations can optionally be associated (730) with source identifiers. Association with source identifiers is not necessary, where the information already includes a source identifier provided by the information source. However, when information sources do not provide source identifiers, associations between parsed information sets and source identifiers can be generated. In numerous embodiments, the generated source identifier for an information set is the URL from which the information on things, events, and/or locations was gathered. In some embodiments, the information sets for things, events, and/or locations are stored (740) in a feeds database. The information sets for things, events, and/or locations are initially stored unmerged (e.g., not associated with other information sets). Further merge and relationship processing can performed in order to identify previously stored information sets with which to associate the information sets for things, events, and/or locations.

While the operations described as part of processes 400, 500, 600, and 700 were presented in the order as they appeared in the embodiments illustrated in FIGS. 4, 5, 6, and 7, various embodiments of the invention perform the operations of the processes in different orders as required to implement the invention. Embodiments of the invention gather numerous types of data, as discussed above in connection with processes 400, 500, 600, and 700. Furthermore, this gathered data can be given further meaning through merging of collected information sets where the information sets are sufficiently similar.

### Merging Information Sets

CI systems in accordance with many embodiments of the invention merge gathered information sets according to the sets' similarity to particular named entities. When several sets of information gathered from information sources are similar enough that they can be said to refer to a same named entity (e.g., a person or a business), the CI systems can merge the sets of information to create a merged information set that describes the named entity. As discussed above, information sets can include clusters of information gathered from information sources, such as (but not limited to) profiles of persons from social media websites, listings of businesses from directory websites, and/or reviews of a businesses (submitted from a mobile device). The CI systems can use several measures of similarity to determine when gathered information sets refer to the same entity. The CI systems can assess differences (or lack thereof) between attribute values in the gathered information sets. For example, CI systems in accordance with many embodiments of the invention merge information sets where the differences between the information sets is merely a permutation in a name, a minor numerical difference in addresses, and/or where the information sets are gathered from similar geocodes. Merging information sets can be an important process for CI systems in accordance with embodiments of the invention as information about a single person or business can come from many different information sources.

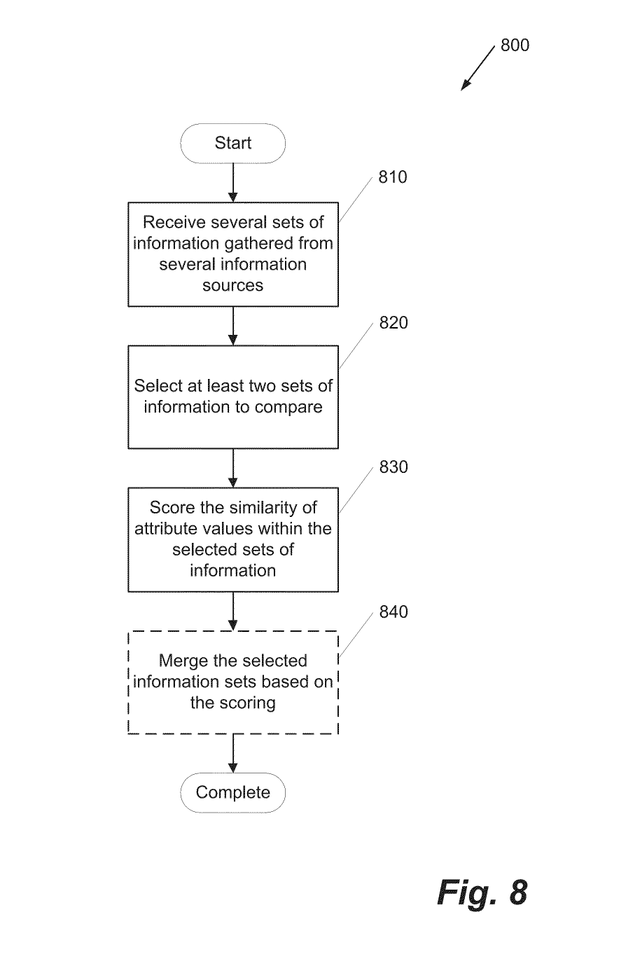

A process performed by a CI system to merge gathered information sets in accordance with an embodiment of the invention is illustrated in FIG. 8. Process 800 includes receiving (810) several sets of information gathered from several information sources. In the embodiment illustrated in FIG. 8, the merge process 800 is a standalone process that does not include a gathering process. Other embodiments of the invention can implement the merge process as a part of the gathering process, or as a sub-process of a larger system-wide CI process. The received sets of information can be gathered from any number of different sources. The gathered information typically includes attribute values for the names, addresses, and/or phone numbers of named entities (such as consumers and businesses). In other embodiments, any information appropriate to the requirements of specific applications can be merged. The several sets of information gathered from several information sources can be received from a crawler database of a CI system.

In several embodiments, at least two gathered sets of information are selected (820) from gathered information sets for comparison. Information sets can be selected from a feeds database as part of a continuous selection process or as information sets are added to the feeds database. For instance, in several embodiments of the invention, the CI system may select and assess gathered information sets as they are added to a feeds dataset. This ensures that newly gathered information sets are compared and assessed before storage with the remainder of the gathered information sets. Other embodiments may use a continuous crawling process to assess previously stored information sets from the feeds database. In a continuous crawling process, a CI system can continuously compare stored information sets for their relative similarity to each other. Numerous embodiments of the invention select sets of information to compare for merger based on a shortened comparison scheme that compares basic information from sets in order to identify information sets to select for a more full assessment.

Similarity of attribute values within two or more sets of information can be scored (830). Different embodiments of the invention can use various methods to score the similarity of attributes within the selected sets of information. For instance, the attribute values can be assessed for matching percentages (e.g., where all the attributes are the same between two information sets, the matching percentage would be 100%). Alternatively, or in addition to matching comparisons, embodiments of the invention can use location information within the information sets to identify geocodes for the information sets. For instance, where the gathered information sets have attribute values for addresses, or where the gathered information sets have geographic metadata (such as when the gathered information sets are gathered from mobile devices with GPS technology), the merge processes of a number of embodiments convert the addresses and/or location metadata into geographic coordinates (i.e., geocodes). These geocodes can be used to assess whether the selected information sets should be merged.

Selected information can (optionally) be merged (840) based upon the similarity of the selected information sets. For instance, two selected information sets can be merged when the differences in their attribute values fall within a threshold percentage. Two selected information sets can also be merged, where the differences between their geocodes satisfy certain geometric and statistical requirements. An election not to merge the selected information sets can occur when the selected information sets fail to satisfy any assessment of similarity. In such circumstances, CI systems in accordance with several embodiments of the invention judge the dissimilar sets to refer to different entities. For instance, the selected sets may refer to different individuals.

Some embodiments can merge information sets based on only sub-portions of information being similar between the selected information sets. For instance, information sets can be merged where only a single common attribute, such as a name, address, or phone number, is found between the two selected information sets. Such mergers may be performed where the selected information sets are gathered from different types of sources. For instance, where a first selected information set is a phone record and a second information set in a web page, yet both information sets include at least one sufficiently similar attribute. The merger of disparate types of information sets based on limited points of similarity allows for the binding of information of entities from diverse sources. The merged information sets can be stored in a merge database of a CI system.

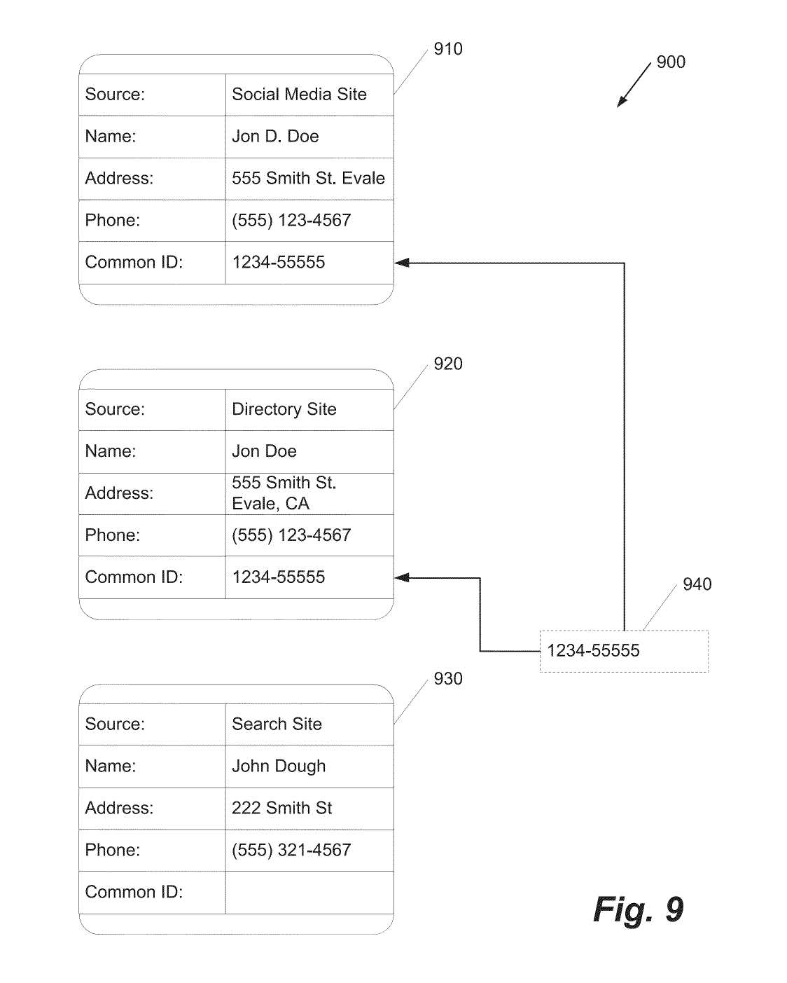

Several example information sets to be selected, assessed, and optionally merged are conceptually illustrated in FIG. 9. FIG. 9 shows example 900 that includes information sets 910, 920, and 930. Information sets 910, 920, and 930 are gathered from various information sources and are selected for comparison. Information sets 910, 920, and 930 can be compared to determine if any of them refer to the same named entity.

Information sets 910, 920, and 930 each include several attribute value pairs. The attribute value pairs include names, addresses, and/or phone numbers. In addition, a source identifier field and a common ID field are present in each of the information sets. The attribute value pairs and fields shown in example 900 are pairs and fields for one embodiment of the invention. Other embodiments may include additional attribute value pairs and fields to store additional information (such as time gathered, time stored, source ratings, and/or files sizes) or may include fewer attribute pairs and fields (e.g., some embodiments do not include a Common ID field). In addition, other embodiments of the invention may include additional attribute value pairs for multiple names, multiple addresses, and/or multiple phone numbers. For instance, the attribute value pairs can include cell phone number, home phone number, and work phone number. In many embodiments, the information sets are stored in databases and/or in container files that categorize and organize attribute values for gathered information to enable more efficient comparison of values between information sets.

As indicated in FIG. 9, information set 910 is gathered from Social Media Site, information set 920 is gathered from Directory Site, and information set 930 is gathered from Search Site. Information set 910 from Social Media Site indicates that a person named Jon D. Doe has an address 555 Smith Evale with a phone number of (555) 123-4567. Information set 920 from Directory Site indicates that a person named Jon D. Doe has an address 556 Smith St. Evale, Calif. with a phone number of (555) 123-4566. Information set 930 from Search Site indicates that a person named Jon Dough lives at 222 Smith St. with a phone number of (555) 321-4567.

A CI system in accordance with many embodiments of the invention score the similarity of attribute values within several selected information sets (in this case, information sets 910, 920, and 930). This scoring can be accomplished by comparing the various attribute values and field values of the selected information sets. Information set 910 includes the same name value as information set 920, but the name value for information set 930 (John Dough) is significantly different from information set 910 (Jon D. Doe) and information set 920 (Jon Doe). The similarity score for information set 930 in comparison to information sets 910 and 920 with regards to the name attribute value would be fairly low in several embodiments.

Information sets 910 and 920 include similar addresses, “555 Smith St. Evale” and “555 Smith St. Evale, Calif.”, respectively. However, Information set 930 has a significantly different address of “222 Smith St”. Multiple embodiments of the CI systems compare geocodes from address attribute values and perform geometric and geographic analyses on addresses in order to assess their similarity. In the example shown in FIG. 9 the addresses of the example information sets are sufficiently different that simple comparisons would yield low similarity scores for information sets 910 and 920 with 930.

Information sets 910 and 920 include the same phone number “(555) 123-4567”. However, information set 930 has a different phone number of “(555) 321-4567”. CI systems in accordance with a number of embodiments of the invention compare phone numbers via a permutation computation that calculates a similarity score based on how many permutations exist between phone numbers. For instance, where two compared phone numbers are only one permutation apart, then the phone numbers can be considered to be similar. In example 900, information set 930 is separated by two permutations from the phone numbers from information sets 910 and 920. Accordingly, information set 930 can be scored as dissimilar to information sets 910 and 920. In embodiments where multiple phone number types are included in the information sets, differences in phone number types can be the basis for generating similarity and/or dissimilarity scores between information sets. For instance, where two information sets have a matching phone number, but the phone number is for a cell phone in the first information set and a work phone in the second information set.

CI systems in accordance with several embodiments of the invention can generate a composite score for assessed information sets that combines the similarity scores generated from the comparisons of the attribute value pairs and the field values. In example 900, information set 910 can be scored as having a high composite similarity score with regards to information set 920 on the basis that the attribute value pairs between information set 910 and information set 920 have (1) a high similarity score in the name attribute, (2) a high similarity score in the address attribute, and (3) a high (matching) similarity score in the phone attribute. However, information set 930 would have a low composite similarity score to information sets 910 and 920 as the attribute value pairs between information set 930 and information sets 910 and 920 include (1) a low similarity score in the name attribute, (2) a low similarity score in the address attribute, and (3) low similarity score in the phone attribute. CI systems in accordance with several embodiments of the invention use the composite scores for information sets 910, 920, and 930 as the basis for making a decision as to whether to merge the information sets.

In example 900, information set 910 and information set 920 are sufficiently similar to be merged. By merging information set 910 and information set 920, the CI system identifies the two information sets as referring to a same person, Jon D. Doe. In many embodiments, a CI system can assign common unique identifiers to merge information sets in order to identify the sets as being merged. The common unique identifier is common to merged information sets, and each collection of merged information has a unique identifier (e.g., the information sets that are merged with respect to Jon D. Doe get a unique identifier that is common to all of the merged information sets for Jon D. Doe). As shown in example 900, the common unique identifier 1234-55555 is assigned to information sets 910 and 920 for Jon D. Doe. No common unique identifier (or a different unique identifier) is assigned to information set 930 due to its low similarity score with information sets 910 and 920. Other embodiments of the invention may use different numerical conventions for common unique identifiers, including (but not limited to) hexadecimal and/or additional digits as appropriate to the requirements of specific application. Additional techniques for merging information sets using geographic location information are discussed below.

### Merging Information Sets Using Geocodes

CI systems in accordance with many embodiments of the invention use location information within information sets to identify and/or generate geocodes for the information sets. The geocodes can be used to identify relationships between different information sets based on whether they were gathered from a same or different location. The geocodes can also be used to identify when information sets are related to a same or different location. For instance, the geocodes can be used to identify when a consumer has checked in at a business, or to identify when two information sets refer to the same location. The geocodes can be generated from address attribute values in selected information sets, or from geographic metadata connected to the selected information sets. For instance, mobile devices with GPS technology often tag the information with metadata describing a geographic location. In many embodiments, the geocodes are latitude and longitude; however other embodiments may employ different types of geocodes. Multiple embodiments employ geocodes as part of a merge process. The merge processes of several embodiments convert these addresses or location metadata into geographic coordinates (i.e., geocodes) and evaluate information sets for merger.

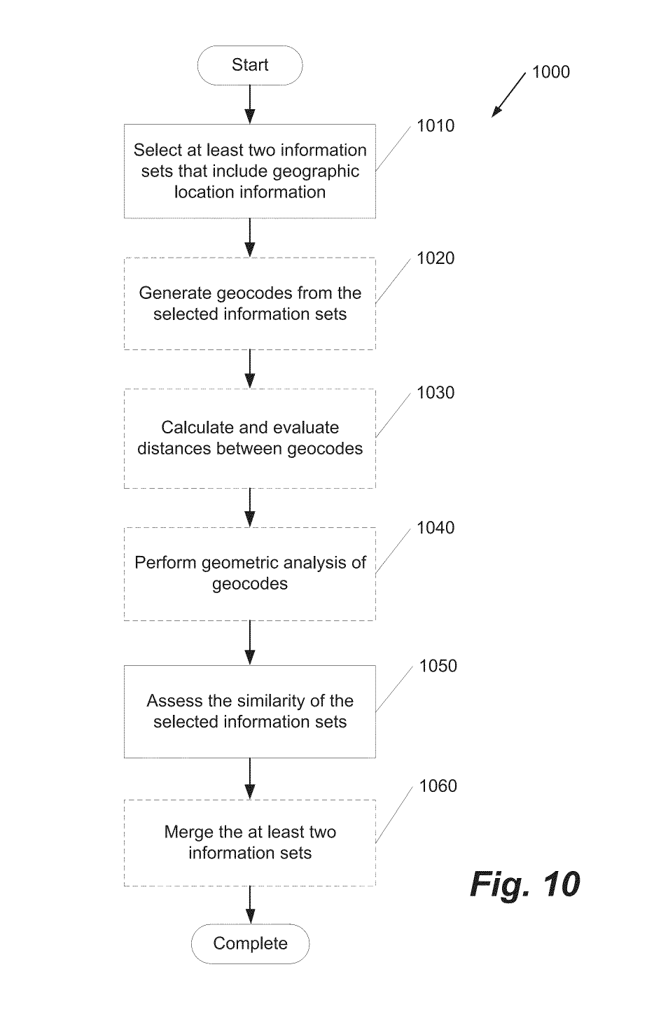

As a part of, or in addition to the merge processes previously discussed, a process performed by a CI system to generate and compare geocodes of selected information sets in accordance with an embodiment of the invention is illustrated in FIG. 10. Process 1000 includes selecting (1010) at least two information sets that include geographic location information. Geographic location information can include address attribute values, GPS information, location tags, location data from metadata, and any other form of information that can be used to generate geocodes. In various embodiments, any of a variety of representations of geographic location information appropriate to the requirements of specific applications can be utilized for the generation of geocodes. In some embodiments, selections are made from gathered information sets stored in a feeds database. In other embodiments, at least two information sets are received for selection without performing a direct selection. This is the case where the selection is performed as a sub-process of a larger merge process that has already selected information sets to analyze for possible merging.

Geocodes can optionally be generated (1020) from the selected information sets. Various embodiments employ public and/or private geocode generation systems to generate geocodes from location information. Such geocode generation systems include (but are not limited to) the MapQuest Geocoder service provided by AOL, the Geocoding API of Google Maps provided by Google, and/or the TIGER (Topologically Integrated Geographic Encoding and Referencing) services provided by the United States Census Bureau. In other embodiments, CI systems can use any of a variety of processes and/or services to generate geocodes from location data as appropriate to the requirements of specific applications. In addition, previously generated and/or stored location information can be used in combination with the location information from the selected information sets to infer the geocodes from the previously generated and/or stored information. Generated geocodes can be used to score the similarity between the selected information sets. Different embodiments may use different operations on the generated geocodes. Accordingly, process 1000 includes operations that may or may not be performed in different embodiments of the invention.

Distances between generated geocodes can optionally be calculated (1010) and evaluated. These distances can be computed according to “as the crow flies” distances on a map, or based on road-wise distances that account for travelling between the compared geocodes. Numerous embodiments take advantage of GPS data and/or geographic location information in order to determine distances between geocodes for different information sets. The calculated distances can be compared to thresholds of similarity and/or used to generated scores of similarity for the selected information sets. In addition, distances can be computed based on the latitude and longitude values associated with the geocodes.

Geometric analysis of the generated geocodes (1040) can also be optionally performed. Geometric analysis can comprise defining areas on maps that encompass the generated geocodes and assessing the relative positions of the geocodes within the defined areas. For instance, CI systems in accordance with some embodiments of the invention define circles around clusters of geocodes for several selected information sets; and evaluate the relative density and positions of the geocodes within and/or outside the defined area (e.g., a circle or a circumference). Other embodiments can use alternative geometric shapes to analyze the geocodes, such as rectangular, linear, or graphical objects. In several embodiments, CI systems can determine a center position between the geocodes prior to defining any geometric shapes. For instance, a CI system can identify a center point between several geocodes, and then draw a circle of a particular radius around that center point. The radius and/or size of the geometric object(s) used can vary depending on the type of assessment performed by the CI systems. When assessing whether social media posts from mobile devices (i.e., check-ins) refer to the a named entity encompassing a large area, such as (but not limited to) a park, an outdoor arena, and/or a shopping center, a moderate radius of several hundred feet may be used. Whereas when assessing whether two reviews of a named entity having a smaller geographic footprint such as (but not limited to) a small office, a home, and/or a street corner, then a shorter radius in the tens of feet can be used.

The similarity of the selected information sets can be assessed (1050) based on the previous analysis or analyses of geocodes. Different embodiments of the CI systems can assess the selected information sets differently. For instance, some embodiments can generate similarity and/or distance scores based on the previous analysis. Similarity and/or distance scores may be compared to thresholds to determine when geocodes are close enough to refer to a same location. Geometric proximity scores may be generated which can yield either relative distances or binary “close enough/not close enough” results. In a number of embodiments, the thresholds can adapt based upon factors including (but not limited to) the similarity of other pieces of characteristic data, knowledge of the existence of multiple locations sharing the same name and/or the density of the multiple locations. As can readily be appreciated, thresholds can be adapted using any of a variety of criterion appropriate to the requirements of specific applications in accordance with embodiments of the invention.

The at least two information sets can be optionally merged (1060). In an independent merge process, the decision to merge the information sets can be based on the generated scores. Where the scores pass certain thresholds the information sets can be merged. In a number of embodiments, process 1000 is a sub-process of a larger merge process that is optionally performed when information sets include address, geographic, and/or location data. In other embodiments, process 1000 can be performed as a singular merge operation that merges information only based on the geocodes without any other merge analyses. In yet other embodiments, process 1000 can be a part of a relationship establishing process that establishing relationships between information sets for different named entities based on the similarity of generated geocodes between the information sets for the different named entities. Specific examples of the geometric analysis of geocodes in accordance with embodiments of the invention are discussed further below.

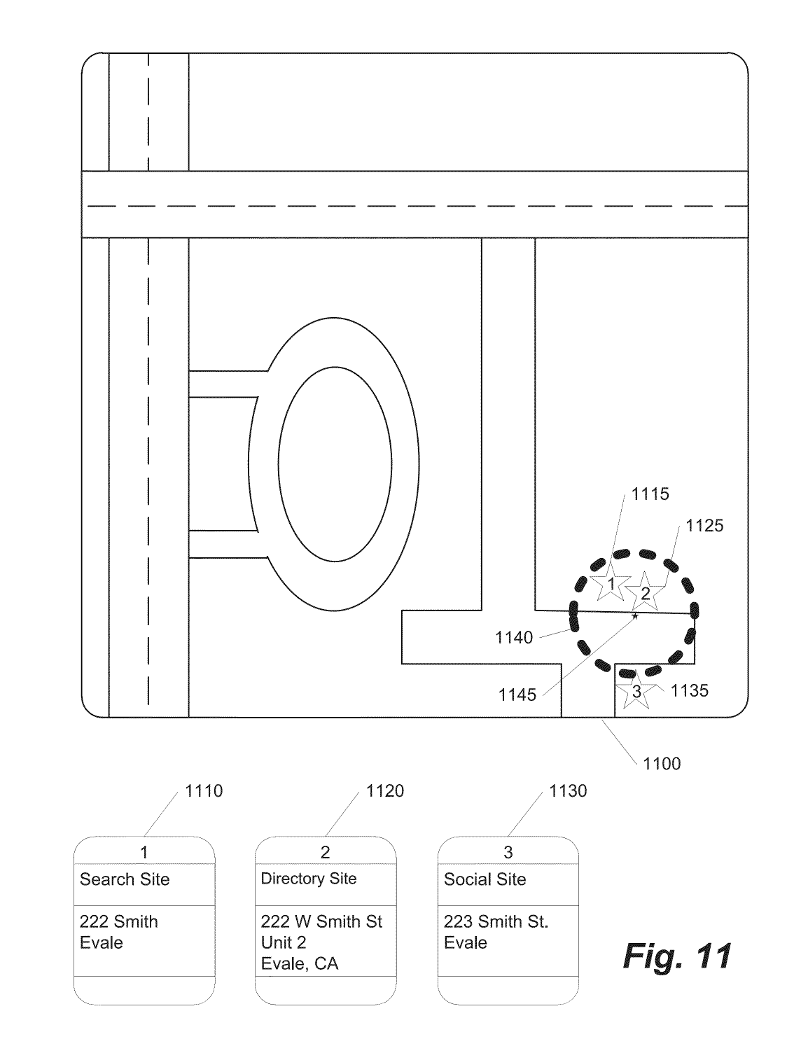

FIG. 11 conceptually illustrates the geometric analysis of several geocodes within geographic area 1100. Geographic area 1100 is a conceptual illustration and different kinds of map and/or computerized abstractions can be utilized as appropriate to the requirements of specific applications to represent an area. In many embodiments, public and/or private geographic systems can be employed to analyze and the geocodes and/or geographic location information from information sets. Geographic area 1100 includes several highways, a round driveway, side streets, a circle 1140 around a center point 1145, and three marked geocodes 1115, 1125, and 1135. The three marked geocodes 1115, 1125, and 1135 respectively correspond to information sets 1110, 1120, and 1130. The information sets can be gathered from many types of sources, such as from mobile devices, and/or from websites indicating the address of a named entity or entities. As illustrated, information set 1110 is from Search Site and has an address attribute of “222 Smith Evale”. Information set 1120 is from Directory Site and has an address attribute of “222 W Smith St Unit 2 Evale, Calif.”. Information set 1130 is from Social Site and has an address attribute of “223 Smith St. Evale”.

The circle 1140 around the center point 1145 has been drawn in order to assist in analysis of information sets 1110, 1120, and 1130 and geocodes 1115, 1125, and 1135. CI systems in accordance with many embodiments of the invention can use the circle to identify whether geocodes are close enough to be regarded as the same location. In the geographic area 1100, the radius of the circle is set to a neighborhood setting (e.g., the length of one or several houses). When assessing other information sets, such as those within large areas such as parks or stadiums, different length radii may be used. Numerous embodiments can take advantage of WiFi, radio, and/or other cellular technology from information sources to analyze the relative distances between geocodes in conjunction with the geometric analysis. Other embodiments may use different radii for circles or different lengths of polygons used in geometric analysis.

As shown in geographic area 1100, geocodes 1115 and 1125 from information sets 1110 and 1120 are within the circle 1140 whereas geocode 1135 from information set 1130 is outside of circle 1140. Where information set 1130 is being analyzed in connection with the application of a merge process to information sets 1110 and 1120, information set 1130 can be scored as having a low similarity score with information sets 1110 and 1120. As a result, the merge process of may not merge information set 1130 with information sets 1110 and 1120. However, as information sets 1110 and 1120 are both within circle 1140; a merge process can score information sets 1110 and 1120 as having a high similarity score. As a result, the merge process of some embodiments can merge information sets 1110 and 1120.

During a merge process, various embodiments of the invention do a word or character permutation based comparison of attribute values to assess the similarity attribute values between information sets. In the example illustrated in geographic area 1100, such a permutation based strategy can yield misleading results. The geocoding reveals that information set 1110 at geocode 1115 is much closer to information set 1120 at geocode 1125 than to information set 1130 at geocode 1135. However, according to simple permutations, information set 1110 includes substantially fewer differences from information set 1130 (e.g., only the “3” is different).

While geometric analysis has been discussed in terms of merge processes, other embodiments of the invention can utilize geometric analysis techniques similar to those described above with respect to FIG. 11 in conjunction with other CI processes, such as the process of generating authoritative information sets from merged information sets. If information sets 1110, 1120, and 1130 were merged information sets, the authoritative information set generation process of some embodiments could use the geometric analysis shown in FIG. 11 to identify that “222 W Smith St Unit 2 Evale, Calif.” as the most reliable data point from information sets 1110, 1120, and 1130. The authoritative information set generation process can make such a judgment based on geocode 1125 being the most proximate to center point 1145 of circle 1140. The following section discusses the generation of authoritative information sets in more detail.

### Generation of Authoritative Information Sets

In various embodiments, CI systems can generate authoritative information sets from merged sets of information. An authoritative information set is a CI system's most accurate description of a named entity (e.g., the correct name, address, and phone number of a business or a consumer). A CI system can select different attribute values from different merged information sets in order to generate an authoritative information set. In several embodiments, generation of an authoritative information set can involve using attribute values from information sets that have been merged by a merge process. In other embodiments, attribute values from any gathered information sets whether merged or not merged can be utilized. In several embodiments, the process of generating the authoritative information sets involves assessing the reliability of the attribute values in order to generate authoritative information sets for named entities.

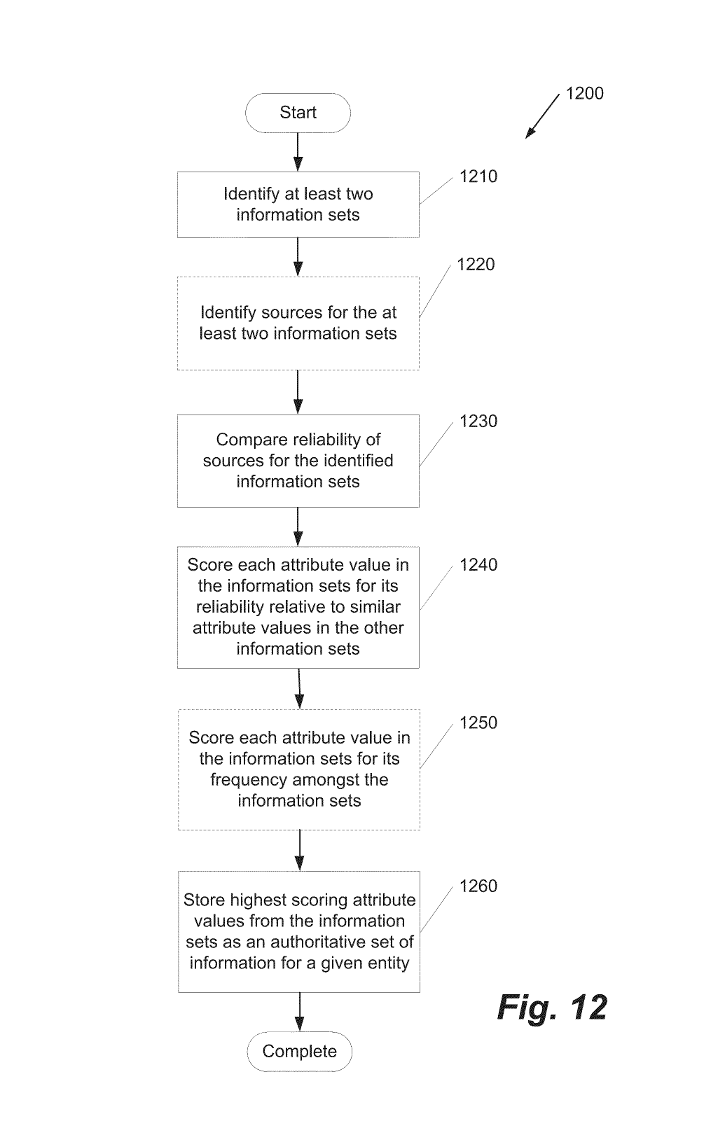

As an example, CI systems in accordance with embodiments of the invention can merge several information sets for a person “Jane Doe”. The several merged information sets can include an information set gathered from a directory site and an information set gathered from a social media site. In this example, a CI system can select the phone number from the directory site information set and the name from the social media information set to include in an authoritative information set for “Jane Doe”. A process for generating authoritative information sets in accordance with this example is illustrated in FIG. 12.

Process 1200 includes identifying (1210) at least two information sets. The at least two identified information sets can be merged information sets. Where the at least two identified information sets are merged information sets, then the CI system has previously identified the merged information sets as relating to the same entity. In several embodiments, the at least two identified information sets can draw from information sets that have not been merged by a prior merge process.

The sources of the identified at least two information sets can be (optionally) identified (1220). In a number of embodiments, each identified information set includes a source identifier that identifies the information source from which the information set was gathered. The source identifiers of can include unique identifiers assigned by the CI system, and/or addresses from which the information was gathered (e.g., a URL). Source identifiers can be used to identify sources for the identified information sets.

The reliability of sources associated with the at least two identified information sets can be compared (1230). In many embodiments, the comparison involves assessing the sources of the identified information sets using ratings maintained for various information sources. CI systems can maintain ratings for various information sources that rate the sources for qualities including (but not limited to) accuracy, reliability, trustworthiness, and/or reputation. Further ratings for information sources may be used and/or maintained as appropriate to the requirements of specific applications. In numerous embodiments, the ratings are for particular types of attribute values. In several embodiments, CI systems generate ratings for information sources and/or obtain ratings from a ratings source.

Each attribute value in the identified information sets can be scored (1240) for the attribute value's reliability relative to similar attribute values in other information sets. Similar attribute values can be attribute value types such as (but not limited to) name, address, phone number, time, price, and/or dates. As mentioned above, different sources can have different ratings for different types of attribute values. For instance, a directory website can have a very high reliability rating with regard to phone numbers, whereas a mapping application can have a very high accuracy rating with regard to addresses. Thus, phone attribute values in information sets from the directory website can be scored as more reliable relative to phone attribute values in information sets from a lower rated information score.

Each attribute value in the identified information sets can be (optionally) scored (1250) for the attribute value's frequency amongst the identified information sets. Where attribute values of the same type are repeated across information sets (e.g., when a same name is present in multiple information sets), the repeating attribute value can be scored (1250) as more reliable in addition to scoring the attribute values based on source ratings.

The highest scoring attribute values from the identified information sets can be stored (1260) as part of an authoritative information set for the given named entity. The highest scoring attribute values can come from any combination of the identified information sets (or all from the same identified information set). Of note, storing an authoritative information set for a given entity is functionally equivalent to generating an authoritative information set for the given entity. Where process 1200 is performed by a production process server, the production process server can store generated authoritative information set(s) in a production database. While process 1200 is discussed in the context of generating a first authoritative information set for a given entity, of a variety of processes to update existing authoritative information sets. For instance, when a CI system gathers new information for a given named entity or when a CI system merges an additional information set for a given named entity, the CI system may update the existing authoritative information set for the given named entity using similar techniques to those described with respect to FIG. 12. Accordingly, it should be appreciated that although various techniques for generating authoritative information sets are described above with respect to FIG. 12, any of a variety of processes can be utilized to generate authoritative data from a set of data as appropriate to the requirements of specific applications in accordance with embodiments of the invention.

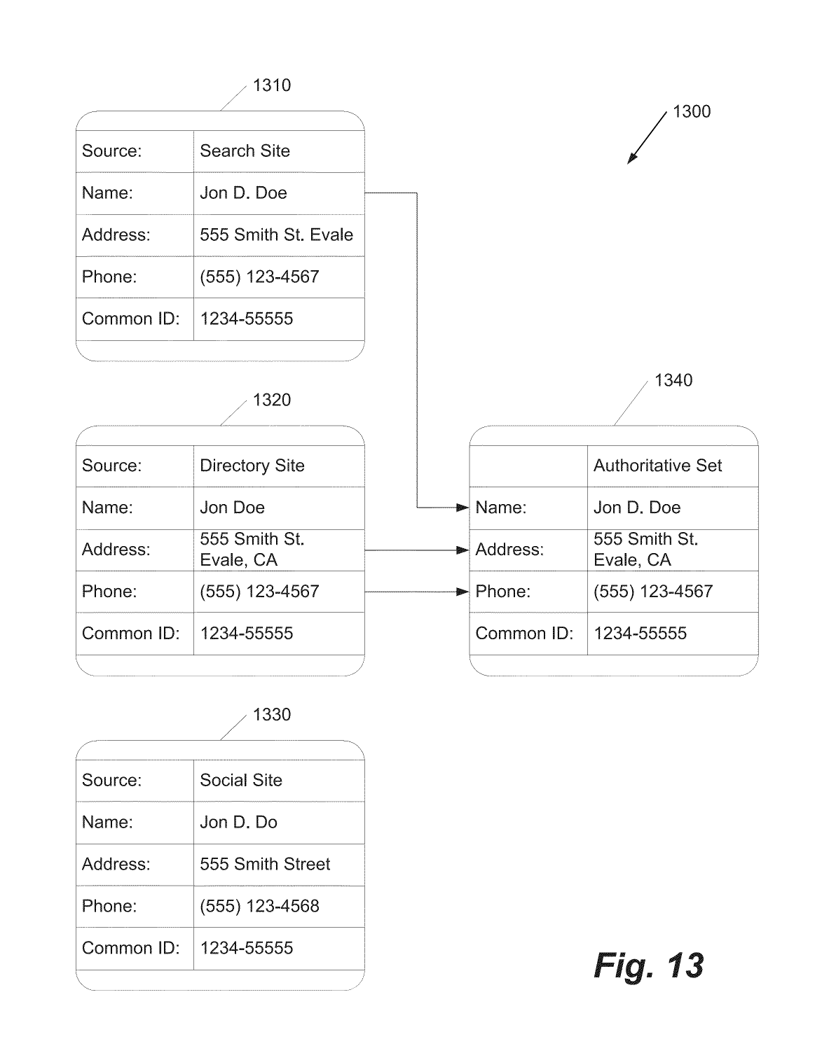

Having discussed the generation of authoritative information sets in connection with process 1200, the following discussion will detail examples of information sets being used to generate an authoritative information set. Information sets used to generate an authoritative information set are conceptually illustrated in FIG. 13. Example 1300 includes identified information sets 1310, 1320, and 1330 after they have been identified by an authoritative information set identification process (such as process 1200 of FIG. 12). In example 1300, the attribute values of information sets 1310, 1320, and 1330 are used to generate an authoritative information set 1340 for “Jon D. Doe”.

Information sets 1310, 1320, and 1330 are gathered from various information sources and/or are previously merged as information sets belonging to “Jon D. Doe”. Information sets 1310, 1320, and 1330 all share a common ID of 1234-55555 assigned to merged information sets for “Jon D. Doe”. Information sets 1310, 1320, and 1330 each include several attribute value pairs. The attribute value pairs include names, addresses, and phone numbers. In addition, a source identifier field and a common ID field are present in each of the information sets. Other information sets may include additional attribute value pairs and fields storing additional information, such as (but not limited to) time gathered, time stored, source ratings, and/or files sizes); or fewer attribute pairs and fields. For instance, some information sets do not include a Common ID field. In addition, other embodiments of the invention may include additional attribute value pairs for multiple names, multiple addresses, and multiple phone numbers. For instance, the attribute value pairs can include cell phone number, home phone number, and work phone number. As can be appreciated, any of a variety of information types and/or attribute value types can be utilized appropriate to the requirements of specific applications in accordance with embodiments of the invention.

As indicated in FIG. 13, information set 1310 is gathered from Search Site, information set 1320 is gathered from Directory Site, and information set 1330 is gathered from Social Site. CI systems can rely on ratings maintained for different sources with regard to their reliability for different attribute value types. The different sources shown in information sets 1310, 1320, and 1330 each have different ratings for reliability for different attribute value types. In example 1300, Search Site has a high rating for names, Directory Site has a high rating for addresses and phone numbers, whereas Social Site has low ratings for most attribute value types. Accordingly, the name attribute value from information set 1310 can be given a high score and the address and phone number attribute values from information set 1320 can be given a high score. Due to Social Site's low reliability rating for all attribute value types, no attribute values from information set 1330 can receive a high score in example 1300. Of note, identical phone numbers are repeated across information set 1310 and information set 1320. Therefore, CI systems in accordance with a number of embodiments of the invention can score the phone number attribute values for information set 1310 and information set 1320 highly.

Authoritative information set 1340 includes the high scoring attribute values from information set 1310 and information set 1320. As indicated by the arrows, authoritative information set 1340 includes the name attribute value from information set 1310 and the address and phone number attribute values from information set 1320. Authoritative information set 1340 shares a common ID with information sets 1310, 1320, and 1330 to indicate its relationship with the merged information sets. While a particular example is illustrated in FIG. 13, different CI systems in accordance with embodiments of the invention can utilize various techniques statistics, attribute values, and information sets generating authoritative information sets.

### Generating and Scheduling Crawls for Information

CI systems in accordance with many embodiments of the invention merge information sets, generate authoritative information sets, and relate various sets of information for different named entities. In addition, CI systems can receive queries from users regarding gathered information. These and other operations can be the basis for generating and scheduling crawls for information. For instance, where a CI system receives a user query that contains a particular attribute value that relates to a previously merged information set, the CI system can generate a crawl for information to seek out additional information related to the attribute value. In addition, a CI system can update scheduled batches of crawls for information, where authoritative information sets have not been updated for certain periods of time.

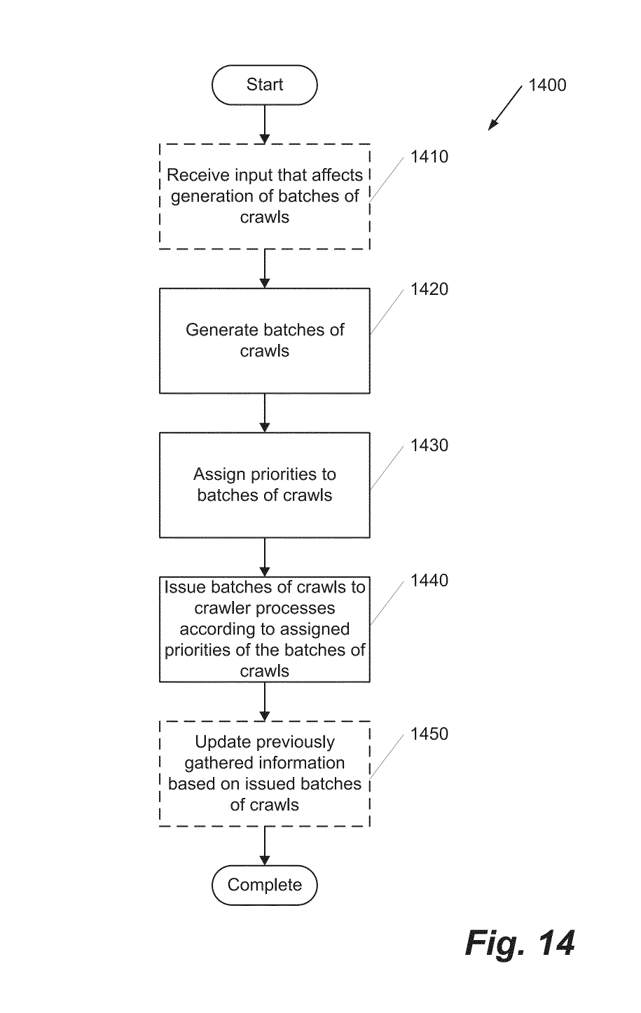

A process performed by a CI system to generate and schedule batches of crawls for information that take into account received input from other CI system operations in accordance with an embodiment of the invention is illustrated in FIG. 14. Process 1400 includes optionally receiving (1410) input that affects generation of batches of crawls for information. Numerous types of input can affect the generation of batches of crawls for information. For instance, CI systems can account for the output of the operations of the CI system. Where insights have been made based upon gathered information, such as the merger of information sets, the generation of authoritative information sets, or the relating of information sets, these insights can be the basis for generating crawls for information. Furthermore, actions and inputs received by the CI system over user interfaces can affect the generation of batches of crawls for information. User queries for information may necessitate or suggest the generation of crawls for information. In addition, user interaction with the CI system can prompt the scheduling of crawls for information used to populate a user interface generated in response to a user interaction. For example, a CI system may crawl for information with regard to a customer for which a user of the CI system seeks information. As the crawling for information is affected by and affects almost all operations of a CI systems in accordance with several embodiments of the invention, the operations and functionalities listed herein are not exhaustive with regard to the inputs that can affect the generation of batches of crawls for information.

Batches of crawls for information can be generated (1420). In several embodiments, the batches are automatically generated as part of a general crawling of all available information sources. The generation of a batch of crawls can also take into account received input from user interfaces, CI operations, and CI functionalities as discussed above. Batches of crawls for information can include instructions to gather information from many different types of information sources. As can be appreciated, any of a variety of information sources can be crawled depending upon the requirements of the specific applications in accordance with embodiments of the invention. In a number of embodiments, existing batches of crawls can be updated and/or re-prioritized in addition to generating batches of crawls.

Priorities can be generated (1430) to the generated and/or updated batches of crawls. Where a particular crawl was generated in response to a user query, the particular crawl can be given a high priority to reflect the real time nature of the user query. Whereas a crawl that is to be performed on a cyclical basis as a background process can be given a low priority. The generated and/or updated batches of crawls to can be issued (1440) to crawler processes according to assigned priorities batches of crawls can be performed to gather information for use in CI operations.

Previously gathered information sets can be (optionally) updated (1450) based on information gathered from the issued batches of crawls. For instance, where an issued crawl for information relating to a user query returns new information with regard to a particular named entity, a CI system can update merged, related, and/or authoritative information sets concerning the particular named entity with the new information. In many embodiments, an update operation (1450) is performed by separate servers than those that perform the crawls. For example, an updating operation (1450) can be performed by an application server, merge process server, production process server, and/or relation process server. Furthermore, the update operation (1450) can be applied to information stored in feeds database and/or production database.

While process 1400 is illustrated as a discrete process with a start and a completion, in multiple embodiments the scheduling of batches of crawls, generation of crawls, and/or issuing of crawls, are performed as a continuous process that accepts input from various operations of CI systems and updates gathered information with newly crawled information in a continuous manner. While the operations described as part of process 1400 were presented in the order as they appeared in the embodiments illustrated in FIG. 14, various embodiments of the invention perform the operations of the processes in different orders as required to implement the invention.

### Relating Information Sets and Identifying Customers of Businesses

CI systems in accordance with multiple embodiments of the invention can relate merged, authoritative, and/or other gathered information sets for named entities. Relationships can be identified using several different techniques in varying embodiments. For instance, where a CI system in accordance with embodiments of the invention has identified a transaction between entities, the CI system can use this transaction to establish a relationship between the entities. Alternatively, or in addition to using transaction data, the CI system can use content correlations between information sets to identify relationships between the entities associated with the information sets. In addition, geographic correlations between information sets can be identified using geographic location information associated with and/or included in each of the information sets. These varying relationship identification techniques allow CI systems in accordance with embodiments of the invention to identify current and potential customers of businesses from gathered information sets. Identified current and potential customers of businesses can also be used to form customer lists for businesses, assist in targeting of campaigns, and further CI system functionalities that will be described in greater detail below.

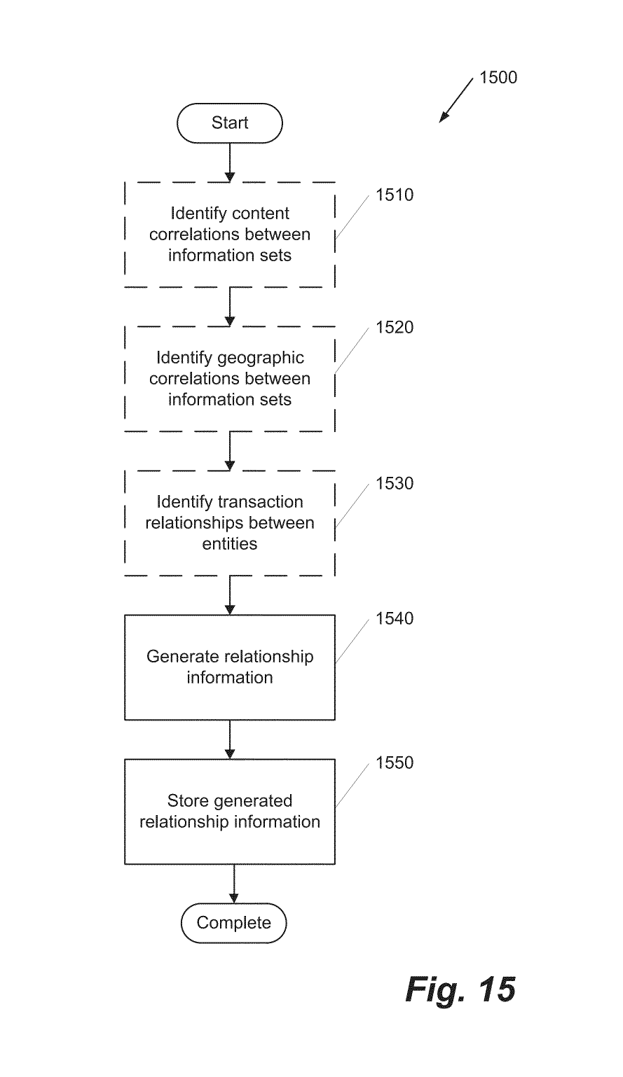

A process 1500 to identify relationships between named entities in accordance with an embodiment of the invention is illustrated in FIG. 15. Process 1500 can impart meaning to the information gathered via other processes. Several different techniques can be used as a part of process 1500. For instance, content correlations can optionally be identified (1510) between information sets for different named entities. Content correlation identification includes identifying similar and/or matching content in different information sets for different named entities. Content correlations can include (but are not limited to) the mentioning of entity names in multiple information sets, the discussion of a named entity in a social media post of a different named entity, discussions of businesses in reviews by consumers, similar times and listed locations for information sets, and/or similar metadata. Content correlations can also be identified between groups of merged information sets for different named entities and/or between different authoritative information sets for different entities. In addition, content correlations can be identified between information sets of varying types for same or different entities. In various embodiments, the correlated information sets can be merged information sets belonging to different named entities and/or authoritative information sets for different named entities.

Geographic correlations between information sets can optionally be identified (1520). Geographic correlation identification includes identifying where different information sets for different named entities have similar geocodes and/or addresses attribute values. Geographic correlations between geocodes and/or addresses attribute values across information sets for different entities can be the basis for identifying relationships between entities. For instance, a geographic correlation can occur where a social media post has geographic metadata that is similar to a business address. Geographic correlations can be of particular use in identifying relationships between different types of entities, such as relationships between consumers and businesses, businesses and businesses, and/or consumers and consumers. Information sets for consumers that include geographic location information similar to that of information sets for businesses can be used to identify said consumers as customers of said businesses.

Transaction relationships between information sets of different entities can optionally be identified (1530). Other processes in accordance with embodiments of the invention, such as the transaction gathering processes described above, may be used in conjunction with process 1500 to gather transaction information as a part of identifying transaction relationships. In addition, transaction relationships can be identified directly via transaction gathering processes or indirectly by inference through content similarities between information sets. The identified transactions can be used in establishing relationships between named entities listed as parties to the identified transactions. As discussed above, many embodiments gather information regarding consumers from (but not limited to) landline phone records, mobile phone records, email messages, web data, loyalty systems, discount programs, point of sale systems, credit card gateways, and/or credit card records from merchants. This gathered consumer information can also be used to identify transactions between consumers and businesses, and thereby identify customers. For instance, a phone record for a consumer can be used to identify a business that was called on the phone record. Specifically, call tracking lines and/or crawling phone record documents provided by a merchant user can yield transaction relationship information. Often, tracking lines and/or crawling phone records can be accessed using a phone provider's information through a website and/or an API. Also, the consumers identified in gathered credit card records can then be identified as customers of merchants from which the credit card records were gathered.

Relationship information describing relationships between information sets and/or named entities can be generated (1540). The relationship information generated (1540) can incorporate information identified using the several techniques (1510, 1520, and/or 1530) used from process 1500. Content correlations can be used to generation relationships between information sets that relate to a same entity. Geographic correlations can be used to link information sets from different entities to a common location. Transaction relationships can be used to identify when consumers have become customers or businesses. In addition, some embodiments of the invention can infer that consumers could be potential customers of a business where identified content correlations, geographic correlations, and/or transaction relationships suggest such potential. Various embodiments include thresholds of correlation and similarity for establishing relationships. In many embodiments, information sets are marked as being related using identifiers shared across related information sets.

Relationship information can optionally be stored (1550). In many embodiments, the generated relationship information is stored in a production database as sub-components of authoritative information sets for various entities. For instance, the stored relationship information may be stored as a part of one or more authoritative information sets and/or merged information sets for which the relationship information describes relationship(s) for named entities. Various embodiments may use different database configurations for storing relationship information, such as storing the relationship information in a feeds database, a production database, a customer database, and/or a merge database. The stored relationship information can include (but is not limited to) landline phone records associated with customers and/or businesses, mobile phone records associated with customers and/or businesses, email messages between customers and/or businesses (can be to, from, cc, and/or in bodies of email messages such as in the signature line of the email messages), web data to, from, or exchanged between customers and/or businesses (such as reviews, checkins, likes, follower status, and/or mentions), information linking customers to businesses from loyalty and/or discount systems and programs, point of sale systems indicating customer relationships, credit card records from credit card gateways, and/or credit card records from merchants. While the operations described as part of process 1500 were presented in the order as they appeared in the embodiments illustrated in FIG. 15, various embodiments of the invention perform the operations of the processes in different orders with varying optional operations as required to implement the invention.

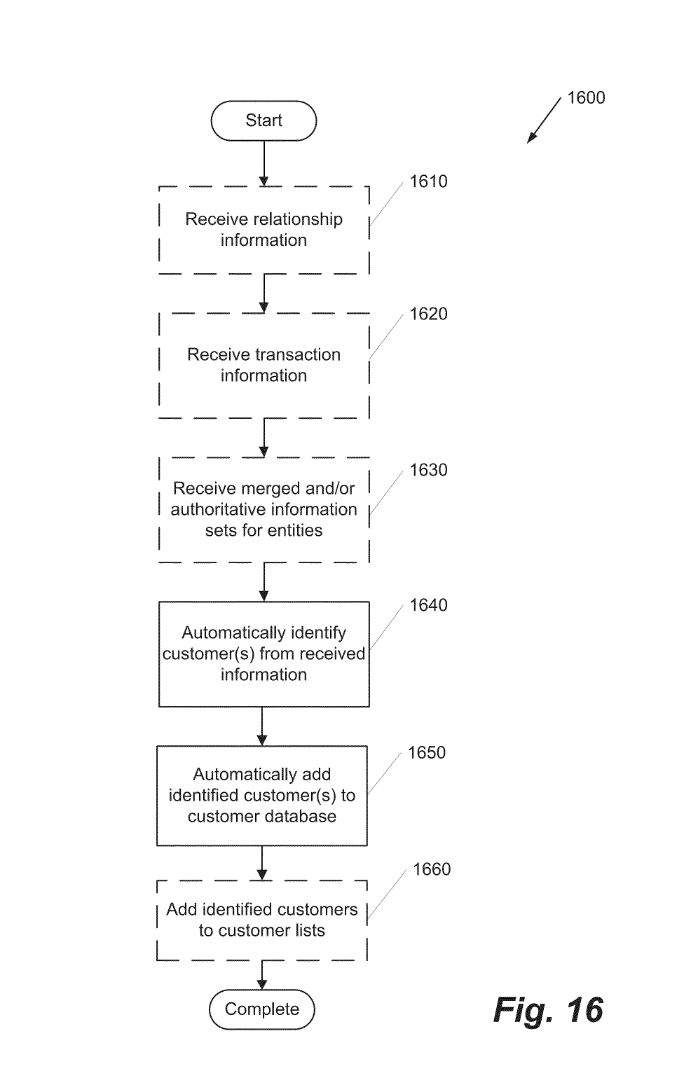

Relationships between existing and/or potential customers and businesses are of particular relevance for CI systems. Embodiments of the invention can use generated relationship information along with other information to identify consumers as current and/or potential customers of businesses. In addition, identified customers can be placed into customer lists associated with businesses. A process 1600 to identify current and/or potential customers of in accordance with an embodiment of the invention is illustrated in FIG. 16. Process 1600 can receive and utilize information from various sources. These sources can include other components of CI systems in accordance with embodiments of the invention. For instance, several of the databases discussed above can be used as sources of information to be utilized in identifying potential and/or current customers of businesses. In addition, processes in accordance with many embodiments of the invention can output information that can be received and utilized by process 1600 in identifying customers. For instance, process 1600 can receive and utilize information including (but not limited to) generated relationship information, gathered transaction information, merged information sets, and/or authoritative information sets to identify current and/or potential customers of businesses. In some embodiments, process 1600 is performed as a sub-process of a larger process for providing CI functionalities. In these embodiments, the generated relationship information, transaction information, merged information sets, and/or authoritative information sets may be gathered and/or generated as a part of the larger process.

Relationship information can optionally be received (1610). In many embodiments, relationship information is stored in a production database along with or as a part of authoritative information sets. Thus, the relationship information can be received from a production database of a CI system in many embodiments. The received relationship information can include (but is not limited to) telecommunication bills gathered via optical character resolution, APIs, logins, or crawling; call records tracking communications between consumers and businesses and/or merchants; and/or any of the above described examples of relationship information.

Transaction information can optionally be received (1620). In several embodiments, transaction information is stored in a production database along with or as a part of authoritative information sets and/or stored in a feeds database along with or as parts of merged information sets. Thus, the relationship information can be received from a production database and/or a feeds database of a CI system. The received transaction information can include (but is not limited to) transactions between consumers and businesses and/or merchants; credit card transactions; and/or any of the above described transaction gathering techniques.

Merged and/or authoritative information sets for entities can optionally be received (1630). In some embodiments, merged information sets are stored in a feeds database and authoritative information sets are stored in a production database. Thus, the merged and/or authoritative information sets can be received from a production database and/or a feeds database of a CI system. The received merged and/or authoritative information sets can include (but is not limited to) web forms and email accounts that are parts of merged and/or authoritative information sets for entities; reviews associated with merged and/or authoritative information sets for entities; checkins that are parts of merged and/or authoritative information sets for entities; likes, follows, and/or followers that are parts of merged and/or authoritative information sets for entities; mentions of businesses that are parts of merged and/or authoritative information sets for entities; mobile app operations and/or data that are parts of merged and/or authoritative information sets for entities; and/or any of the above described merged and/or authoritative information set generation techniques.

Customers can be automatically identified (1640) utilizing the received relationship information (1610), transaction information (1620), merged information sets (1630), and/or authoritative information sets (1630). While the above discussion of receiving relationship information (1610), transaction (1620), and merged and/or authoritative information sets (1630) provided several examples for each respective information category, embodiments of the invention can use examples from different categories and/or other information as necessary to implement CI functionalities. Thus, process 1600 can utilize various combinations and sub-combinations of the different information types that can be optionally received as discussed above.

The identified customers can be automatically added (1650) to a customer database. Different embodiments of the invention may utilize different storage techniques involving any variety of storage mechanisms. The identified customers can optionally be added (1660) to customer lists for businesses and/or merchants. In some embodiments, the customer lists are stored in a database of a CI system. For instance, embodiments may store the customer lists in a customer database and/or a customer list database. Customer lists of existing customers can be used by embodiments of the invention to produce typical customer profiles

Although specific processes are described above with respect to FIGS. 15 and 16 for identifying customers and generating customer lists, any of a variety of processes can be utilized to identify relationships between different types of named entities and/or generate customer lists as appropriate to the requirements of specific applications in accordance with embodiments of the invention. Customer lists of potential customers can be used by CI systems in accordance with various embodiments of the invention to automatically generate advertising campaigns and in the targeting of advertising campaigns. The automatic generation of advertising campaigns in accordance with embodiments of the invention is discussed further below.

### Advertising Targeting Using Identified Customers

CI systems in accordance with numerous embodiments of the invention can utilize identified customers to generated advertising targeting data and/or advertising campaigns. Advertising networks typically receive targeting information and display ads and/or creatives based on the received targeting information. Advertising targeting data is data that is provided to an advertising network that enables the advertising network to determine the circumstances under which an advertisement should be displayed. Advertising targeting data can include varying types of data that can be provided to advertising networks. The advertisement displayed by the advertising network can be automatically generated by the network and/or provided as part of the advertising campaign. Advertising networks can be a part of CI systems in accordance with many embodiments of the invention, or the advertising networks can be provided as a service by server systems maintained by third parties. CI systems in accordance with several embodiments of the invention can leverage the power of customer information aggregated within a customer database from a variety of information sources to target ads more effectively using one or more advertising networks. For example, a CI system can utilize information posted by a customer of a business on a first social network in an advertisement targeting users of a second social network having a known relationship to the customer.

In several embodiments, characteristic data describing named entities corresponding to customers of a business maintained within the customer database of a CI system can be utilized to generate demographic targeting information corresponding to a typical customer of the business. In a number of embodiments, characteristic data describing named entities corresponding to customers of a business maintained within the customer database of a CI system can be utilized to identify specific user identities to target via an online social network associated with existing customers, and/or potential customers matching a typical customer profile. In many embodiments, characteristic data describing named entities corresponding to customers of a business maintained within the customer database of a CI system can be utilized to automatically identify posts to online social networks that can be promoted and/or utilized as creatives in advertising campaigns. In certain embodiments, user identities to specifically target using the promoted posts are also identified using the characteristic data describing specific named entities corresponding to customers within the customer database maintained by a CI system.

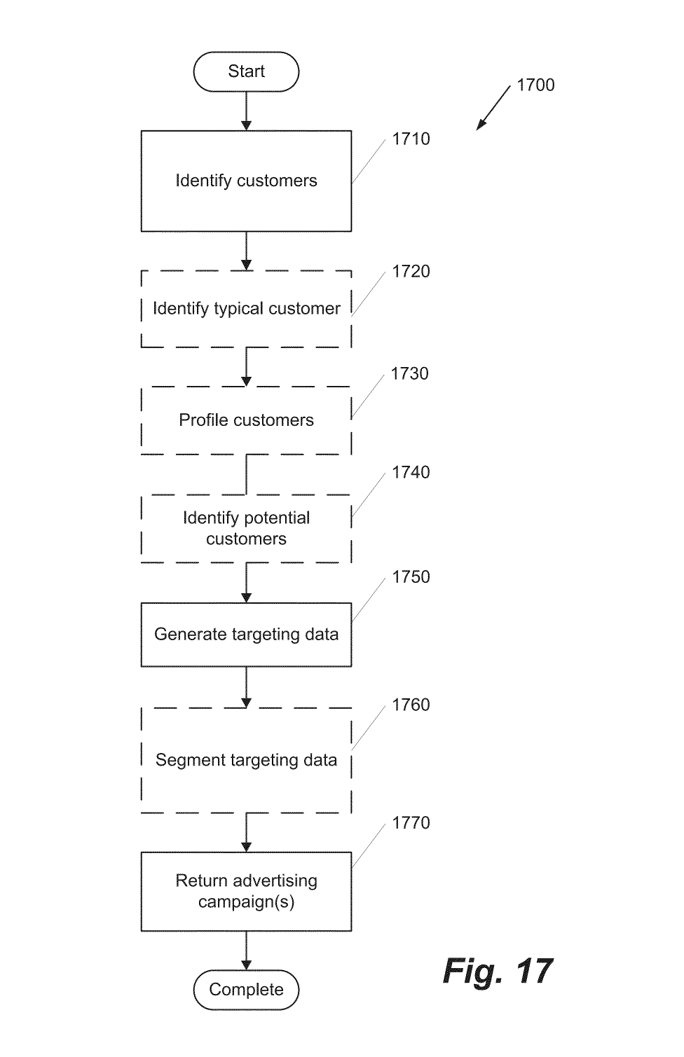

A process 1700 that can be utilized to generate one or more advertising campaigns in accordance with an embodiment of the invention is illustrated in FIG. 17. Customers of a business can be identified (1710). In some embodiments, potential and/or current customers of a business are identified in a customer database. Characteristic data associated with named entities corresponding to the identified potential and/or current customers within the customer database can be utilized to generate demographic information to target with an advertising campaign.

Demographic information can include (but is not limited to) language, location, age range, gender, level of education, interests, behaviors marital status, number of children, and/or additional examples of demographic information discussed above. As can readily be appreciated, the types of demographic information that can be gathered for use in targeting is typically determined based upon the ability of the CI system to gather characteristic data from remote information sources that is relevant to the demographic targeting capabilities of specific advertising networks.

A typical customer can optionally be identified (1720). In many embodiments, the typical customer is a “good” customer for the business that would tend to spend more than an average amount of money over time for the business or more than a threshold amount of money. Any of a variety of processes described herein can be utilized in the scoring of customers and/or estimating the revenue generated by specific customers can be utilized to generate a typical customer profile as appropriate to the requirements of specific applications in accordance to embodiments of the invention. Identification of a typical customer can optionally be used in profiling (1730) customers to directly target and/or use as a seed to perform look-alike targeting. In addition, potential customers who are similar to the identified typical customer and/or a set of seed customers can be identified (1740).

Advertising targeting data can be generated (1750) based upon customer information associated with the actual and/or potential customers identified during the generation of the advertising campaign. The advertising targeting data generated can include (but is not limited to) demographic targeting data, location targeting data, user targeting data, and/or keyword targeting data. In several embodiments, the advertising targeting data is generated by the CI system using characteristic data maintained in the customer database describing individual actual and/or potential customers such as (but not limited to) characteristic data describing a phone number, an email address, an IP address, name and location, specific devices, and/or any other piece of data that can be utilized by an advertising network to individually target a specific individual. In several embodiments, the advertising targeting data can also target based on general information such as (but not limited to) general profiles, interests, niches, and/or any other generalized targeting methods provided by a given advertising network. As an example of general targeting, advertising targeting data can be directed to persons who have an interest in motorcycling, are 30-50, are male, are married, have no children, and live in Pasadena. The example includes demographic targeting information, interest targeting information, and location targeting information that can all be derived from characteristic data describing named entities corresponding to customers and/or potential customers of a business that is maintained in the customer database. Moreover, advertising targeting data can include generic targeting that identifies individuals according to their uses of relevant websites, apps, and/or media. For instance, generic targeting can target individuals based on numbers of visits to a particular website or uses of a specific app. As can readily be appreciated, the manner in which a named entity described within the customer database can be targeted is only limited by the types of characteristic data aggregated about the named entity from different information sources and the targeting capabilities of specific advertising networks.

The generated advertising targeting data can optionally be segmented (1760) into more narrow categories of advertising targeting data. The segmentation can be accomplished by profiling a database of existing customers to identify points for segmentation. Segmentation of customers to target can occur along demographic lines, such as (but not limited to) age, location, marital status, children status, household income, education levels, home ownership, and/or gender. The targeting advertising data segmented to the following (but not limited to) categories of ads and ad platforms: targeting to search ads, targeting to display ads, targeting to mobile devices, targeting to mobile ads, targeting to emails, targeting to social networks, targeting to social sharing sites, and/or targeting to phones.

The final advertising targeting data can be used to generate one or more advertising campaign that can be output (1770) to an advertising network for distribution and display. Specific combinations of advertising targeting data can be utilized to generate campaigns for different types for advertising networks. For example, demographic, location, and/or keyword targeting data can be utilized to generate targeted search advertising campaigns. Similarly, demographic, location, and/or keyword targeting data can be utilized to generate display advertising campaigns. In several embodiments, demographic, location and/or keyword targeting data can be utilized to generate advertising campaigns for advertising networks that target advertising via social media posting. CI systems can also be utilized to generate specific user targeting information that can be used to generate advertising campaigns for advertising networks that can target advertising to specific users of a service (e.g. social media services, and/or email services). In many embodiments, location targeting data can be generated to assist with the targeting of location based advertising campaigns. As can readily be appreciated, the specific advertising targeting data utilized in the generation of an advertising campaign typically depends upon the capabilities of a specific advertising network to target advertising. In a number of embodiments, CI systems can develop multiple advertising campaigns that are provided by multiple advertising networks to target users of different services and/or based upon different targeting criterion appropriate to each of the advertising networks. The final advertising campaign(s) can direct advertising networks to display ads that include (but are not limited to) pay per click ads, pay for performance ads, banner ads, mobile ads within apps, and/or mobile ad networks according to device characteristics. The creative for the advertisements can be manually generated, automatically generated using targeting keywords and templates, and/or automatically generated using social media posts. Processes for generating specific types of targeting data and the generation of various different types of advertising campaigns in accordance with embodiments of the invention are discussed further below.

Although specific processes for generating one or more advertising campaigns are described above in the context of FIG. 17, any of a variety of processes can be utilized to generate advertising campaigns using customer data obtained using any of the techniques described above as appropriate to the requirements of specific advertising platforms in accordance with embodiments of the invention. Specific processes for generating a variety of different types of advertising campaigns are discussed below. Before discussing the generation of advertising campaigns, however, processes for building individual customer profiles and typical profiles that can be presented to a user and/or utilized in the generation of advertising campaigns are discussed below.

### Generating and Presenting Customer Profiles

In many embodiments, CI systems can generate and present customer profiles for an individual consumer that interacts with a specific named entity such as (but not limited to) a business. A customer profile can contain information including (but not limited to) transaction histories, various spending ratings, and/or demographic details regarding a customer. A customer profile can be generated by identifying a relationship between a specific consumer and a given business. In numerous embodiments, information regarding an individual consumer can be used to generate customer profiles with respect to multiple businesses (e.g., one consumer can have two customer profiles, one profile for a first business and a second profile for a second business).

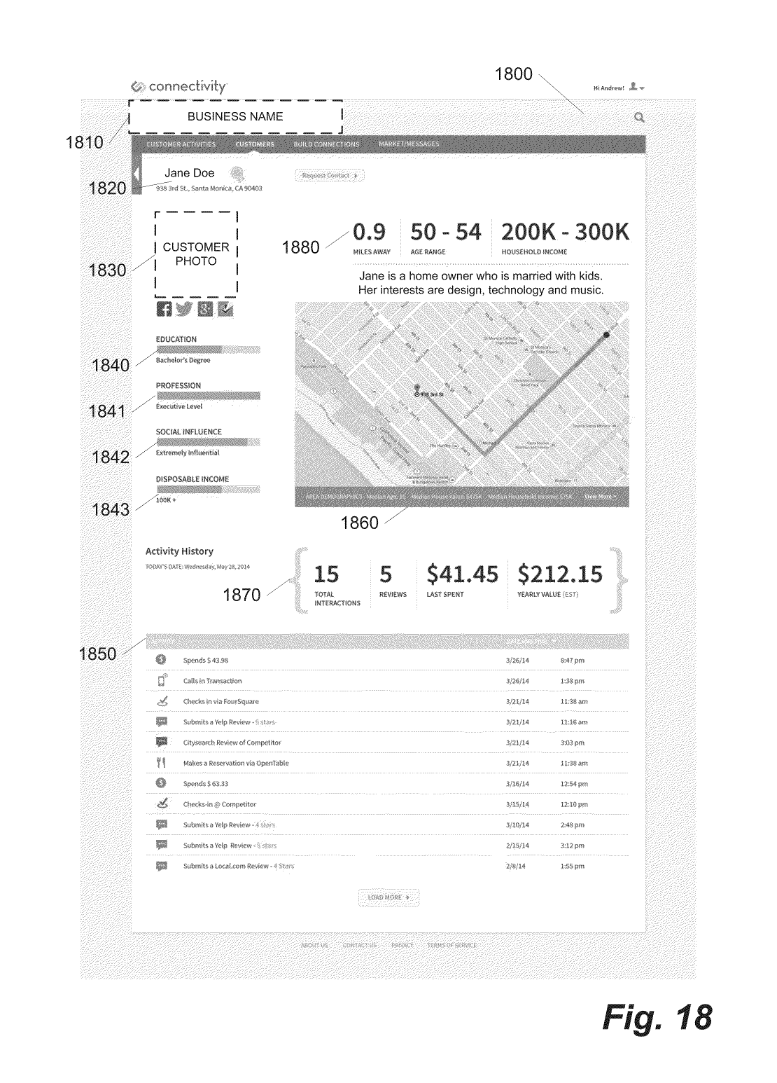

FIG. 18 shows a user interface that enables a user to access a customer profile 1800 of a customer of a business. Customer profile 1800 provides several functionalities and displays various data to a user of the user interface. Customer profile 1800 includes a business name indicator 1810. In some embodiments, the business name indicator 1810 indicates a merchant who is a user of the CI system. In many embodiments the information presented in customer profile 1800 is information from merged information sets and authoritative information sets for a specific customer of a business.

Customer profile 1800 also includes a customer name indicator 1820 that in this case indicates a name of “Jane Doe”. Customer profile 1800 displays several data points for the customer indicated by the customer name indicator 1820. In several embodiments, the customer name indicator 1820 indicates a name of a customer for which the CI system stores several merged information sets and at least one authoritative information set. For instance, the information presented in customer profile 1800 can be from merged information sets and an authoritative information set for “Jane Doe”.

Customer profile 1800 displays several ratings 1840-1843 for “Jane Doe”. These ratings include levels of education 1840, professional status 1841, social influence 1842, and disposable income 1843. The ratings are derived by the CI system by analyzing merged and authoritative information sets related to “Jane Doe”. In addition, customer profile 1800 shows an activity timeline 1850 for “Jane Doe”. The CI system can generate an activity timeline using transaction histories generated from merged information sets. For instance, a CI system can populate a transaction history for a consumer, where: the consumer has interacted with mobile devices at locations corresponding to a business; consumers have interacted with social media websites; or publically available credit information reveals that consumers have made purchases at a location of the business. As shown, activity timeline 1850 includes events where “Jane Doe” spent money, checked in via social media sites, and/or submitted to business review websites. In a number of embodiments, each event in a given activity timeline is drawn from information sets merged based upon a particular consumer. For instance, each review submitted for “Jane Doe” can be an information set gathered from a business review website that is merged to be associated with “Jane Doe”.

Customer profile 1800 also displays a map with geographic data that relates the address for the customer indicated by the customer name indicator 1820 with the address for the business indicated by the business name 1810. As shown, a distance and a road route are displayed connecting the addresses of the customer and the business. In addition, customer profile 1800 displays an activity summary showing total interactions, reviews, last transaction spending, and estimated yearly value for the customer indicated by the customer name indicator 1820. The customer profile 1800 also displays a customer summary 1880 that includes distance, age ranges, and household income ranges for the customer indicated by the customer name indicator 1820.

As mentioned above, CI systems need do not expose all of the information the CI systems has gathered with respect to a customer. CI systems of some embodiments can gather more information than the users of CI systems have rights to access. Often, the users of the CI systems are merchants seeking information on customers associated with businesses. Merchant users often do not have rights to access certain otherwise public information gathered by the CI systems of some embodiments. Accordingly, customer summary 1880 reveals only age ranges and household income ranges, rather than specific data with regards to “Jane Doe”. While the above discussed customer profile 1800 was discussed in connection with a consumer “Jane Doe”, embodiments of the invention are not limited to the specific consumer or customer shown in customer profile 1800.

The screenshot of customer profile 1800 shown in FIG. 18 shows only a single possible configuration in accordance with an embodiment of the invention. As can be appreciated, any of a variety of information and/or attribute values can be displayed in a customer profile as appropriate to the requirements of specific applications in accordance with embodiments of the invention.

### Generating and Presenting Typical Customer Information

In many embodiments, CI systems can produce typical customer profiles that show information regarding a typical customer of a business. The typical customer profiles provide an overview of information regarding customers to allow merchant users to assess their customers in aggregate. The typical customer profiles can contain information including (but not limited to) transaction histories, various spending ratings, and/or demographic details regarding average customers.

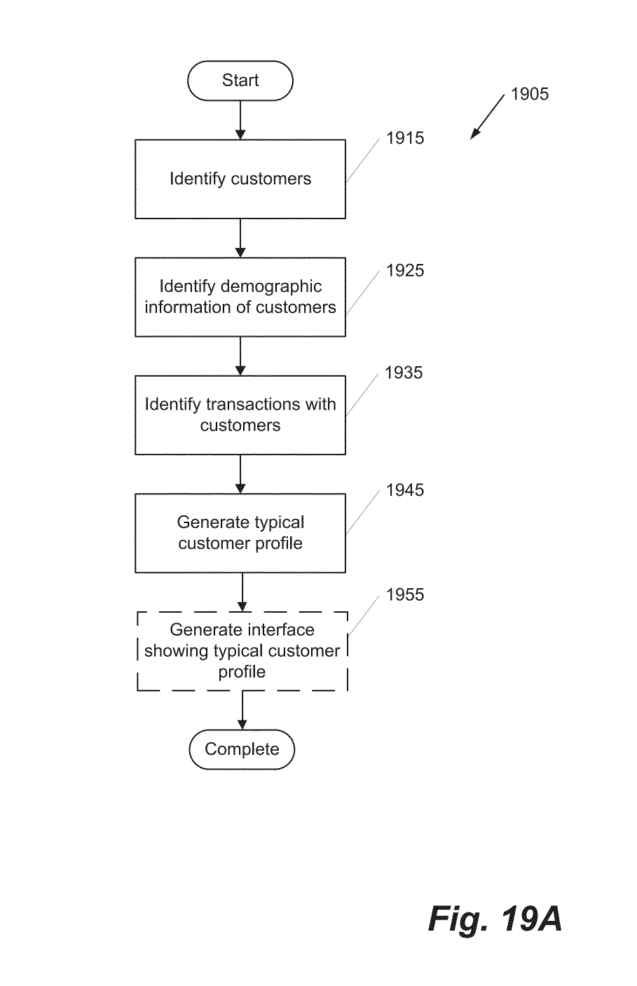

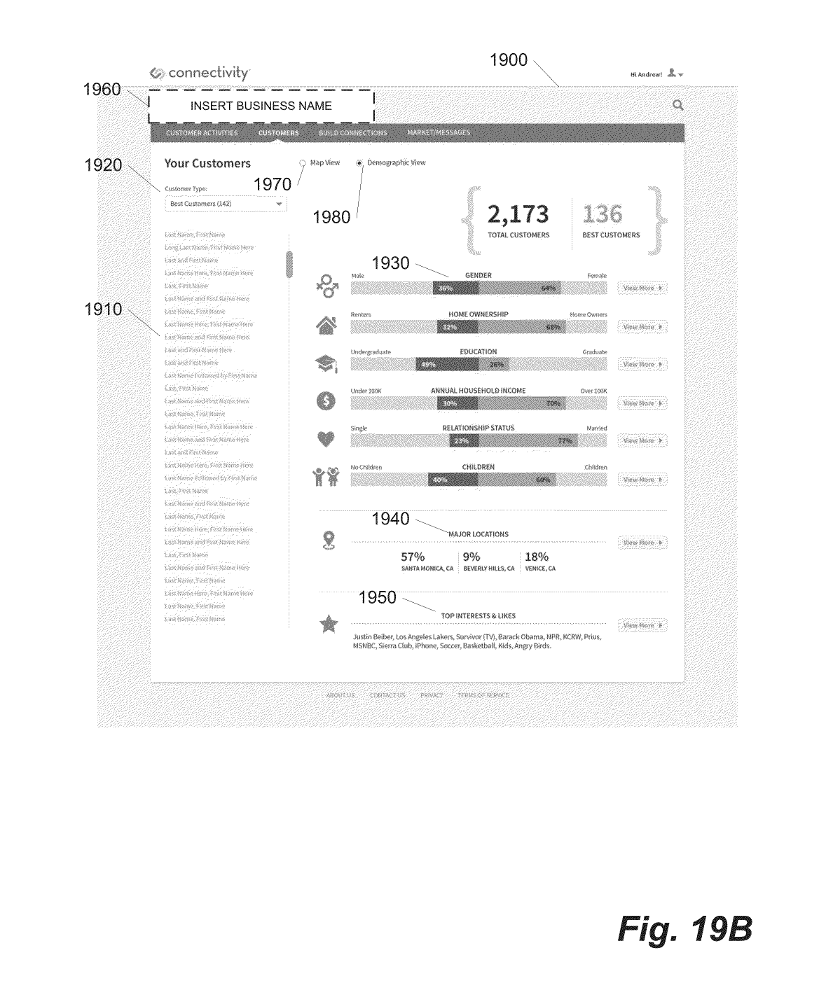

A process 1905 that can be utilized to generate one or more advertising campaigns in accordance with an embodiment of the invention is illustrated in FIG. 19A. Customers can be identified (1915) for a given business. Any of the processes described above for identifying named entities within a customer database corresponding to customers of a business described by authoritative and/or merged data sets stored in databases maintained by a CI system can be utilized in accordance with various embodiments of the invention. In several embodiments, relationship data is maintained by the CI system that can be utilized to identify customers of a business. The relationship information can include (but is not limited to) landline phone records associated with customers and/or businesses, mobile phone records associated with customers and/or businesses, email messages between customers and/or businesses (can be to, from, cc, and/or in bodies of email messages such as in the signature line of the email messages), web data to, from, or exchanged between customers and/or businesses (such as reviews, checkins, likes, follower status, and/or mentions), information linking customers to businesses from loyalty and/or discount systems and programs, point of sale systems indicating customer relationships, credit card records from credit card gateways, and/or credit card records from merchants. The specific relationship information maintained by a CI system is largely dependent upon the available information sources and the requirements of specific applications.

Demographic information for the identified customers can be identified (1925). Identifying information associated with the identified customers can be utilized to query production databases and/or merge databases of a CI system to return characteristic data, authoritative information sets, and/or merged information sets describing the identified customers. Alternatively, any of the processes described above for gathering information for named entities can be utilized in accordance with various embodiments of the invention to identify demographic information of the identified customers.

Transactions for the identified customers can be identified (1925). Identifying information associated with the identified customers can be utilized to query customer, production and/or merge databases of a CI system to return transaction and/or relationship information describing transactions between the identified customers and the given business. The returned transaction information can include transaction values. In some embodiments, estimated transaction values can be generated to estimate the values of transactions for customers, who do not have specific transaction values stored in databases of the CI system.

A typical customer profile can be generated (1945) utilizing the identified customers, customer demographic information, and transaction information. The typical customer profile can include various ranges and averages describing customers of the given business, along with a list of customers for the given business. The typical customer profile can optionally be used to generate an interface (1955) showing the typical customer profile. FIG. 19B shows a user interface that includes a customer analysis page 1900 that includes a typical customer profile of the type generated by process 1905 of FIG. 19A. Customer analysis page 1900 include customer listing 1910, customer listing type menu 1920, average customer statistics 1930, customer location table 1940, a customer top interest list 1950, and a business name indicator 1960. Customer analysis page 1900 also includes map view 1970 and demographic view 1980 indicators. The various statistics, averages, information, and/or data shown on the customer analysis page 1900 can be gathered from databases of a CI system in accordance with embodiments of the invention. Said databases can include customer databases, production databases and/or merge databases.

Customer listing 1910 shows a subset of an automated customer list for a business indicated by business name indicator 1960. The particular subset of the automated customer list for the business indicated by business name indicator 1960 is selected by the customer listing type menu 1920. Customer listing type menu 1920 includes several options for what subset of the automated customer list can be displayed in the customer listing 1910. The several options include (but are not limited to) best customers, most frequent customers, worst customers, and/or all customers. Other embodiments may include additional menu display options as necessary to facilitate the display of information regarding typical customers.

Average customer statistics 1930 includes several statistics for a typical customer of the business indicated by business name indicator 1960. As shown, average customer statistics 1930 includes demographic information on the gender balance of a typical customer, home ownership percentages of a typical customer, education attainment of a typical customer, annual household income of a typical customer, relationship status of a typical customer, and children of a typical customer. Embodiments of the invention are not limited to the particular listed statistics of average customer statistics 1930. Additional statistics may be presented in other embodiments. Customer analysis page 1900 also displays customer location table 1940 and customer top interest list 1950. Customer location table 1940 indicates major locations where customers are concentrated. Customer top interest list 1950 lists several top interests and likes by customers. As shown, customer analysis page 1900 has demographic view indicator 1980 selected. Upon selection of the map view 1970 indicator a different page can be presented. The screenshot of customer analysis page 1900 shown in FIG. 19 shows only a single possible configuration in accordance with an embodiment of the invention. As can be appreciated, any of a variety of attribute values and/or menu options to control the display of the attribute values can be provided in a typical customer profile as appropriate to the requirements of specific applications in accordance with embodiments of the invention.

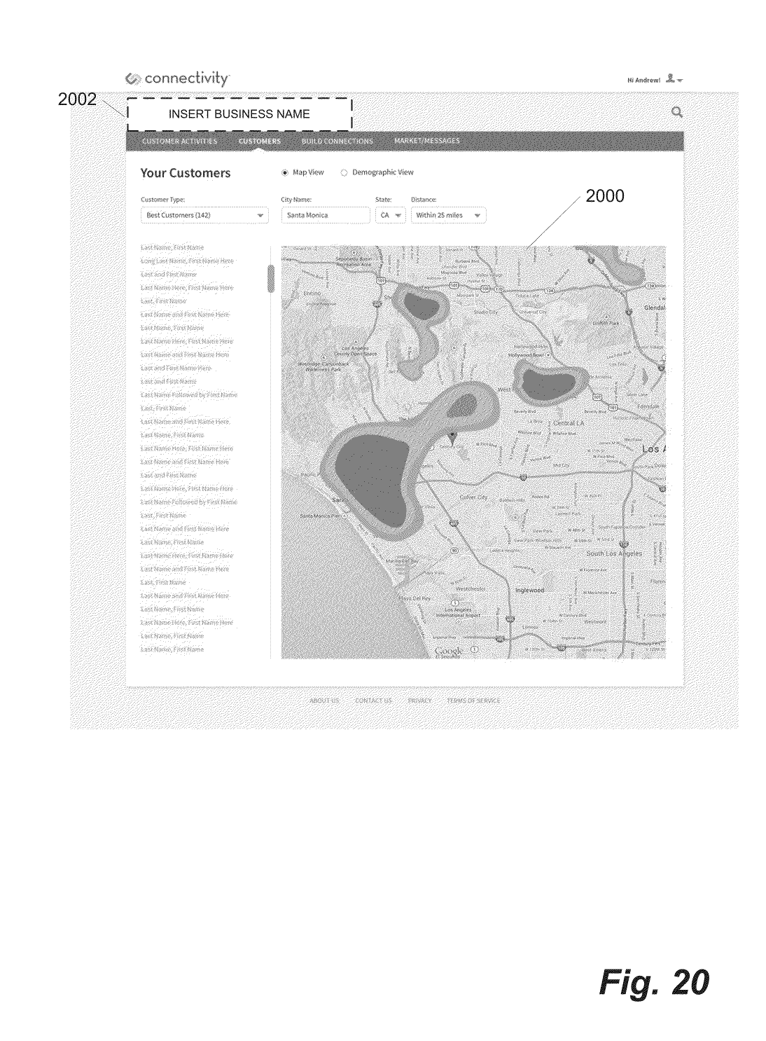

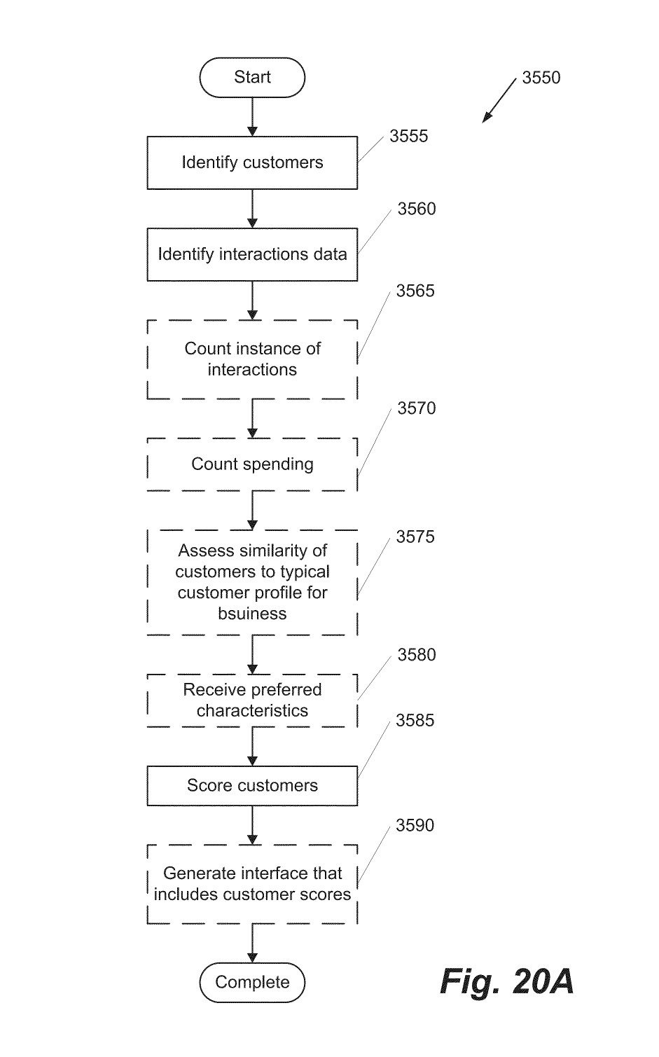

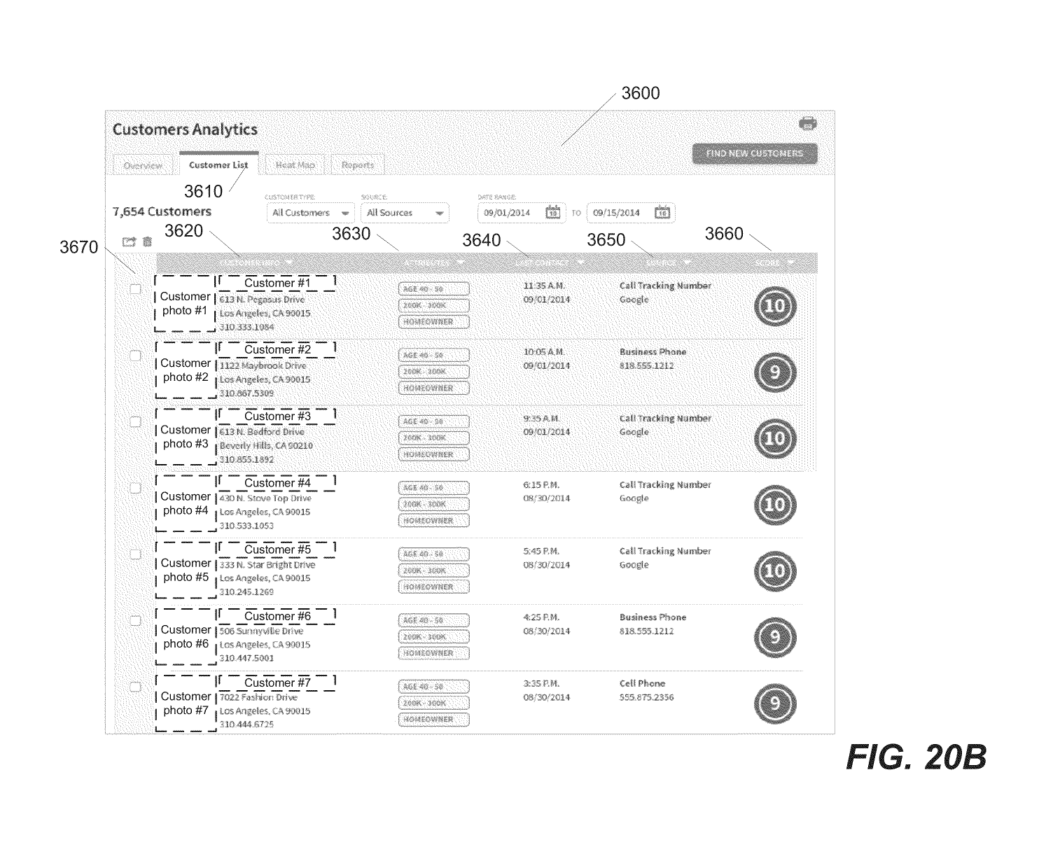

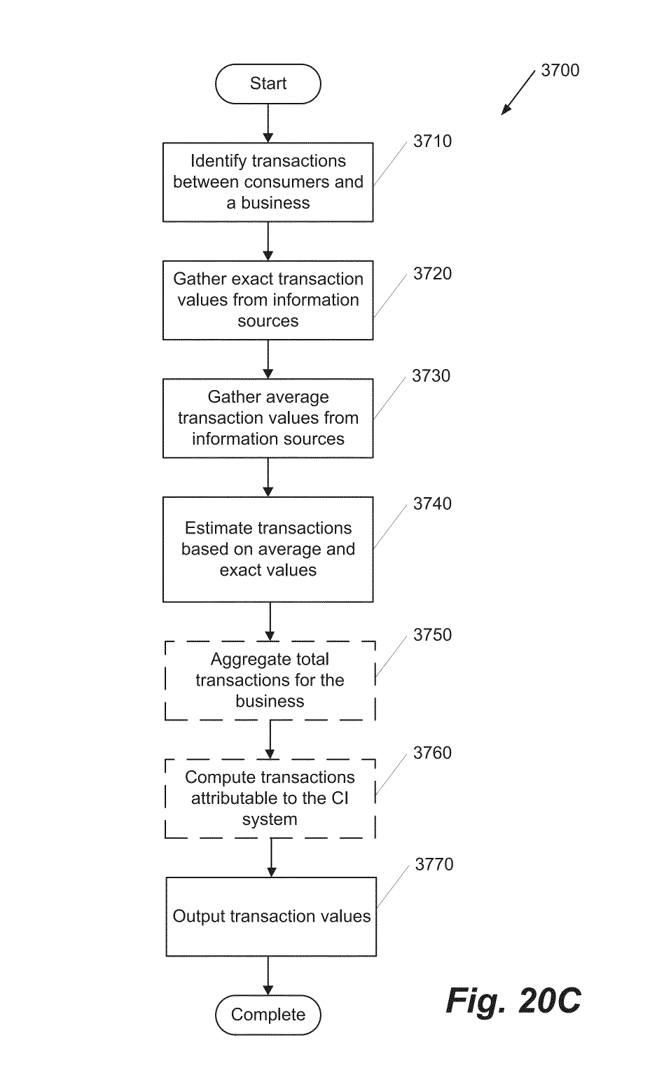

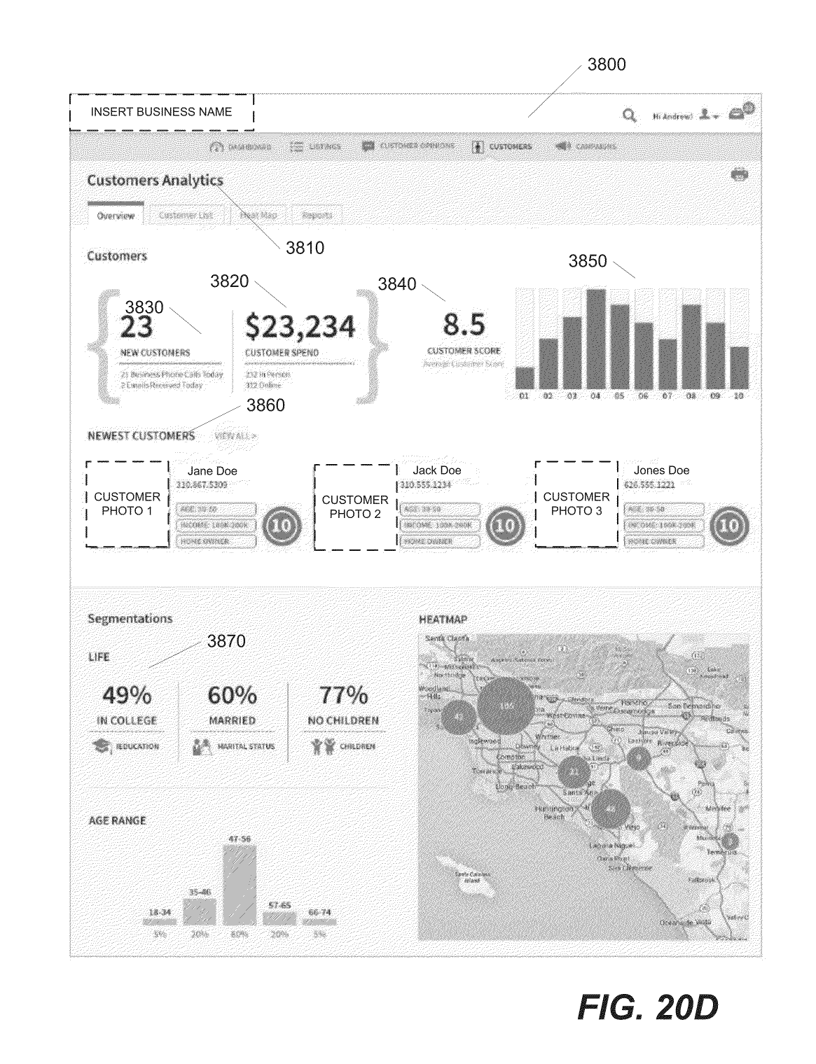

FIG. 20 shows a user interface that includes a customer heat map 2000. The data to support customer heat map 2000 can be stored in the customer, production and/or merge databases of a CI system in accordance with embodiments of the invention. The geographic location information used to generate the customer heat map 2000 can be stored in customer databases, production databases and/or merge databases of a CI system. Customer databases can store the addresses of customers, production databases can store the definitive geographic location information of named entities, and merge databases can also include geographic location information.

Customer heat map 2000 indicates geographic concentrations of customers for the business indicated by business name indicator 1960. In several embodiments, the CI systems use the associations between customer lists and underlying geographic data and/or geographic location information from the merged and/or authoritative information sets for consumers to identify geographic concentrations of customers. The screenshot of customer heat map 2000 shown in FIG. 20 shows only a single possible configuration in accordance with an embodiment of the invention. As can be appreciated, any of a variety of information and/or attribute values can be displayed in a customer heat map as appropriate to the requirements of specific applications in accordance with embodiments of the invention. Some embodiments provide filtering options that allow for only some customers to be displayed on the heat map according to segmenting options. The filtered and/or segmented data can be queried and received from databases of a CI system utilizing filtered queries. For instance, a ZIP code can be provided in the query to filter the results to a specific ZIP code.

The embodiments illustrated in the screenshots shown in FIG. 18, FIG. 19, and FIG. 20 are taken from the perspective of a user that can access all of the information presented within the illustrated screenshots. Some embodiments may limit the ability of different users to access certain information. For instance, lower level users may not have access to all of the customer information that higher level users may have access to. Various embodiments provide interfaces (not shown) for controlling these access levels.

### Scoring of Customers

In many embodiments, CI systems can utilize customer lists and typical customer profiles to score current and/or potential customers of businesses for their value to businesses. Customer scoring allows merchant users of CI systems in accordance with embodiments of the invention to quickly and powerfully survey their customers to identify the most valuable customers. Embodiments of the invention can then provide interactive interfaces for displaying, managing, and communicating with a scored list of customers.

A process 3550 for scoring customers of businesses in accordance with an embodiment of the invention is illustrated in FIG. 20A. Customers can be identified (3550) for a given business. Any of the processes described above for identifying named entities within a customer database corresponding to customers of a business described by authoritative and/or merged data sets stored in databases maintained by a CI system can be utilized in accordance with various embodiments of the invention. In several embodiments, relationship data is maintained by the CI system that can be utilized to identify customers of a business. The relationship information can include (but is not limited to) landline phone records associated with customers and/or businesses, mobile phone records associated with customers and/or businesses, email messages between customers and/or businesses (can be to, from, cc, and/or in bodies of email messages such as in the signature line of the email messages), web data to, from, or exchanged between customers and/or businesses (such as reviews, checkins, likes, follower status, and/or mentions), information linking customers to businesses from loyalty and/or discount systems and programs, point of sale systems indicating customer relationships, credit card records from credit card gateways, and/or credit card records from merchants. The specific relationship information maintained by a CI system is largely dependent upon the available information sources and the requirements of specific applications. In addition, customers can be identified for multiple or single businesses.

Interactions data between customers and businesses can be identified (3560). Interactions data between customers and businesses can be used in order to assess customers. Interactions data can be derived from relationship information, such as customer relationship information that identifies consumers as customers in businesses. As can readily be appreciated, interactions data can include many forms of interactions between consumers and businesses, such as (but not limited to) cash purchases, checkins, walk ins, credit card transactions, debit card transactions, reviews, online mentions, and/or check purchases. Interactions data is stored as characteristics data for named entities in databases for

Instances of interactions with the business can optionally be counted (3565). The generated counts of instances of interactions can include numbers of times customer purchased goods or services for business. In addition, the generated counts of instances of interactions can also include a number of times a customer is detected at a geographic location corresponding to a business independent of any purchasing data. Instances of interactions can be indicated by interactions data for named entities. As previously mentioned, interactions data can be stored in several of the above-described databases of a CI system in accordance with embodiments of the invention. The instances of customer interactions can be counted and used as a factor in scoring customers. Some embodiments recall previously gathered interaction and relationship information for customers on the identified or received customer list from at least one of the above-discussed databases of a CI system. For instance, relationship information can be recalled from the feeds database from named entities that have stored relationship information relating to the given business. Alternatively, some embodiments gather and/or relate additional interaction information for customers on the customer list in order to assess the previous interactions with said customers. In further embodiments, the assessment of the instances of interactions can also include an identification of most recent and first interactions using the relationship information.

Previous spending of customers can be counted (3570). Previous spending of customers can be totaled and used as a factor in scoring customers. Some embodiments recall previously gathered transaction information for customers on the identified or received customer list from at least one of the above-discussed databases of a CI system. For instance, transaction information can be recalled from the feeds database where named entities have been merged with the given business. Alternatively, some embodiments gather and/or estimate additional transaction information for customers on the customer list in order to assess the previous spending habits of said customers. In many embodiments, transaction information is included within interactions data for named entities. As previously mentioned, interactions data and transaction information can be stored in several of the above-described databases of a CI system in accordance with embodiments of the invention. Moreover, transaction data can include financial transaction values for customer transactions. Some embodiments can further estimate financial transaction values for use in scoring customers utilizing averages of known financial transaction values for customer transactions.

Similarity of customers to a typical customer profile can optionally be assessed (3575). Typical customer profiles can include averages and ranges of characteristic data for customers of a given business. The characteristic data of the typical customer profile can describe demographic information for the customers. In many embodiments, a typical customer profile can be generated prior to scoring of customers for a particular business. Where such a typical customer profile does not already exist, process 3500 can generate a typical customer profile or request that another process of the CI system generate a typical customer profile prior to assessing the similarity of the customers on the list to the typical customer profile.

Preferred characteristics of customers and/or segmentation selection can optionally be received (3580). These characteristics can be provided by a merchant user of a CI system in accordance with embodiments of the invention. Alternatively, the CI system can infer optimal sets of characteristics for customers from a typical customer profile or previous transaction data. In some embodiments, the preferred characteristics can include attributes such as (but not limited to) age, location, marital status, children status, household income, education levels, home ownership, and/or gender.

Scores for customers on the identified customer list can be generated (3585). These scores can be based on any combination or only a single one of the above mentioned counts of interactions, counts of spending, and/or assessments of similarity to typical customer profiles. The scores can also take into account any received preferred characteristics for the customers. In some embodiments, the scores range from 0 to 10. Other embodiments may provide different numerical score value ranges and types including scores that are non-linear. An interface that includes the customer scores can optionally be generated (3590). The generated interface typically includes the scores and limited summaries of customers.

An example of a customer list interface 3610 that presents scores and limited summaries of customers of a customer list is illustrated in screenshot 3600 in FIG. 20B. As shown, customer list interface 3610 includes a customer list 3670. The customer list 3670 shows a brief portion of a list of customers for a business. The customer list 3670 also includes several categories of information for the customers. Customer list 3670 includes a customer info 3620 category that shows a brief summary of the customers, including their names, addresses, and phone numbers. Customer list 3670 also includes an attributes category 3630 showing several attributes for the customers. The attributes in the attributes category 3630 include age ranges, income ranges, and homeowner status. CI systems in accordance with embodiments of the invention can limit the amount of information for customers shown to merchant users. As shown in screenshot 3600, attributes category 3630 only shows ranges for certain attributes.

Customer list 3670 also includes a last contact category 3640 that shows when a customer last interacted with a business. The customer list 3670 also includes a source category 3650 that shows what piece of information was most critical to identifying the customer. As shown, this critical piece of information includes (but is not limited to) a call tracking number, a business phone, and/or a cell phone. Finally, the customer list 3670 includes a score category 3660. The score corresponds to the score that can be generated by processes similar to those described above with reference to FIG. 20A.

While the operations described as part of process 3500 were presented in the order as they appeared in the embodiment illustrated in FIG. 35, various embodiments of the invention perform the operations of process 3500 in different orders as required to implement the invention. For instance, in some embodiments, the assessing operations could be performed separately or without certain assessments. Furthermore, any of a variety of processes for scoring customer interactions with a business and/or other type of named entity based upon any number of different factors using interactions data can be utilized as appropriate to the requirements of specific applications in accordance with embodiments of the invention.

### Processes for Estimating the Transaction Values of Customer Interactions

In many embodiments, CI systems can estimate transaction values for customer interactions where limited information is available about the transactions. Many embodiments of the invention can present estimated transaction data to allow merchant users to powerfully survey the effectiveness of various campaigns and business strategies. Also, the transaction value information can direct businesses towards their most valuable customers. Transactions commonly occur that are difficult for CI systems to track. For instance, where a customer transacts with a business in an all cash transaction, it can be difficult for CI systems to know the value of that transaction. In a number of embodiments, CI systems utilize several techniques in order to estimate the value of these unknown transactions. These techniques can include incorporating gathering, merging, production, and relationship processes discussed above in combination with specific process to be discussed below.

A process 3700 to estimate and present transaction values of customer interactions is illustrated in FIG. 20C. Customer interactions can be any transactions between a customer and a business, including those involving an exchange of money for goods and/or services. The values of these transactions are of great importance to CI systems. Customers can be identified (3705) for a given business. Any of the processes described above for identifying named entities within a customer database corresponding to customers of a business described by authoritative and/or merged data sets stored in databases maintained by a CI system can be utilized in accordance with various embodiments of the invention. In several embodiments, relationship data is maintained by the CI system that can be utilized to identify customers of a business. The relationship information can include (but is not limited to) landline phone records associated with customers and/or businesses, mobile phone records associated with customers and/or businesses, email messages between customers and/or businesses (can be to, from, cc, and/or in bodies of email messages such as in the signature line of the email messages), web data to, from, or exchanged between customers and/or businesses (such as reviews, checkins, likes, follower status, and/or mentions), information linking customers to businesses from loyalty and/or discount systems and programs, point of sale systems indicating customer relationships, credit card records from credit card gateways, and/or credit card records from merchants. The specific relationship information maintained by a CI system is largely dependent upon the available information sources and the requirements of specific applications. In addition, customers can be identified for multiple or single businesses.

Transactions between consumers and a particular business can be identified (3710). Embodiments of the invention can identify groups of consumers and/or customers of businesses as required, the embodiment illustrated in FIG. 20C discusses the estimation of transaction values for a group of consumers in the context of a single business. Transactions between consumers and a business can be identified using any of several techniques discussed herein. For instance, transaction data, relationship data, merged information sets, and/or authoritative information sets can indicate the presence of a transaction between named entities. The various data and information sets can be accessed in the above-mentioned databases of a CI system. For instance transaction data can be accessed in a feeds database and/or a production database. Relationship information can be accessed in a feeds database, a production database, and/or a customer database. Merged information sets can be accessed in a feeds database and authoritative information sets can be accessed in a production database. Moreover, transaction data and/or financial transaction values can be queried or crawled from remote information sources where they are not already present in a database of the CI system. Moreover, location correlations can indicate a transaction, such as data points indicating the presence of a consumer inside a location associated with a business. In some embodiments, process 3700 is executed as a sub-process of a larger CI process and receives transactions for which values must be gathered and/or estimated without an explicit identification operation.

Exact transaction values can be gathered (3710). As mentioned above the exact transaction values can be gathered from information sources where such exact information is available and/or can be queried and returned from databases of a CI system. Typically, exact transaction values will not be available for all customer and business interactions. Exact transaction values can be gathered from sources according to techniques and processes discussed above. Certain sources are of particular importance for exact transaction values, for instance loyalty systems, discount programs, and/or point of sale systems enable direct gathering of exact transaction values. CI systems in accordance with embodiments of the invention can access exact transaction values through these sources and/or sources that provide similar types of information. Further embodiments can include internal merchant account processing systems. Embodiments of the invention that include merchant account processing systems can directly access exact transaction values that are processed through such merchant account processing systems.

Average transaction values can be gathered (3720). As mentioned above the exact transaction values can be gathered from information sources where such average transaction information is available and/or can be queried and returned from databases of a CI system. Often, average transaction information will be available where a credit card transaction has taken place. Average transaction information can be gathered from credit card gateways, payment gateways, and/or credit card records. Credit card gateways usually only make available average transaction values and do not provide exact transaction values. CI systems in accordance with many embodiments of the invention can utilize average transaction values in estimating values for transactions for which exact values are not available.

Transactions for which financial transaction values are known and/or unknown for the identified transactions can be determined (3740). The estimates allow merchant users of the CI system to assess the value of transactions, even where records are missing and/or incomplete. Financial transaction values often cannot be determined for all identifiable transactions. For instance, all cash transactions can leave no records for a customer insight system to gather. For unknown transactions, estimates can be generated (3750) using several techniques. For instance, gathered average and exact transaction values for other transactions can be the basis for the estimates. For a given business, previous average and exact transaction values associated with the given business can be used to estimate these unknown transactions.

The estimates can consider previous interactions of particular customers and/or groups of customers. The estimates can also utilize consumer and/or customer segmentation in order to fine tune estimates of transactions for certain segment groups. Typically, other customer transactions at a given business can be the basis for such estimations. In some embodiments, the estimates can be generated using values from comparable transactions at different businesses and/or locations. Comparable transactions can be identified using demographic data and transaction values for known transactions. For instance, where a customer is known to be of a certain demographic segment, transaction values for customers in a certain demographic segment can be utilized as factors for consideration in estimating transaction values for customer transactions in the same or similar demographic segments. The market segmentations can include (but are not limited to) age, location, marital status, children status, household income, education levels, home ownership, and/or gender

The gathered, identified, and/or estimated transactions can optionally be used to compute (3760) transactions attributable to the CI system. Transactions attributable to the CI system can be computed by back linking identified, gathered, and/or estimated transactions to messages and interactions through the CI system. In order to accomplish the attribution, dates and times of the analyzed transactions can be assessed relative to the initiation of use of the CI system.

The gathered, estimated, aggregated and/or estimated transaction values can be output to a user interface. An example of a customer analytics overview 3810 that includes an aggregated transaction indicator 3820 is illustrated in screenshot 3800 in FIG. 20D. The aggregated transaction indicator 3820 indicates the customer spending attributable to the CI system providing customer analytics overview 3810. This enables merchant users to see the value of the CI system in real time. As shown, customer list interface 3810 also includes new customer indicator 3830, customer score indicator 3840, and customer score breakdown 3850. Furthermore, a segmentation overview 3870 is provided that shows various demographic and location breakdowns of the customers of the business.

As discussed above, the aggregated transaction indicator shows an aggregate transaction value of the type that can be produced by process 3700 of FIG. 20C. Different embodiments of the invention may use different combinations of the techniques in process 3700. For instance, the gathering operations may be omitted when the transactions considered are limited to those for which no transaction values are available. While the operations described as part of process 3700 were presented in the order as they appeared in the embodiment illustrated in FIG. 20C, various embodiments of the invention perform the operations of process 3700 in different orders as required to implement the invention. In some embodiments, only the transaction value estimation operation is performed and the gathering operations are performed as part of a larger CI process for gathering, merging, and producing authoritative information regarding named entities. In addition, any of a variety of processes can be utilized to estimate transaction value using sources of transaction data as appropriate to the requirements of specific applications in accordance with embodiments of the invention.

### Generating Automated Campaign Messages

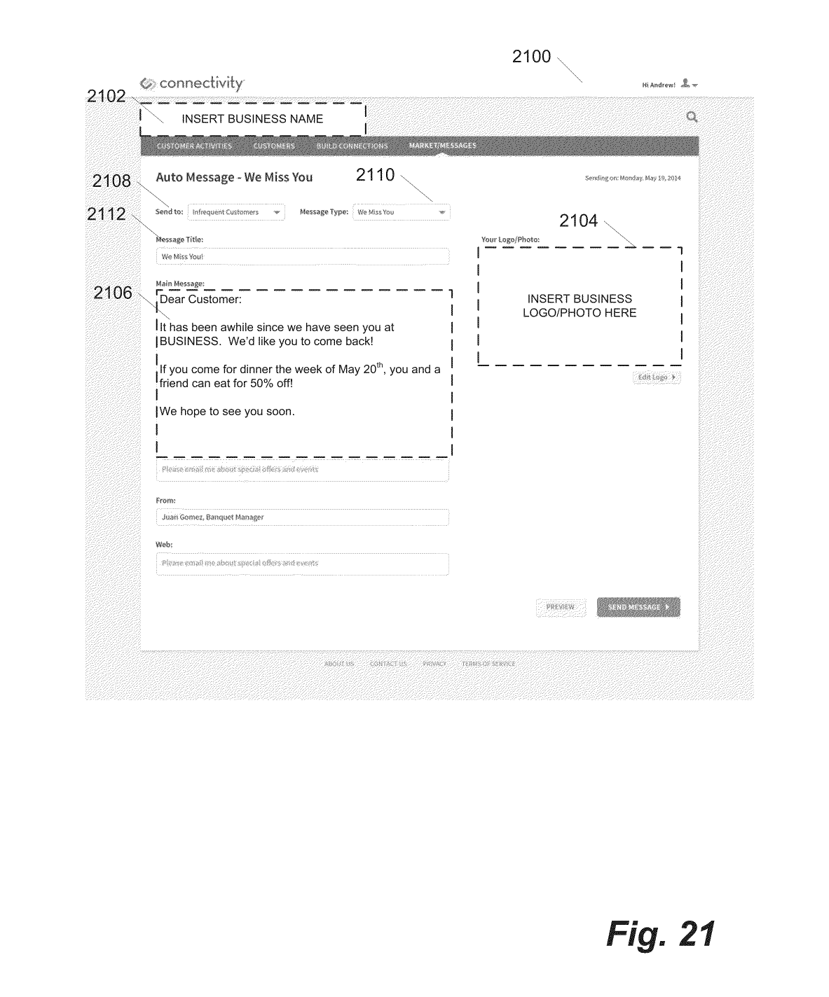

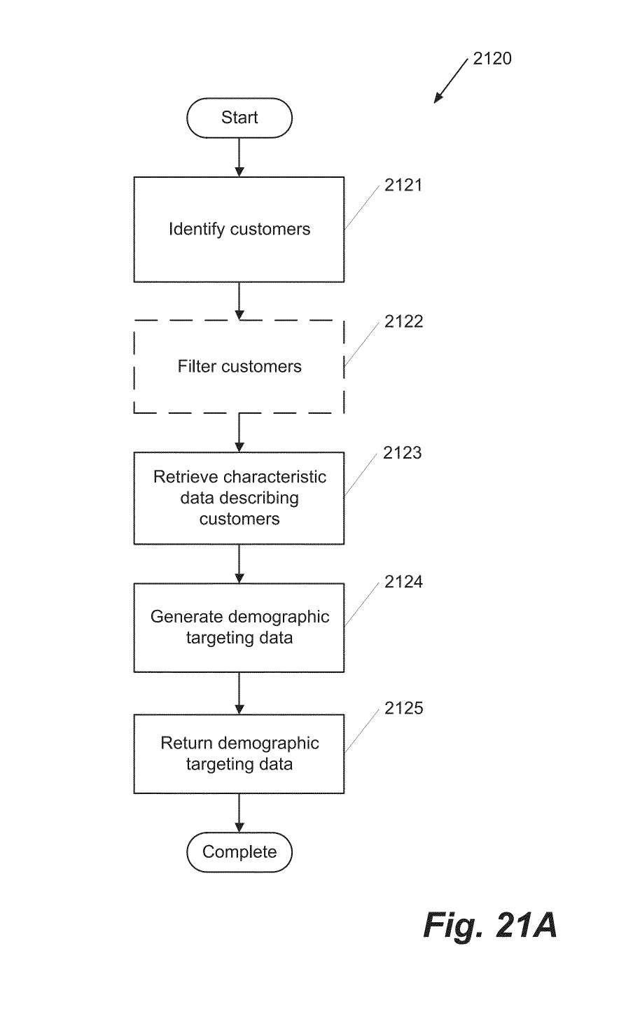

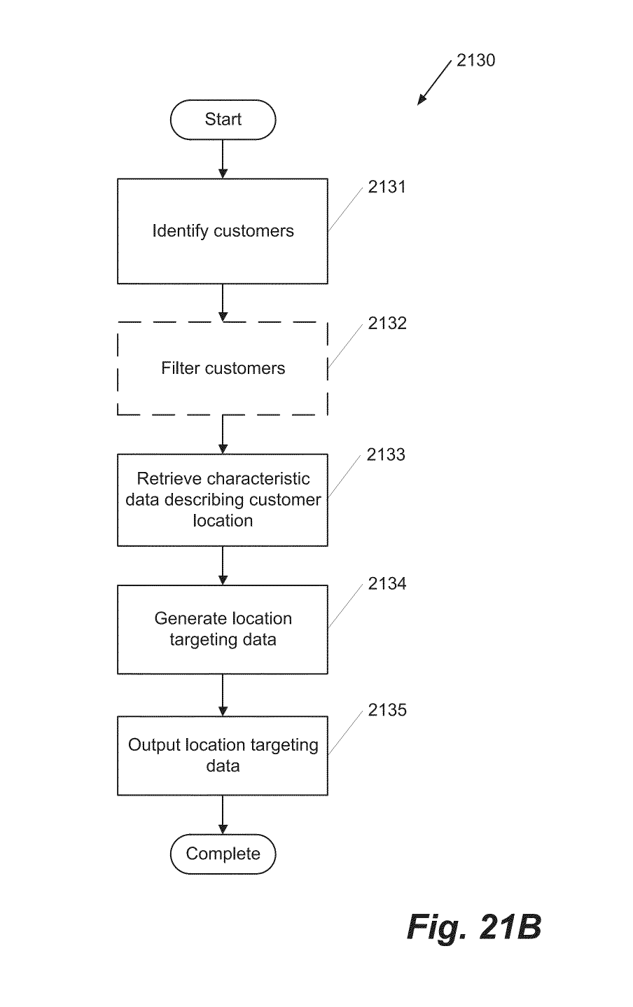

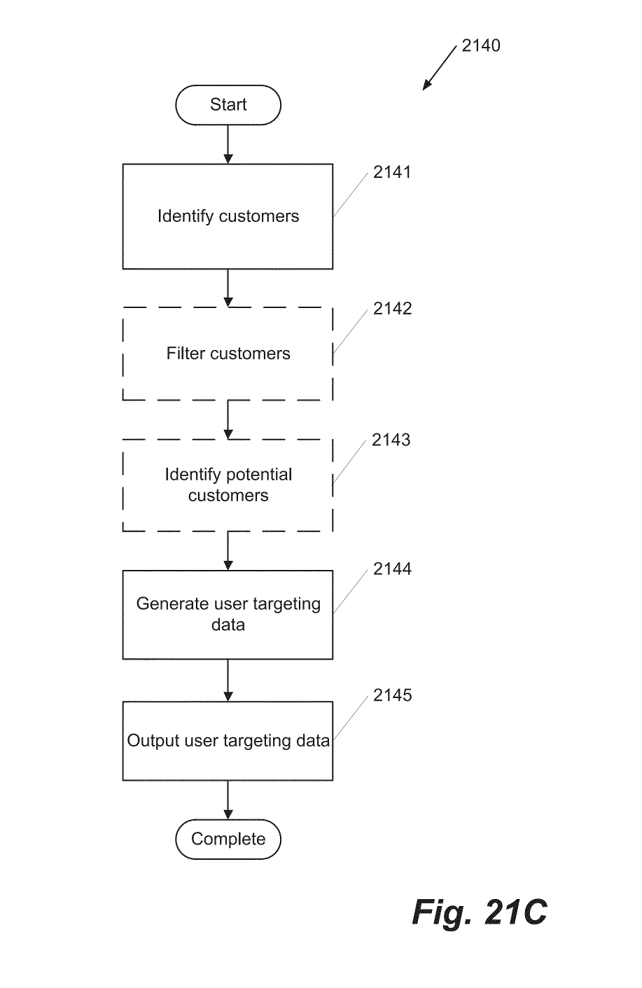

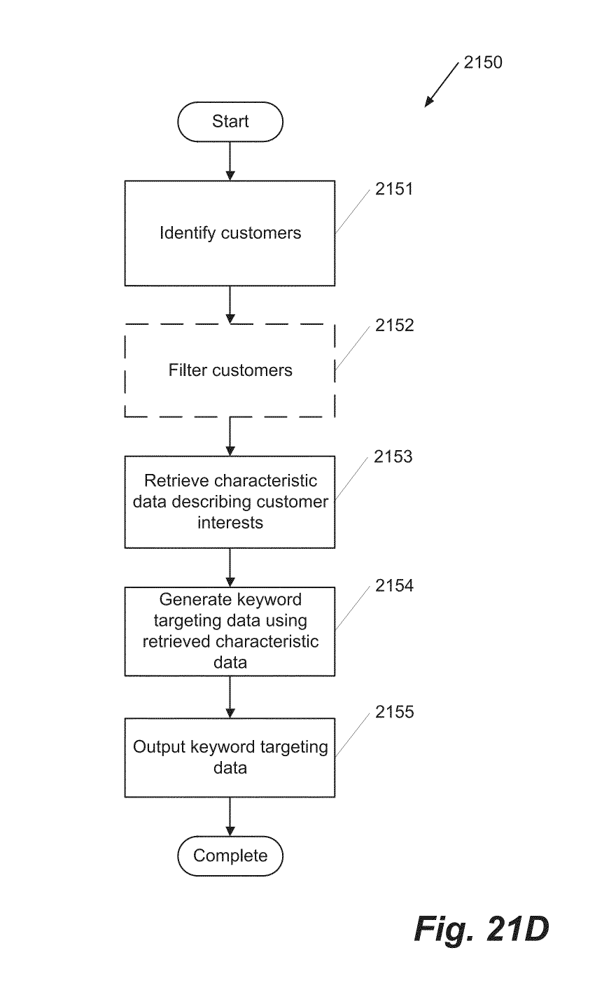

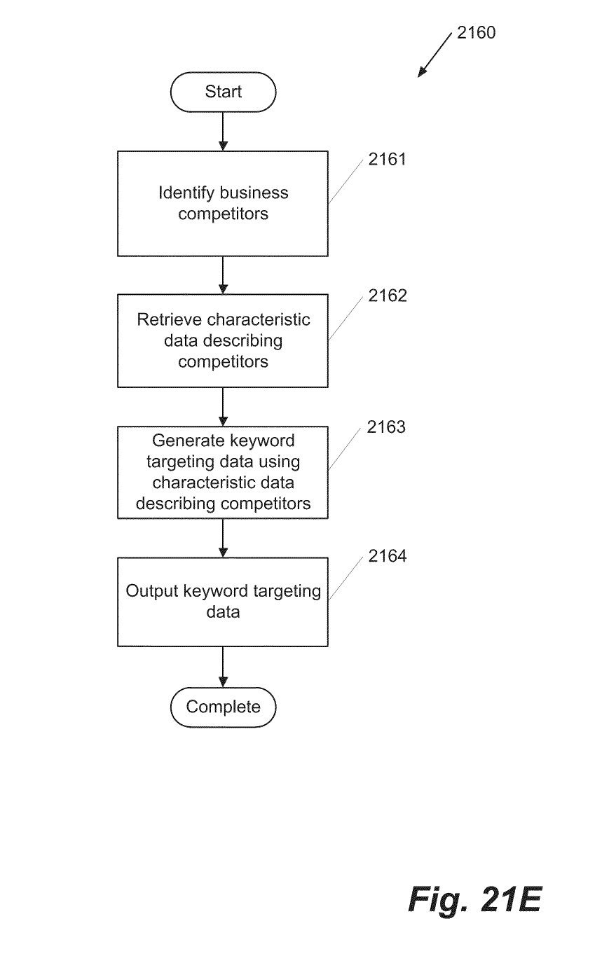

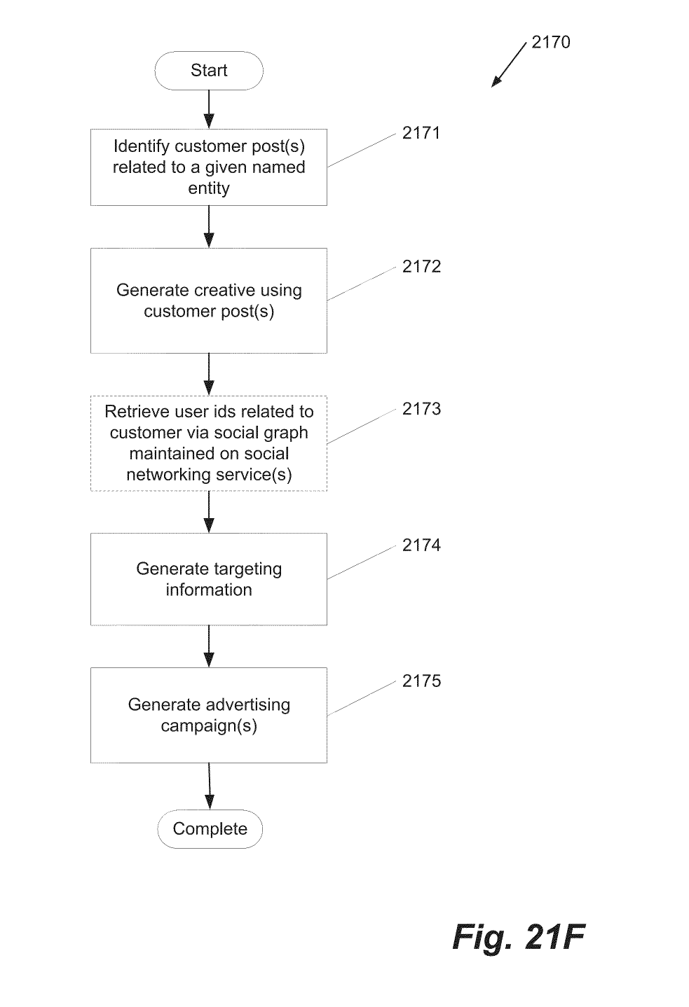

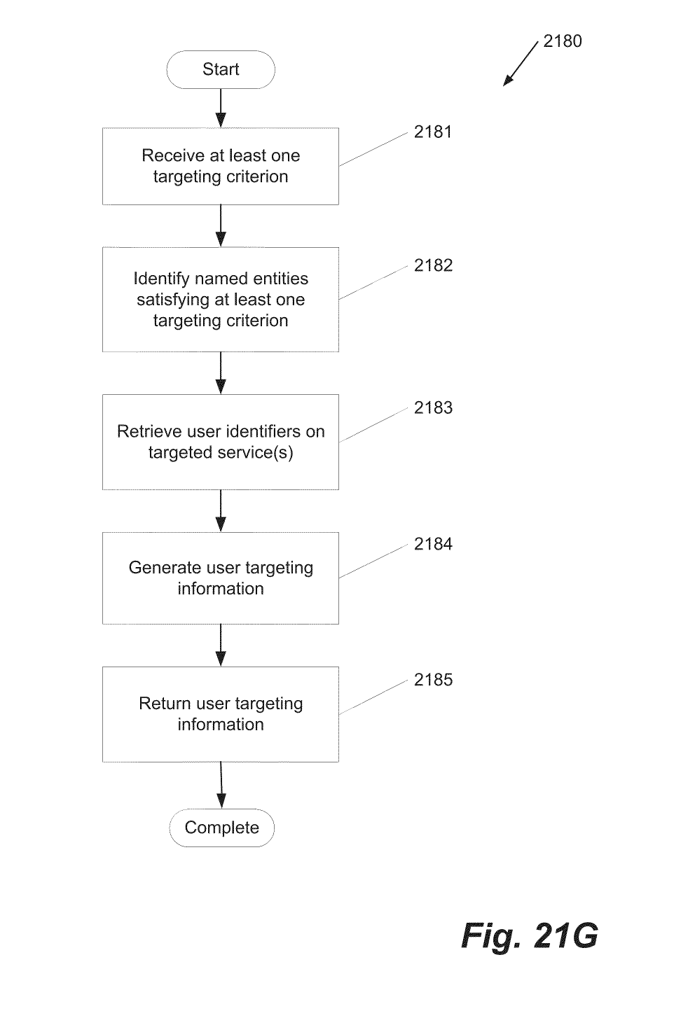

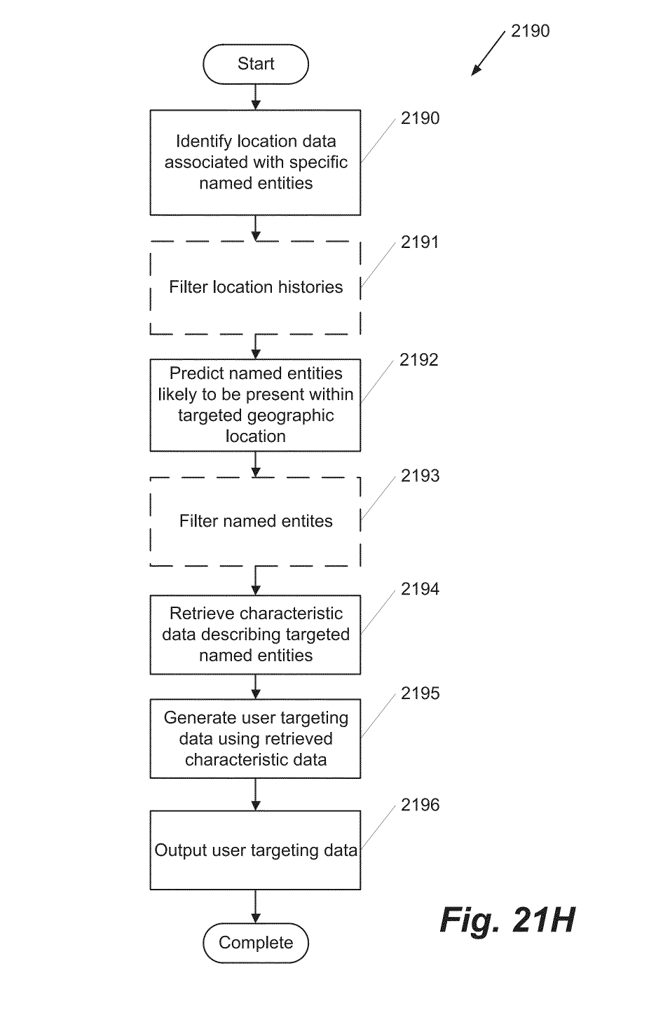

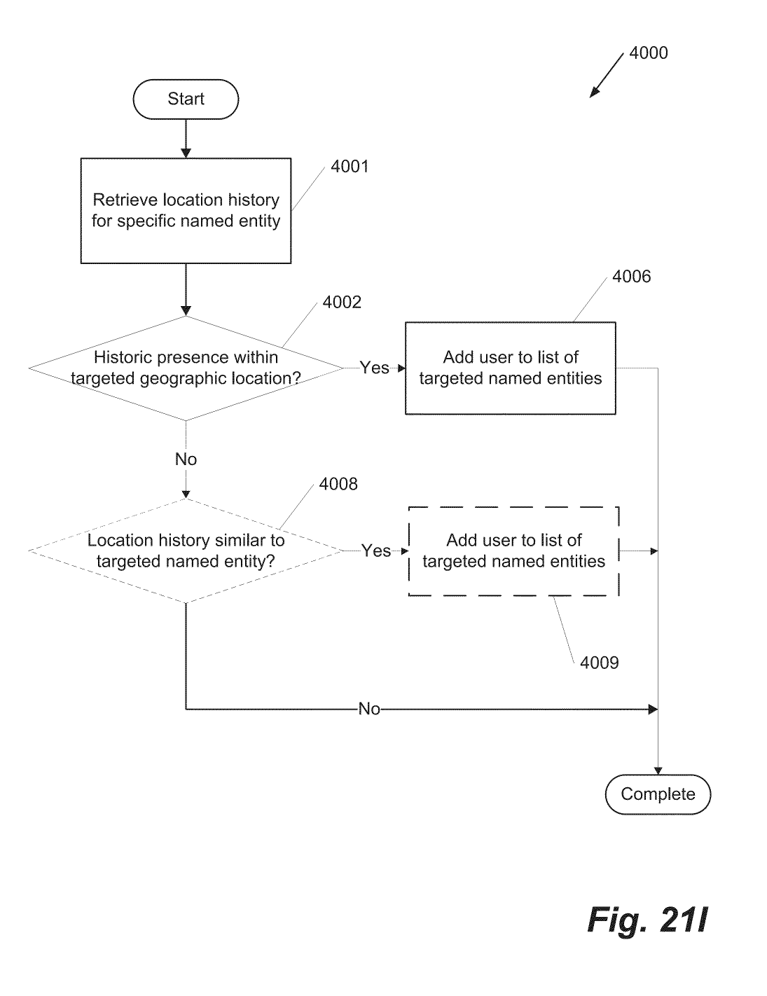

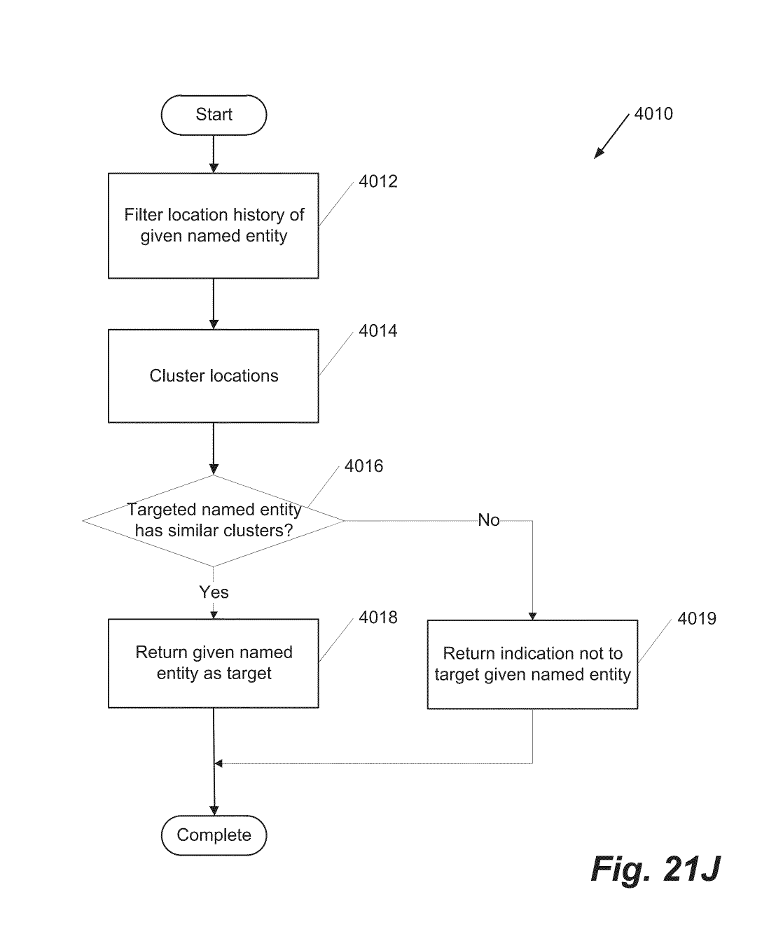

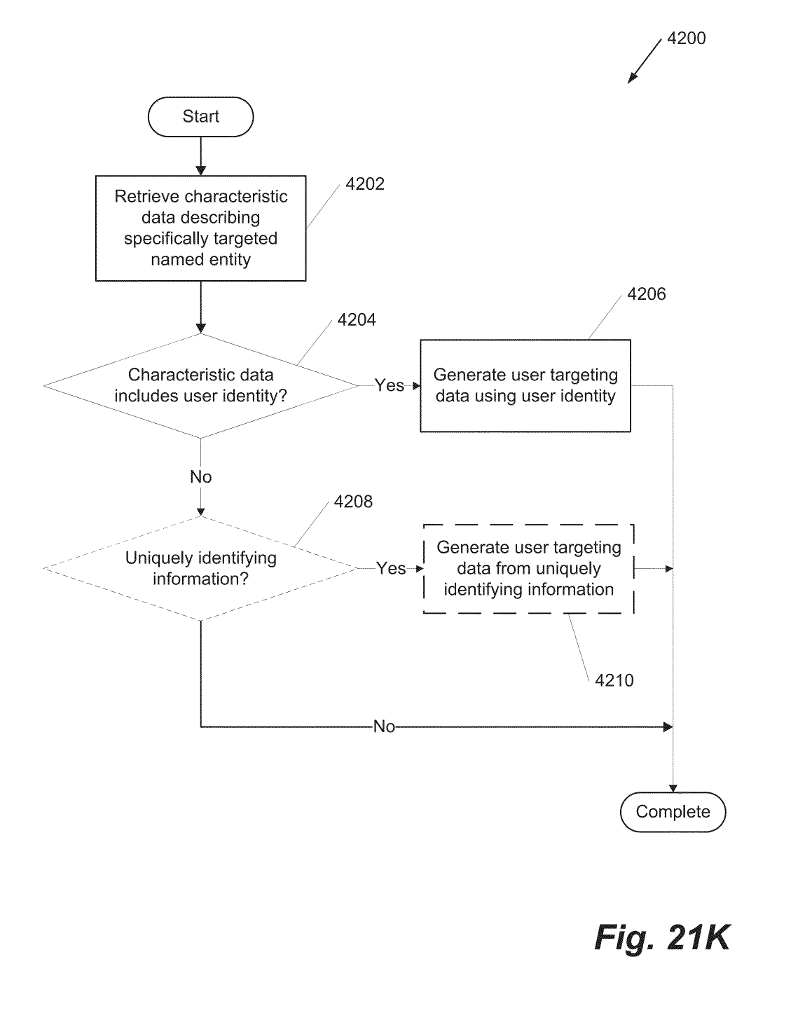

In several embodiments, CI systems can generate automated campaign messages for use in marketing campaigns to customers identified in the automated customer lists. These automated campaign messages can be targeted toward customers that, for example, have not transacted with a business for a period of time. The automated campaign messages are directed to customers using interfaces provided by the CI systems. An example user interface that includes an automated campaign message generation interface 2100 is shown in FIG. 21. Automated campaign message generation interface 2100 includes business name indicator 2102, business logo indicator 2104, main message window 2106, send to interface 2108, message type interface 2110, and message title interface 2112.

The message type interface 2110 indicates several types of base messages from which automated campaign messages can be generated. The several types of base messages include (but are not limited to) “we miss you” messages, deal messages, special offers messages, reminder messages, and/or new product messages. Once a type of base message is selected from the message type interface 2110, then the automated campaign message generation interface 2100 can automatically generate an editable campaign message that is displayed in main message window 2106. Main message window 2106 shows an automatically generated but user editable campaign message that can be sent to customers through the campaign message generation interface 2100.

The editable, automatically generated campaign message(s) will not be directed to specifically identified users in some embodiments. The CI systems of some embodiments limit avenues by which merchant users of the CI systems can contact customers in order to respect the privacy of customers identified by the CI systems. As shown, main message 2106 will be directed to customers indicated by send to interface 2108. Send to interface 2108 indicates to which types of customers the automated message will be sent. Several options are presented by the send to interface 2108, including (but not limited to) best customers, most frequent customers, worst customers, all customers, infrequent customers, closest customers, and/or most distant customers.

The CI systems of many embodiments provide further channels by which merchant users of the CI systems can reach customers. For instance, the automated campaign messages can be transmitted through the interfaces of the CI systems to various channels including (but not limited to) social media sites, Internet messengers, and/or emails. However, customers often do not wish to be sent messages on channels on which they have not interacted with a business. The CI systems of many embodiments restrict the transmission of automated campaign messages based on the interactions customers have had with businesses, place, thing, and/or any other named entity for which a campaign is generated. Accordingly, CI systems in accordance with many embodiments of the invention can limit transmission of automated campaign messages to channels on which customers have interacted with businesses, place, thing, and/or any other named entity for which a campaign is generated. For instance, CI systems may only send a message over a particular social media website when a customer has interacted with a business on the particular social media website.

The screenshot of automated campaign message generation interface 2100 shown in FIG. 21 shows only a single possible configuration in accordance with an embodiment of the invention. As can be appreciated, any of a variety of text options can be provided in an automated campaign message generation interface as appropriate to the requirements of specific applications in accordance with embodiments of the invention.

As is discussed above, CI systems in accordance with many embodiments of the invention can automatically generate advertising campaigns incorporating a variety of advertising targeting data, and/or creatives. Various processes for automatically generating specific types of advertising targeting data and creatives in accordance with numerous embodiments of the invention are discussed below.

### Automated Generation of Demographic Targeting Information

A variety of advertising networks enable targeting using demographic information. Demographic information can be as general as language, age range, and/or gender. Demographic information can be as granular as specific interests and/or behaviors. As noted above, CI systems in accordance with a number of embodiments of the invention can identify relationships between named entities such as (but not limited to) customers and businesses. Characteristic data describing individual customers aggregated from different information sources by a CI system can be utilized to generate demographic information for the customers of a specific business, which can in turn be utilized to generate demographic targeting data. The specific demographic targeting data generated by a CI system is largely dependent upon the requirements of the advertiser and the targeting capabilities of specific advertising networks.

A process for generating demographic targeting data using a CI system in accordance with an embodiment of the invention is illustrated in FIG. 21A. The process 2120 includes identifying (2121) customers of a given business. Any of the processes described above for identifying named entities within a customer database corresponding to customers of a business described by authoritative and/or merged data sets stored in databases maintained by a CI system can be utilized in accordance with various embodiments of the invention. In several embodiments, relationship data is maintained by the CI system that can be utilized to identify customers of a business. The relationship information can include (but is not limited to) landline phone records associated with customers and/or businesses, mobile phone records associated with customers and/or businesses, email messages between customers and/or businesses (can be to, from, cc, and/or in bodies of email messages such as in the signature line of the email messages), web data to, from, or exchanged between customers and/or businesses (such as reviews, checkins, likes, follower status, and/or mentions), information linking customers to businesses from loyalty and/or discount systems and programs, point of sale systems indicating customer relationships, credit card records from credit card gateways, and/or credit card records from merchants. The specific relationship information maintained by a CI system is largely dependent upon the available information sources and the requirements of specific applications.

In several embodiments, the set of named entities corresponding to customers are optionally filtered (2122) to eliminate customers from the set of named entities from the customer database used to generate the demographic targeting information. Any of a variety of criterion appropriate to the requirements of specific applications can be utilized to filter the set of named entities from the customer database used to generate the demographic targeting information including (but not limited to) such characteristics as the average transaction size of transactions between the business and a customer, transaction frequency, residential address of customer, and/or negative sentiment expressed concerning the business by the customer via an online posting.

Characteristic data describing each of the named entities in a set of named entities from the customer database can be retrieved (2123) from the customer database and used to determine targetable common demographic characteristics of a significant number of customers within the set of customers that can be utilized to generate (2124) demographic targeting data. Customers may not share the same set of demographic characteristics. Therefore, customers can be clustered to create different demographic groups to target and/or thresholds applied to limit targeting to only those groups exceeding a specific size. As can readily be appreciated, the specific process utilized to extract one or more sets of common demographic characteristics that can be utilized in the generation of demographic targeting data is typically dependent upon the requirements of specific applications including (but not limited to) the demographic targeting capabilities of the specific advertising network to which the resulting demographic targeting data will be directed by a CI system. The process 2120 completes by returning (2125) the generated demographic targeting data.

Although specific processes for generating demographic targeting information are described above with reference to FIG. 21A, any of a variety of processes can be utilized to generate demographic targeting data as appropriate to the requirements of specific advertising campaigns that may include (but are not limited to) targeted search advertising campaigns, display advertising campaigns, mobile advertising campaigns, social media advertising campaigns, location based advertising campaigns and/or any other advertising campaign that can be launched via a computer implemented advertising platform that supports the use of filtering based upon demographic targeting data in the targeting of advertisements. Processes for generating location targeting information in accordance with various embodiments of the invention are discussed further below.

### Automatic Generation of Location Targeting Information

The processes described above for generating demographic targeting data attempt to identify general demographic characteristics of a set of customers of a given business. Similar processes can be utilized to identify any of a variety of characteristics common to a set of named entities within a customer database corresponding to customers related to a named entity within a production database corresponding to a business in accordance with an embodiment of the invention. Location is one such characteristic that can be extremely useful in the targeting of a variety of different types of advertising campaigns including search advertising campaigns, display advertising campaigns, mobile advertising campaigns, and/or social marketing campaigns. Many advertising networks support the ability to target advertising based upon the presence of a client device within a specific geographic location such as (but not limited to) country, ZIP code, and/or a specific bounded region.

A process for generating location targeting data using a CI system in accordance with an embodiment of the invention is illustrated in FIG. 21B. The process 2130 includes identifying (2131) named entities within a customer database corresponding to customers of a given business based upon references to the customer named entities in merged and/or authoritative datasets maintained by the CI system with respect to the specific business named entity and (optionally) filtering (2132) the identified customer named entities to create a set of targeted customer named entities using processes similar to those described above with respect to FIG. 21A.

Characteristic data describing each of the customer named entities in a set of customer named entities can be retrieved (2133) from the customer database and used to determine geographic location information associated with each of the targeted customer named entities that can be utilized to generate (2134) location targeting data. The specific location information contained within merged information sets and/or authoritative information sets in the customer database can include, but is not limited to, characteristic data within the customer database describing an association between a customer named entity and any one or more of: a country, a residential address information, an employment address, a ZIP code, an IP address, a Global Position System measurement, cell tower IDs, a list of MAC addresses for WIFI access points, a geocode, a location history reported by a mobile device, a location history associated with a MAC address used by a mobile device, registering at a specific location via a location based service, a search query related to a specific location, a search query bounded to a specified geographic location, a navigation request, a transportation record generated by a shared ride service, a transaction record associated with a geographic location, and/or a URL corresponding to a specific geographic location. As can readily be appreciated, the location history that can be generated by merging characteristic data obtained by multiple information sources can provide a significantly richer location history than can be obtained from any single source of information. The location targeting data can include identification of one or more countries, regions, states, provinces, cities, ZIP codes, and or specified bounded geographic region that may be specified using techniques including (but not limited to) a radius around a geographic location, and set of geographic locations form the vertices of a polygon defining a specified bounded geographic region. As can readily be appreciated, the specific location targeting data generated by a CI system is typically dependent upon the targeting capabilities of the specific advertising networks utilized by the CI system to execute an advertising campaign.

In many instances, the number of customers associated with specific locations (e.g. ZIP codes) may vary considerably and customers can be clustered to create different location groups to target and/or thresholds can be applied to limit targeting to only those locations with which at least a specific threshold number of customers are associated. In a number of embodiments, location targeting can be performed based upon specific targeting criteria including (but not limited to) residential address, and/or place of employment. In several embodiments, a location history for a specific named entity corresponding to a customer is built using a variety of location information in merged information sets obtained from a variety of remote information sources. The location history and/or a portion of the location history corresponding to location during a time window or within recent time period can be used to generate targeting data. In certain embodiments, the CI system generates location targeting information that targets locations including residential addresses and locations from location histories of identified named entities corresponding to customers of a specific business. In several embodiments, the generated location targeting data only utilizes locations from location histories that occur during a specific time period or time periods. As can readily be appreciated, the specific process utilized to identify one or more locations to target is typically dependent upon the requirements of specific advertising campaigns including (but not limited to) the location targeting capabilities of the specific advertising network to which the resulting location targeting data will be directed by a CI system. The process 2130 completes by returning (2135) the generated location targeting data.

Although specific processes for performing location targeting data are described above with reference to FIG. 21B, any of a variety of processes can be utilized to generate location targeting data as appropriate to the requirements of specific advertising campaigns that may include (but are not limited to) targeted search advertising campaigns, display advertising campaigns, mobile advertising campaigns, social marketing campaigns, location based campaigns and/or any other advertising campaign that can be launched via a computer implemented advertising platform that supports the use of filtering based upon location targeting data in the targeting of advertisements. Processes for generating user targeting information in accordance with various embodiments of the invention are discussed further below.

### Automated Generation of User Targeting Information

Many advertising networks provide the ability to target advertisements to specific users of a service such as (but not limited to) an email service, a messaging service, and/or a social media service. A significant benefit of CI systems in accordance with many embodiments of the invention is the ability to aggregate information from a variety of sources concerning a named entity. In several embodiments, a specific customer or potential customer can be identified based upon information aggregated about the customer from multiple information sources using a CI system. In a number of embodiments, the CI system can then map a specific customer or potential customer to a user identity on a particular service or can provide uniquely identifying information such as an email address and/or a mobile phone number that the service can map to a user identity. Any information that can be utilized to identify a specific user of a service can be considered as different types of user identifiers. The user identifier can then be provided to an advertising network as user targeting information with respect to the specific service. In this way, information that is not available to a specific service can be used in the selective targeting of advertising to specific users of the service.

A process for generating user targeting data using a CI system in accordance with an embodiment of the invention is illustrated in FIG. 21C. The process 2140 includes identifying (2141) named entities within a customer database corresponding to customers of a given business based upon references to the customer named entities in merged and/or authoritative datasets maintained by the CI system with respect to the specific business named entity and (optionally) filtering (2142) the identified customer named entities to create a set of targeted customer named entities using processes similar to those described above with respect to FIG. 21A.

In several embodiments, the list of targeted customer named entities can be utilized by a CI system to identify (2143) additional named entities corresponding to potential customers. In a number of embodiments, processes similar to those described above can be utilized to generate a profile of a typical customer of the business. The typical customer profile can then be utilized to identify named entities possessing characteristic data matching the customer profile within a customer database. In certain embodiments, location is utilized to identify potential customers and named entities with a location history that includes a location proximate the location of the business can be targeted. In this way, the ability to the CI system to aggregate location histories across a variety of information sources can be leveraged to perform location targeting to specific users of an online service using location information that may not be available to the service on which the users are targeted.

User targeting data (2144) can be generated from characteristic data describing the identified customers and/or potential customers that is maintained within a customer database of a CI system. In many instances, the characteristic data will include the user identity utilized by the user on a specific service (e.g. a username). Many online services enable the targeting of advertising based upon other uniquely identifying information including (but not limited to) mobile phone numbers and/or email addresses. In several instances, information derived from uniquely identifying information (e.g. a hash of the uniquely identifying information) can be utilized as user targeting data. Accordingly, CI systems in accordance with various embodiments of the invention can utilize any user identifier acceptable to a specific service and/or advertising network to generate user targeting data. The process 2140 completes by returning (2145) the generated user targeting data.

Although specific processes are described above with reference to FIG. 21C, any of a variety of processes can be utilized to generate user targeting data as appropriate to the requirements of specific advertising campaigns that may include (but are not limited to) targeted search advertising campaigns, display advertising campaigns, mobile advertising campaigns, social marketing campaigns, location based campaigns and/or any other advertising campaign that can be launched via a computer implemented advertising platform that supports the use of filtering based upon user targeting data in the targeting of advertisements. Processes for generating keyword targeting information in accordance with a number of embodiments of the invention are discussed further below.

### Automatic Generation of Keyword Targeting Information

Keywords can be utilized as targeting data in a variety of different types of online advertising campaigns including (but not limited to) targeted search advertising campaigns, display advertising campaigns, social media advertising campaigns, and/or location based advertising campaigns. Keywords can be particularly useful for targeting users of services that have provided information concerning specific interests, behaviors, and/or intents. Targeted search advertising was one of the earliest advertising technologies to utilize keywords to target users of search engine services based upon interest expressed in the form of a search query. Interest can also be inferred from the content of documents including (but not limited to) web pages, email messages, and/or short messages posted to messaging services. Many advertising networks infer interest from user activity on online social networking services such as (but not limited to) “liking”, linking to, and/or reposting a page, post, image, and/or any other piece of content that may be posted via an online social networking service. In a number of embodiments, CI systems can automatically generate keyword targeting data from merged information sets and/or authoritative information sets describing the named entity corresponding to a business and/or a customer or potential customer of a business based upon a variety of criterion appropriate to a specific type of advertising campaign. In several embodiments, characteristic data describing a named entity can be used to generate targeting keywords that target search queries related to a similar and/or competing business. In a number of embodiments, characteristic data describing customer and/or potential customer named entities can be used to generate targeting keywords that target the interests of customers and/or potential customers of a business. As can readily be appreciated, the specific processes and/or criterion utilized to identify targeting keywords from characteristic data maintained concerning various named entities by a CI system is typically determined based upon a specific advertising strategy employed within an advertising campaign and the capabilities of the advertising network used to distribute the advertising campaign.

A process for generating keyword targeting data that targets specific interests expressed by users of a service using a CI system in accordance with an embodiment of the invention is illustrated in FIG. 21D. The process 2160 generates targeting keywords targeting the interests of customers of a business. The process 2160 includes identifying (2161) named entities within a customer database corresponding to customers of a given business based upon references to the customer named entities in merged and/or authoritative datasets maintained by the CI system with respect to the specific business named entity and (optionally) filtering (2152) the identified customer named entities to create a set of targeted customer named entities using processes similar to those described above with respect to FIG. 21A.

Characteristic data describing customer named entities retrieved (2153) from a customer database maintained by a CI system can be utilized to generate a list of keywords describing interests and/or activities associated with the customer named entities. The keywords can then be utilized by the CI system to generate (2154) keyword targeting data that can be utilized to present advertising in response to a user of a service expressing an interest in an interest and/or activity that is typical of customers of a business. In several embodiments, the keyword targeting data is a list of keywords and a specified match type for each keyword. Match types specify the extent to which a match to the targeted must be found in order to display an advertisement. Match types in keyword targeting data can specify that misspellings, synonyms, related keywords, and other relevant various be considered matches. The match type can also require that the keyword in its entirety be present (i.e. phrase matching) and/or only the keyword be present (i.e. exact matching) for a match to be found. As can readily be appreciated, the specific match types supported is largely dependent upon the targeting capabilities of the specific advertising network utilized to execute an advertising campaign. The process 2150 completes by returning (2155) the generated user targeting data.

Although specific processes for generating keyword targeting data that targets the interests of customers of a business are described above with reference to FIG. 21D, any of a variety of processes can be utilized to generate keyword targeting data targeted toward a specific interest of a user of a service as appropriate to the requirements of specific advertising campaigns that may include (but are not limited to) targeted search advertising campaigns, display advertising campaigns, mobile advertising campaigns, social marketing campaigns, location based campaigns and/or any other advertising campaign that can be launched via a computer implemented advertising platform that supports the use of filtering based upon user targeting data in the targeting of advertisements. Indeed, the sources of keywords that can be utilized by a CI system to generate targeting keywords is not limited to characteristic data describing customer named entities. Keyword targeting data can also be generated using characteristic data describing a business and/or named entities corresponding to similar or competing businesses.

Users of a service that may be particularly interesting to target are users that express interest in a competing business. A process for generating keyword targeting data that targets users of a service that are expressing interest in a competing business using a CI system in accordance with an embodiment of the invention is illustrated in FIG. 21E. The process 2160 includes identifying (2161) businesses that are similar to and/or compete with a specific business. In several embodiments, competing business can be identified by determining the customers of a given business by identifying relationships between named entities in a customer database and the named entity for the given business in merged information sets and/or an authoritative information set associated with the named entity of the given business. The list of customer named entities can then be utilized to identify other named entities corresponding to potential competitors with which the customer named entities are related. The list of potential competitor named entities can be filter based upon the characteristic data describing the potential competitor named entities. A typical filter is to look for characteristics that indicate that the potential competitor named entity is in fact competing with the given business for its customers. For example, restaurants with average transaction prices in the same range compete. However, a restaurant does not typically compete with a hardware store and may not compete with a restaurant where customers spend on average a significantly larger sum of money. As can readily be appreciated, any of a variety of filters appropriate to the requirements of a specific application can be used to filter a list of customer named entities to create a list of competitor named entities. Indeed, any appropriate for identifying competitors including receipt of manual input can be utilized to identify competitor named entities as appropriate to the requirements of different CI systems can be utilized in accordance with various embodiments of the invention.

Characteristic data describing competitor named entities retrieved (2162) from merged information sets and/or authoritative information sets maintained by a CI system can be utilized to generate a list of keywords describing the business such as (but not limited to) the business name, the address of the business, the type of business and a geographic location (e.g. Italian Food in Highland Park, Calif.). The keywords can then be utilized by the CI system to generate (2163) keyword targeting data that can be utilized to present advertising in response to an expression of interest by a user of a service in the targeting keyword(s). The process 2160 completes by returning (2164) the generated user targeting data.

Although specific processes for generating keyword targeting data targeting interest in a competing business are described above with reference to FIG. 21E, any of a variety of processes can be utilized to generate keyword targeting data targeted toward a specific interest as appropriate to the requirements of specific advertising campaigns that may include (but are not limited to) targeted search advertising campaigns, display advertising campaigns, mobile advertising campaigns, social marketing campaigns, location based campaigns and/or any other advertising campaign that can be launched via a computer implemented advertising platform that supports the use of filtering based upon user targeting data in the targeting of advertisements.

While much of the discussion above with respect to FIGS. 21A-21E describes the automated generation of advertising targeting information using information aggregated from multiple sources by a CI system, CI systems in accordance with many embodiments of the invention can also automatically generate creatives for use in advertising campaigns. Automated generation of creatives using CI systems in accordance with various embodiments of the invention is discussed further below.

### Automatic Generation of Creatives

CI systems in accordance with many embodiments of the invention maintain characteristic data in merged information sets and/or authoritative information sets that describe various named entities. In several embodiments, the characteristic data forms an ontology for describing different types of named entities and the ontology can be utilized in combination with templates to automatically generate creative. In a number of embodiments, the characteristic data includes posts published by social media services, and review sites that describe a specific named entity. In several embodiments, sentiment analysis can be performed on customer posts to identify posts that positively describe and/or review a given named entity. In certain embodiments, a CI system can utilize posts expressing positive sentiment as creative in advertising campaign by utilizing a template to format the content of the post into a creative and/or promoting the post using the service on which the post was originally published. In several embodiments, relationship information concerning the user of the service that published the post and other named entities maintained in a CI system customer database can be utilized to identify specific users to target with the generated creative and/or promoted post. By automatically generating a creative using the post, the CI system can target people that share a known relationship with the user that created the post on services other than the service on which the post was published. In addition, the CI system can generate user targeting data that targets the creative and/or promoted posts to users of services that share a relationship to the user that created the post, despite a specific service being unaware that such a relationship exists. For example, a comment posted to a review site can be used to generate a creative displayed via a social media service and targeted to a user of the social media service that shares a relationship with the user of the review site that created the post, even in circumstances where the user that created the post is not a member of the social media service. By aggregating information concerning relationships between named entities from multiple services, a broader set of users of a specific service may be able to be targeted than would be otherwise possible using only those relationships between users of the specific service that are known to the service. Processes for automatically generating creatives using customer posts for generating user targeting data that targets users of services known by a CI system to share a relationship with the creator of a post in accordance with various embodiments of the invention are discussed further below.

### Automatic Generation of Creatives Using Customer Posts

Many online social networking services provide the capability of promoting posts to the online social networking service as advertisements. CI systems in accordance with many embodiments of the invention can automate the targeting of the posts on online social networks to other users within the online social network. Information concerning relationships between named entities maintained by a CI system can be utilized to promote posts to users of a service that are not known to be related by the service that published the post. In a number of embodiments, a customer post can be used to automatically generate a creative that is targeted as an advertisement on services that are different to the service on which the post was published.

A process for automatically generating an advertising campaign for a business using posts published by a user of a service that are related to the business using a CI system in accordance with an embodiment of the invention is illustrated in FIG. 21F. The process 2170 includes identifying (2171) customer posts on various services that relate to a given named entity corresponding to the business. In several embodiments, references to posts related to the given named entity are contained within merged information sets and/or authoritative information sets for the named entity. In a number of embodiments, the CI system can filter the identified (2171) posts based upon sentiment to identify posts that express favorable sentiment toward the business.

The identified (2171) posts can then be utilized to generate creatives (2172) in an advertising campaign. In several embodiments, the content of the identified posts is formatted into creative using templates. In a number of embodiments, the service that published the posts provides the ability to promote the posts as advertisements. Where the advertising campaign promotes posts on the service that published the post, the creative often takes the form of a post ID that is provided to an advertising platform provided by the service that published the post. The specific manner in which the content of the identified posts is utilized to generate a creative in an advertising campaign is typically dependent upon the requirements of a specific advertising campaign.

In addition to automatically generating creatives, a CI system can automatically generate (2174) targeting information for an advertising campaign utilizing the creatives. In several embodiments, the creatives are targeted to customers and/or potential customers that may or may not know the user of the service that created the post using any of a variety of targeting strategies. In a number of embodiments, the CI system (optionally) queries (2173) the service to obtain user identities for users that are known to share a relationship with the user that created the post. The user identities can then be utilized to generate user targeting data for a promoted post on the service that published the post. In several embodiments, the user identities can be utilized to identify named entities corresponding to the users of that are known to share a relationship with the user that created the post. Merged information sets and/or authoritative information sets for the identified name entities maintained in a customer database can be utilized to generate user targeting data that targets user identities services that are different to the service that published the post. In certain embodiments, relationships that are known by the CI system to exist between a named entity corresponding to the user of the service that created a post and other named entities can be utilized to generate user targeting data on any of a variety of services. As can readily be appreciated, any of the variety of processes for generating targeting data using a CI system described above can be utilized in the automated generation of targeting data in accordance with various embodiments of the invention and the specific manner in which targeting information is generated is typically dependent upon the targeting capabilities of a specific advertising network(s) utilized by an advertising campaign. The process 2170 completes by returning (2175) the generated advertising campaign including targeting data and creatives.

Although specific processes for generating advertising campaigns that include targeting data and creative generated using posts related to a specific business are described above with reference to FIG. 21F, any of a variety of processes can be utilized to automatically generate creative for advertising campaigns as appropriate to the requirements of specific advertising campaigns that may include (but are not limited to) targeted search advertising campaigns, display advertising campaigns, mobile advertising campaigns, social marketing campaigns, location based campaigns and/or any other advertising campaign that can be launched via a computer implemented advertising platform that supports the use of filtering based upon user targeting data in the targeting of advertisements.

While much of the discussion above concerning advertising campaigns and the generation of advertising targeting data relates to advertising campaigns related to business, the processes described above can be equally utilized to generate targeting data and/or advertising campaigns for other types of named entities including (but not limited to) named entities corresponding to places, named entities corresponding to objects, and/or named entities corresponding to people. The processes can utilize relationships between named entities identified within the merged information sets and/or authoritative information sets generated by a CI system with respect to the named entity for which the advertising campaign is being generated. As noted above, these relationships can be utilized in a variety of ways to automatically generate different types of targeting data including demographic targeting data, location targeting data, user targeting data, and keyword targeting data. In addition, the identified relationships can also be utilized to identify content related to a specific named entity that can be repurposed as a creative in an advertising campaign. Accordingly, the specific processes described herein should not be considered limited to the generation of targeting data and/or advertising campaigns with respect to businesses, but more fully understood as being general processes that can be utilized with respect to any named entity for which information sets are aggregated from a variety of sources by a CI system in accordance with various embodiments of the invention. Various processes for generating user targeting data based upon targeting criterion that can include demographic, location, and/or keyword targeting criteria are discussed further below.

### Mapping Advertising Targeting Criteria to User Targeting Data

Many online services provide advertisers with the ability to present programmatic advertisements targeted to individual users of the service. A challenge for many potential advertisers is identifying the user identities of consumers that the advertiser would like to target on specific services. The ability of CI systems to aggregate data concerning named entities from a variety of different remote information sources can enable the CI system to associate user identities on online services with specific named entities in a customer database maintained by the CI system. In many embodiments, CI systems are able to generate listings of user identities on specific services that match specified advertising targeting criteria. The specified advertising targeting criteria can include (but are not limited to) demographic targeting criteria, location targeting criteria, and keyword targeting criteria. As can readily be appreciated, CI systems also provide an extremely powerful mechanism for targeting advertising to specific consumers on a variety of platforms based upon information aggregated about the consumer. For example, a customer may interact with a business via a first service and the CI system can use information concerning the user's identity on a second service to target advertisements to the user on the second service without the customer directly providing any information concerning the user identity used by the customer on the second service. Various processes for utilizing CI systems to map advertising criteria to user identifiers on specific services in accordance with embodiments of the invention are discussed below with reference to FIGS. 21G-21K.

A process for mapping advertising targeting criteria to user targeting data on specific services that provide the ability to present programmatic advertisements targeted to individual users of the service in accordance with an embodiment of the invention is illustrated in FIG. 21G. The process 2180 includes receiving (2181) at least one advertising targeting criterion. As noted above, advertising targeting criterion can include (but are not limited to) demographic targeting criteria, location targeting criteria, and keyword targeting criteria. The targeting criterion can specify the strength of the matching criterion to be used with respect to the targeting criterion and/or the specific services to be targeted.

Named entities identified from merged information sets by a CI system that satisfy the at least one advertising criterion can be identified (2182). In several embodiments, aspects of the characteristic data contained within the merged and/or authoritative information sets for a named entity can be indexed by the CI system and the CI system can utilize the index to identify named entities that match the at least one targeting criterion. Indexes can be particularly useful with respect to keyword matching, however, indexes and specific data structures (e.g. B+ trees) can also be utilized to assist with identifying named entities that match location and/or demographic targeting criteria. In several embodiments, matches are determined by directly inspecting the characteristic data describing named entities.

User identifiers on specific services are retrieved (2183) for the identified named entities that satisfy the at least one targeting criterion. As noted above, different services support different user identifiers beyond a user ID and/or user identity utilized by the user on the service. In many instances, services allow the targeting of advertising using mobile phone numbers and/or email addresses. Accordingly, CI systems in accordance with many embodiments apply rules to potential user identifiers contained within characteristic data retrieved from a customer database describing the named entity to select the user identifier that is best suited to targeting the user on a specific service.

The retrieved user identifiers can be utilized to generate (2184) user targeting information and the process completes by returning (2185) the user targeting information.

Although specific processes for mapping advertising targeting criterion to user targeting data are disclosed above with reference to FIG. 21G, any of a variety of processes can be utilized to map advertising targeting criterion to user targeting data on specific services in accordance with embodiments of the invention. Mapping advertising targeting criteria that include location targeting criteria can be particularly challenge due to the fact that a consumer's location is typically dynamic. Processes for mapping location criteria to user targeting data using a CI system in accordance with various embodiments of the invention are discussed further below with reference to FIGS. 21H-21K.

A process for identifying named entities that match a location criterion and generating user targeting data that targets the identified named entities in accordance with an embodiment of the invention is illustrated in FIG. 21H. The process 2190 includes identifying (2190) location data associated with specific named entities. In a number of embodiments, the CI system maintains an extensive location history for named entities and the CI system can filter (2191) the location data considered when matching location targeting criteria. In several embodiments, filtering is performed based upon the recency of the location data and/or the reliability of the location data (e.g. the reliability of the source and/or improbable locations such as, but not limited to, the named entity being present in multiple places at the same time or within a very short period of time). In other embodiments, any of variety of filtering criteria can be utilized to filter the location data associated with a named entity that is considered when matching location targeting criteria.

In several embodiments, the process of matching a location criterion is relatively straightforward and involves matching a static location such as (but not limited to) a residential address, or employment address. In the illustrated embodiment, the matching criterion attempts to match dynamic location. Stated another way, the process 2190 matches a location targeting criterion by determining the presence of a named entity within the targeted location and/or predicting (2192) whether a named entity is likely to be present within a targeted geographic location. Processes for predicting whether a named entity is likely to be present within a targeted geographic location are discussed further below.

Named entities identified as matching the location targeting criterion can be (optionally) filtered (2193) in accordance with other criterion. Characteristic data can be retrieved (2194) describing the identified named entities and user identifiers on specific services can be utilized to generate (2195) user targeting data that can be output (2196) for use in the targeting of programmatic advertising on specific services.

Although specific processes are described above with reference to FIG. 21H, any of a variety of processes that enable the matching of location targeting criteria against location histories generated by CI systems can be utilized as appropriate to the requirements of specific applications in accordance with embodiments of the invention. Various processes for predicting whether a named entity is likely to be present within a targeted geographic location are discussed below with reference to FIG. 21I.

A process for predicting whether a named entity is likely to be present within a targeted geographic location in accordance with an embodiment of the invention is illustrated in FIG. 21I. The process 4000 includes retrieving (4001) a location history for a specific named entity. As discussed above, CI systems in accordance with many embodiments of the invention merge information sets form a variety of remote sources and the merged information sets for a given named entity in a feeds database and/or a customer database typically includes geographic location information. In several embodiments, the CI system can identify relationships between a given named entity and specific geographic locations, at specific times, from the merged information sets and can use the identified relationships to build a location history for the given named entity.

When predicting the likelihood that a given named entity will be within a targeted geographic location, the CI system can determine (4002) whether the location history of the given named entity indicates a historic presence within the targeted geographic location. The determination can consider multiple factors beyond simply a presence within the location including recency and frequency. When a determination is made that the location history of the named entity indicates a historic presence within a targeted geographic location, then the named entity can be added (4006) to a list of targeted named entities.

In certain embodiments, a CI system can also evaluate (4008) whether a given named entity's location history is similar to the location history of a targeted named entity and add (4009) the given named entity to the list of targeted named entities accordingly. A process for comparing the similarity of location histories in accordance with embodiments of the invention is illustrated in FIG. 21J. The process 4010 may include filtering (4012) location histories of given named entities in accordance with various criteria to make the location data more comparable and/or to limit the time window over which the location data is compared. The locations within the location history can be clustering (4014) and a determination (4016) made as to the similarity of the clusters between a given named entity and one or more targeted named entities. When a match is found, the process 4018 returns the named entity as a target. Otherwise, the named entity is not targeted (4019).

Although various processes for predicting the presence of a given named entity within a targeted geographic location based upon location histories built from a variety of remote information sources are described above with reference to FIGS. 21I and 21J, any of a variety of processes that leverage location histories built by CI systems to map location targeting criteria to specific named entities can be utilized as appropriate to the requirements of specific applications in accordance with embodiments of the invention.

As indicated above, a variety of different pieces of identifying information can be used to programmatically target advertising to a user of a service. CI systems in accordance with a number of embodiments of the invention apply a variety of rules when determining the user identifier to provide as advertising targeting data with respect to a specific service. A process for determining user targeting data based upon characteristic data describing a targeted named entity in accordance with an embodiment of the invention is illustrated in FIG. 21K. The process 4200 includes retrieving (4202) characteristic data describing a specifically targeted named entity. When the characteristic data includes a user identity for the targeted service (4204), a CI system can use the user identifier to generate (4206) advertising targeting data. When the characteristic data does not include a user identity for the targeted service an optional determination (4208) can be made as to whether the targeted service enables the programmatic targeting of advertising to users based upon pieces of uniquely identifying information such as (but not limited to) mobile phone numbers, email addresses, and/or user identities on other services. When the targeting of advertising using uniquely identifying information is supported by a targeted service and the specific type of uniquely identifying information supported by the targeted service is present in the retrieved characteristic data, then the uniquely identifying information can be utilized to generate (4210) user targeting data.

Although specific processes for generating user targeting data based upon retrieved characteristic data for a targeted named entity are discussed above with reference to FIG. 21K, any of a variety of processes that generate advertising targeting data from characteristic data in merged and/or authoritative information sets for named entities maintained by a CI system can be utilized as appropriate to the requirements of specific applications in accordance with embodiments of the invention. While much of the discussion above with respect to FIGS. 21H-21K is related to mapping location targeting criteria to user targeting data, it should be appreciated that any of a variety of criteria including combinations of different criteria can be utilized in the generation of user targeting data in accordance with embodiments of the invention.

### Business Listings Management

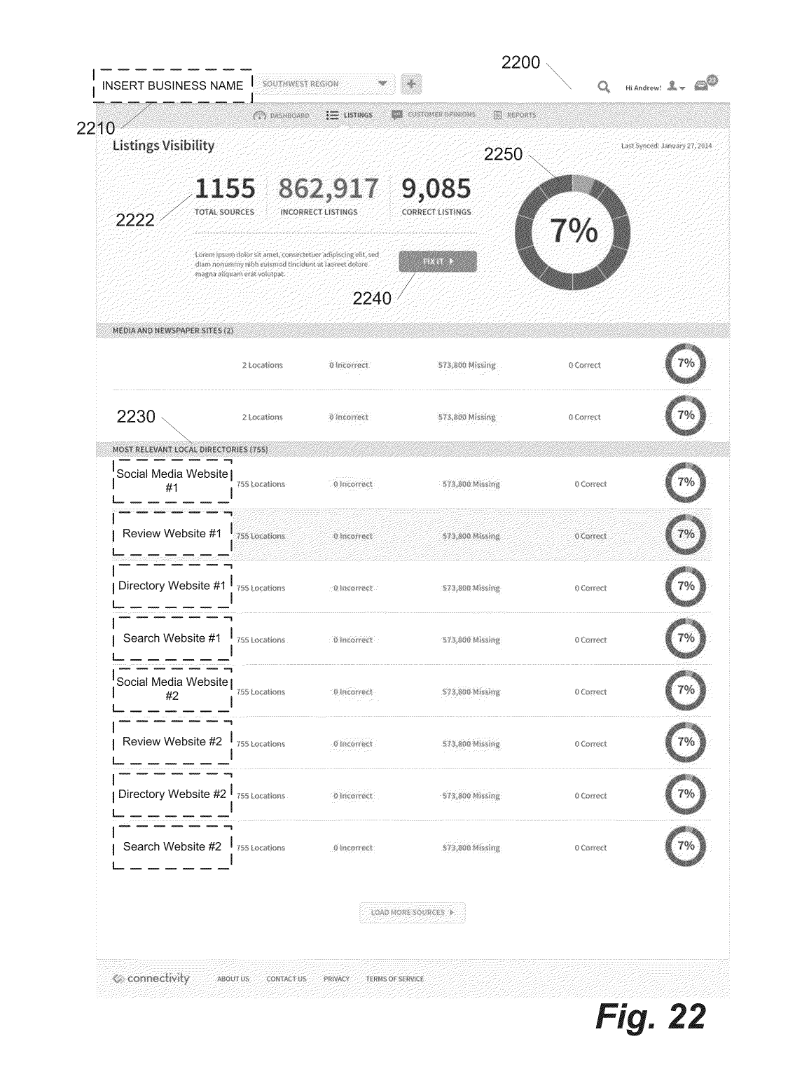

The Internet has enabled vast numbers of websites to contain listings information for businesses. Numerous websites contain incorrect or at least outdated information. In several embodiments, CI systems can identify listings of businesses from gathered information and compare these listings with correct information provided by merchant users or authoritative information sets. The CI systems of a number of embodiments further provide user interfaces through with merchant users can correct the listings for their businesses. FIGS. 22-24 show various interfaces through which merchant users of CI systems in accordance with several embodiments can be made aware of incorrect listings for their business and means to correct listings.

FIG. 22 shows a user interface with a business listing review interface 2200. Business listing review interface 2200 includes business name indicator 2210, listing visibility table 2220, most relevant local directory listings 2230, a “fix it” button 2240, and a correct listing indicator 2250. The listing visibility table 2220 provides a summary of the business listings for the business indicated by the business name indicator 2210. In the example shown in business listing review interface 2200, 1155 information sources have listings for the business indicated by the business name indicator 2210, and of those source 862,917 of the listings within those sources are incorrect. The business listing review interface 2200 regards missing listing information as being incorrect, therefore the missing listing information shown in most relevant local directory listings 2230 are marked as incorrect. Of the total listings detected by the CI system providing business listing review interface 2200, correct listing indicator 2250 finds 7% of the listings to be correct. The “fix it” button 2240 can transition to a different interface to allow for the submission of correct listing information.

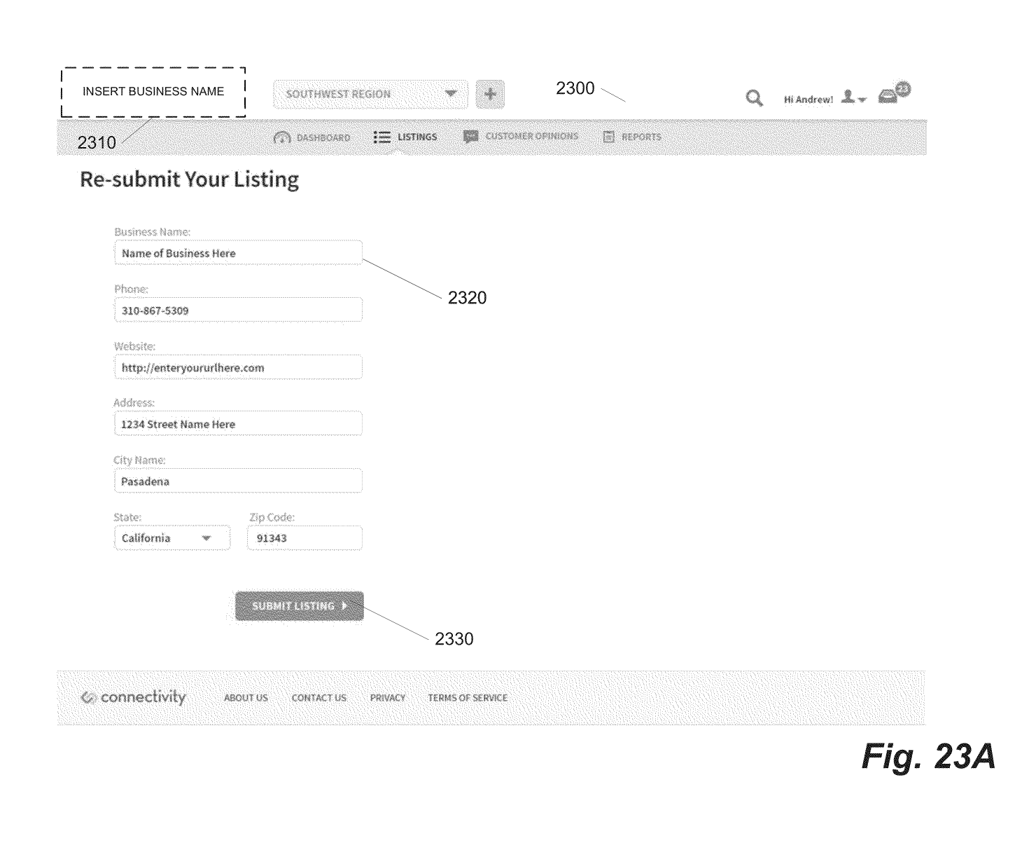

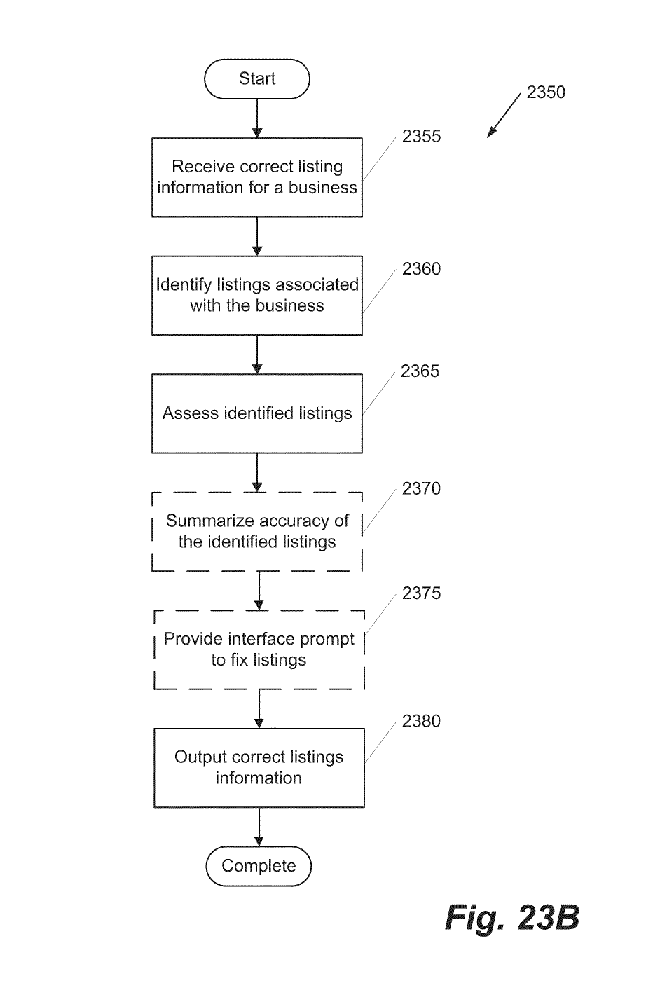

FIG. 23A shows a user interface with a business listing correction interface 2300. Business listing correction interface 2300 includes business name indicator 2310, listing submission interface 2320, and submit listing button 2330. Listing submission interface 2320 allows for entry for various attribute values for listings for the business indicated by the business name indicator 2310. As shown, the various attribute values that can be entered include a business name, a phone, a website, an address, a city name, a state, and a zip code. The attribute values shown in business listing correction interface 2300 are not exhaustive with regards to all embodiments of the invention. Different embodiments may provide additional business listing correction attribute values, such as (but not limited to) name of owner/operator, hours of operation, and/or fax number. The submit listing button 2330 can instruct the CI system providing the business listing correction interface 2300 to propagate the entered information to various listing locations. CI systems in accordance with many embodiments of the invention automatically propagate the entered information with no further input from the merchant user. CI systems can automate this process to provide a convenient method of correcting erroneous or missing business listings information.

The screenshot of listing correction interface 2300 shown in FIG. 23A shows only a single possible configuration in accordance with an embodiment of the invention. As can be appreciated, any of a variety of listing correction forms and/or options can be provided as appropriate to the requirements of specific applications in accordance with embodiments of the invention.

As described above in connection with the screenshots shown in FIGS. 22 and 23A, embodiments of the invention can provide interfaces through which users can correct business listings. CI systems in accordance with numerous embodiments of the invention can perform processes for correcting business listings information. Such processes can be performed with interface objects are interacted with, such as the “Fix It” button 2240 as shown in FIG. 22. As previously discussed, typical businesses often have large amounts of errors in online listings websites and/or directories. Through a simple user interface, CI systems in accordance with embodiments of the invention can provide an easy to use method of correcting large numbers of incorrect business listings.

A process 2350 to correct business listing information in accordance with an embodiment of the invention is illustrated in FIG. 23B. Correct listing information for a business can be received (2355). Correct listing information can be received in a variety of ways in various embodiments of the invention. A user can provide correct listing information for a business. Alternatively, some embodiments of the invention can assess and generate the correct listing information for a business using the information management techniques described above. For instance, an authoritative information set for a particular business can include the correct listing information for the business. Correct listing information can include (but is not limited to) hours of operation, physical addresses, phone numbers, email addresses, and/or website locations.

Listings associated with the business can be identified (2360). Different embodiments of the invention can utilize different techniques for identifying listings associated with a business. In some embodiments, merged, related, and authoritative information sets for various entities can provide the connections between the identity of a business and its various listings across listing sources. For example, the merged information sets for a business entity can include the listings sources associated with the business entity. Listing sources can include (but are not limited to) websites, directories, online review sites, social media sites, and/or search websites.

The identified listings can be assessed (2365) for accuracy. The accuracy can be assessed via direct comparison of the listed information within the listing sources to the received correct listing information. Some embodiments can optionally provide (2370) a summary of the accuracy of the identified listings. An example of a summary of the accuracy of the identified listings is shown in business listing review interface 2200 of FIG. 22. An interface prompt to allow correction of the incorrect listings can optionally be provided (2375). Example of interface prompts to allow correction of incorrect listings include “fix it” button 2240 shown in business listing review interface 2200 of FIG. 22 and the “submit listing” button 2330 illustrated in FIG. 23A. Correct listing information can be output (2380) to business listing sources. Typically, output of correct listing information depends on user into to a user interface element. However, some embodiments can provide automatic correction of listing information without specific user input.

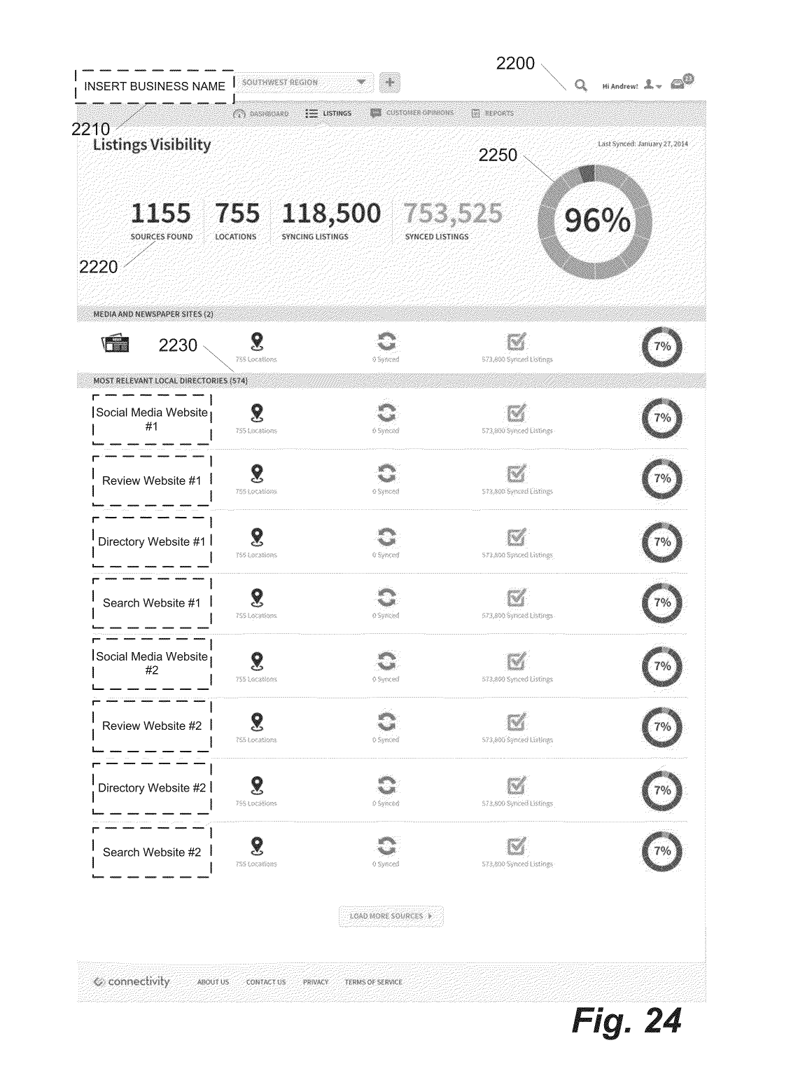

FIG. 24 shows business listing review interface 2200 from FIG. 22 after the pressing of the “submit listing” button 2330 illustrated in FIG. 23A. As shown, listing visibility table 2220 has been substantially updated to shown 753,525 synced listings. Of the total listings detected by the CI system providing business listing review interface 2200, correct listing indicator 2250 finds 96% of the listings to be correct after propagation and syncing. In order to produce these higher correct listing rating, the CI system providing business listing review interface 2200 has propagated the previously entered correct listings information to various websites; including those shown in most relevant local directory listings 2230.

The screenshots of business listing review interface 2200 shown in FIGS. 22 and 24 show only a single possible configuration in accordance with an embodiment of the invention. As can be appreciated, any of a variety of business listing review options and/or displays can be provided as appropriate to the requirements of specific applications in accordance with embodiments of the invention.

### Reputation Management

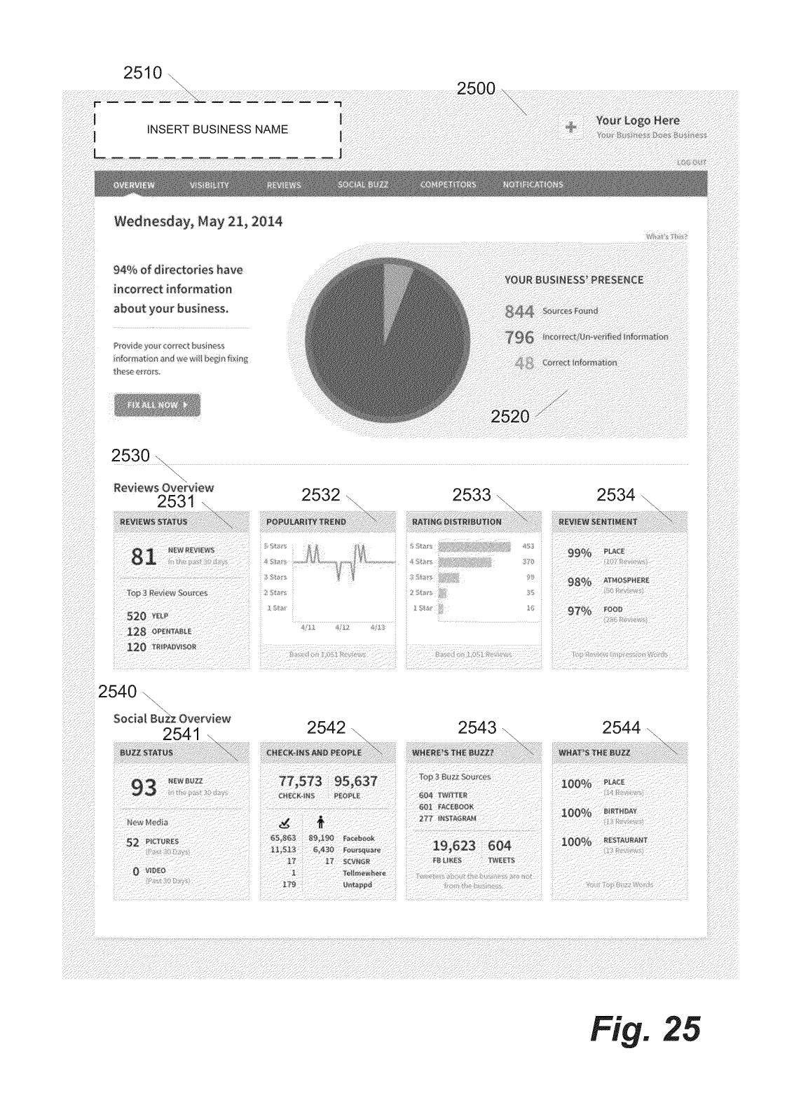

Internet reviews are often the basis for consumer choices between competing businesses. The management of online reputations has become a major component of online marketing. Accordingly, embodiments of the invention provide interfaces by which business owners and survey online business reviews and also communicate through the channels provided by the sites hosting the online business reviews. FIG. 25 shows a user interface with a reputation management interface 2500. The reputation management interface 2500 enables a merchant user to quickly and powerfully survey social media customer interactions with the merchant user's business. Reputation management interface 2500 includes business name indicator 2510, business presence indicator 2520, a reviews overview 2530, and a social buzz overview 2540. The business presence indicator 2520 provides a summary of the online presence for the business indicated by the business name indicator 2510. The reviews overview 2530 provides an overview of reviews identified using the CI operations discussed above. The reviews overview 2530 includes a reviews status table 2531 showing new reviews and top review sources. The reviews overview 2530 also includes a popularity trend 2532 showing recent reviews in graphical form. The reviews overview 2530 also includes a ratings distribution table 2533 showing the balances of one to five star reviews. In addition the reviews overview 2530 also includes a review sentiment table 2534 showing the top review impression words from the identified reviews. The social buzz overview 2540 includes a buzz status table 2541 indicating how many media and buzz incidences have occurred in the past 30 days. The social buzz overview 2540 also includes a check-ins and people summary 2542 indicating quantities of check-ins and people (i.e., customers). The social buzz overview 2540 also includes a “where's the buzz?” table 2543 that indicates social media websites or applications from which the buzz originates. The social buzz overview 2540 also includes a “what's the buzz” table 2544 indicating key words from the social media buzz identified as relating to the business indicated by business name indicator 2510.

The screenshot of reputation management interface 2500 shown in FIG. 25 shows only a single possible configuration in accordance with an embodiment of the invention. As can be appreciated, any of a variety of screenshot of listing correction interface submission forms and/or options can be provided as appropriate to the requirements of specific applications in accordance with embodiments of the invention.

### Customer Feedback Inbox

The Internet has provided new and powerful tools to enable customers and businesses to communicate. Where the old model of customer feedback involves phone calls or paper messages dropped in the box, the Internet enables direct communication between customers and businesses via electronic platforms.

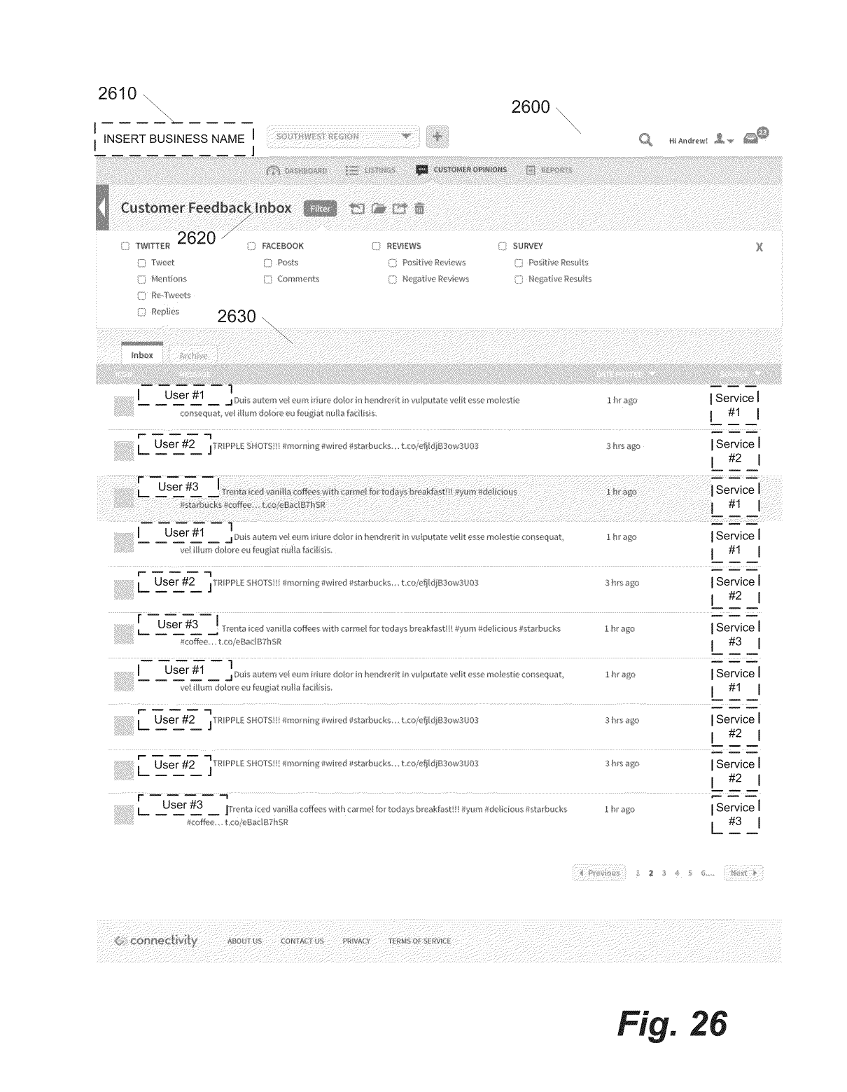

Accordingly, embodiments of the invention provide for a customer feedback platform that aggregates and displays customer feedback from multiple social media websites and/or applications. FIG. 26 shows a user interface with a customer feedback interface 2600. The web servers of CI systems of multiple embodiments generate the user interface shown FIG. 26. The customer feedback interface 2600 enables a merchant user to survey feedback from customers as it occurs over any social media website or application. Specifically, the customer feedback interface 2600 organizes discussions of a particular business as email to the particular business. Customer feedback interface 2600 includes business name indicator 2610, a customer feedback inbox 2620, and a customer feedback listing 2630. The customer feedback inbox 2620 enables selection of various social media websites and applications to serve as filters on customer feedback. The customer feedback listing 2630 shows the selected (in this case all the most recent) customer feedback in an email-style fashion. CI systems of some embodiments of the invention relate information sets gathered from consumers to businesses based on content correlations between the information sets and the names of business. As shown, the listed customer feedback in customer feedback listing 2630 correlate with the business indicated by the business name indicator 2610.

The screenshot of customer feedback interface 2600 shown in FIG. 26 shows only a single possible configuration in accordance with an embodiment of the invention. As can be appreciated, any of a variety of customer feedback folders, menus, and/or text options can be provided as appropriate to the requirements of specific applications in accordance with embodiments of the invention.

### Basic Architectures for Implementing Servers for the CI Systems of Some Embodiments

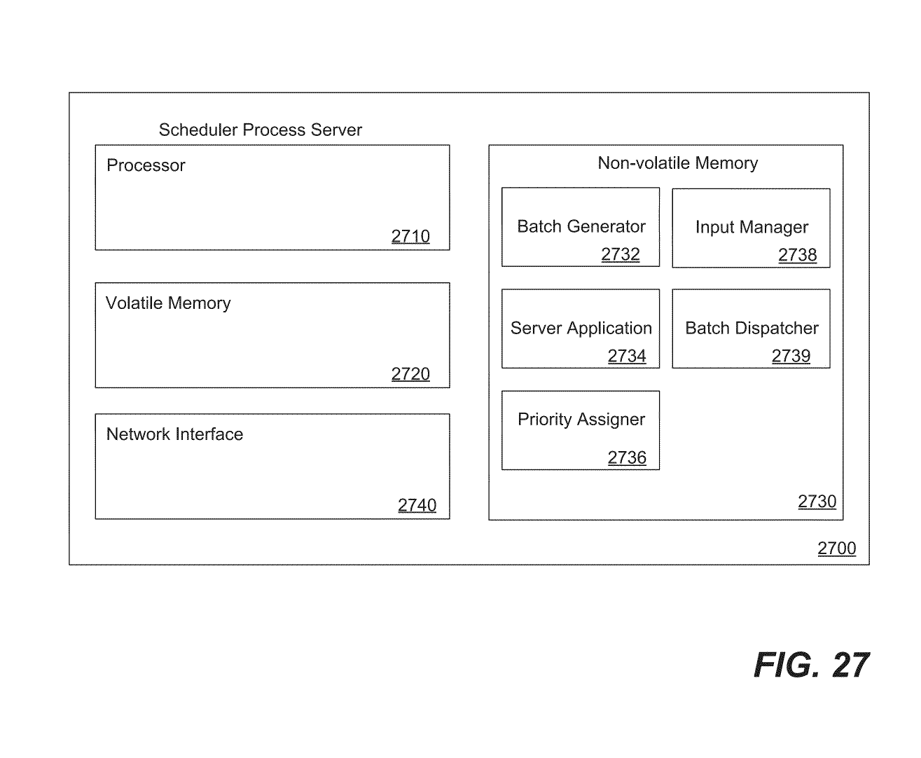

CI systems in accordance with various embodiments of the invention rely on server hardware and/or software to be implemented. The various processes described above can be implemented using any of a variety of server system architectures. Specific server systems that can be utilized to implement CI systems in accordance with embodiments of the invention and implement the various processes illustrated above are described below. Specifically, FIGS. 27-34 discuss several server systems that can be used to implement and/or perform processes in accordance with embodiments of the invention.

An architecture of a scheduler process server in accordance with an embodiment of the invention is illustrated in FIG. 27. The scheduler process server 2700 includes a processor 2710 in communication with non-volatile memory 2730, volatile memory 2720, and a network interface 2740. In the illustrated embodiment, the non-volatile memory includes a batch generator 2732, a server application 2734, a priority assigner 2736, and an input manager 2738. The batch generator 2732 generates batches of crawls to be transmitted to crawler process servers that gather information from information sources. The server application 2734 provides the run-time, support, and/or operating systems functionality necessary to run the scheduler process server 2700. The priority assigner 2736 assigns priorities to generated batches of crawls. The input manager 2738 manages input from various CI system operations and functionalities. Specifically, the input manager 2738 parses receives queries to the CI systems for attribute values that can be the basis of crawls for further information relevant to the queries. In addition, the input manager 2738 receives input from merger, authoritative information set generation, and relationship processes that suggest information to use in generating additional batches of crawls. The batch dispatcher 2739 dispatches generated and prioritized batches of crawls to one or more crawler process server system. In several embodiments, the network interface 2740 may be in communication with the processor 2710, the volatile memory 2720, and/or the non-volatile memory 2730. Although a specific scheduler process server architecture is illustrated in FIG. 27, any of a variety of architectures including architectures where the scheduler process is located on disk or some other form of storage and is loaded into volatile memory at runtime can be utilized to implement scheduler process servers in accordance with embodiments of the invention.

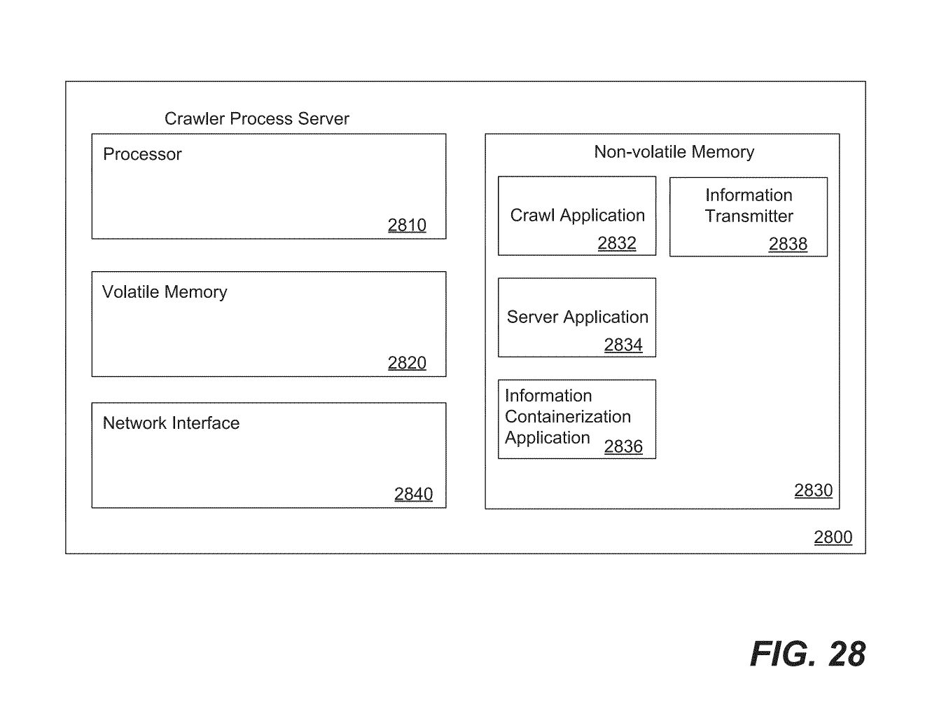

An architecture of a crawler process server in accordance with an embodiment of the invention is illustrated in FIG. 28. The crawler process server 2800 includes a processor 2810 in communication with non-volatile memory 2830, volatile memory 2820, and a network interface 2840. In the illustrated embodiment, the non-volatile memory includes a crawl application 2832, a server application 2834, an information containerization application 2836, and an information transmitter 2838. The crawl application 2832 executes batches of crawls for information from information sources. The server application 2834 provides the run-time, support, and/or operating systems functionality necessary to run the crawler process server 2800. The information containerization application 2836 containerizes gathered information where appropriate. The containerized information is transmitted as information sets to a crawler database by the information transmitter 2838. In several embodiments, the network interface 2840 may be in communication with the processor 2810, the volatile memory 2820, and/or the non-volatile memory 2830. Although a specific crawler process server architecture is illustrated in FIG. 28, any of a variety of architectures including architectures where the crawler process is located on disk or some other form of storage and is loaded into volatile memory at runtime can be utilized to implement crawler process servers in accordance with embodiments of the invention.

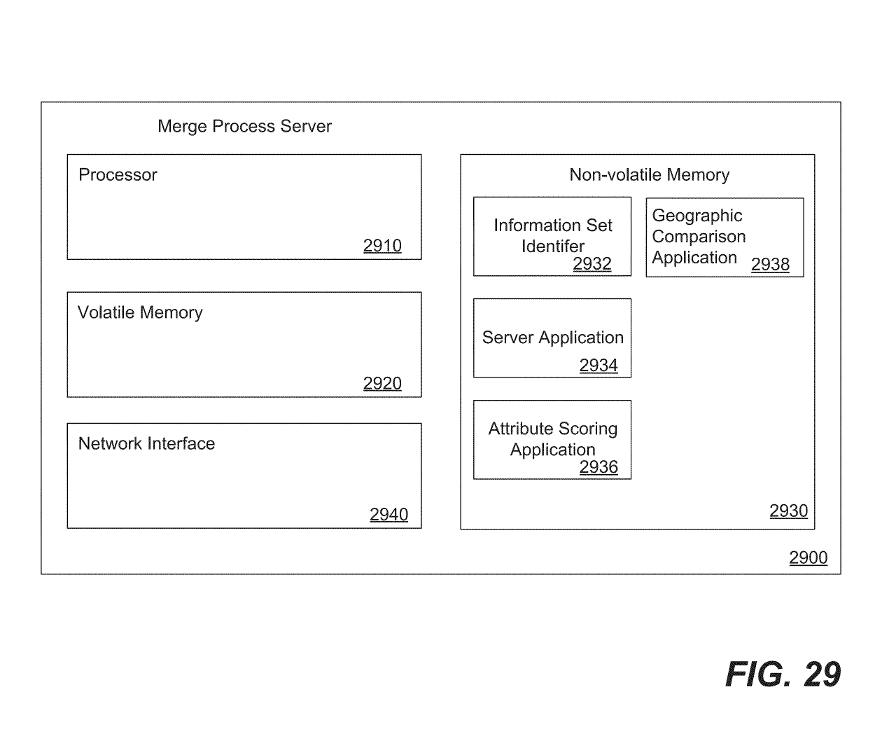

An architecture of a merge process server in accordance with an embodiment of the invention is illustrated in FIG. 29. The merge process server 2900 includes a processor 2910 in communication with non-volatile memory 2930, volatile memory 2920, and a network interface 2940. In the illustrated embodiment, the non-volatile memory includes an information set identifier 2932, a server application 2934, an attribute scoring application 2936, and a geographic comparison application 2938. The information set identifier 2932 identifies sets of information for potential merging. In numerous embodiments, the information set identifier 2932 identifies correlations between information sets. Alternatively, the information set identifier 2932 may simply receive information sets to consider for merging from another process server. The server application 2934 provides the run-time, support, and/or operating systems functionality necessary to run the merge process server 2900. The attribute scoring application 2936 compares and scores attribute values from identified information sets for potential merging. The geographic comparison application 2938 runs geographic comparisons between geocodes and/or geographic location information for identified information sets. In several embodiments, the network interface 2940 may be in communication with the processor 2910, the volatile memory 2920, and/or the non-volatile memory 2930. Although a specific merge process server architecture is illustrated in FIG. 29, any of a variety of architectures including architectures where the merge process is located on disk or some other form of storage and is loaded into volatile memory at runtime can be utilized to implement merge process servers in accordance with embodiments of the invention.

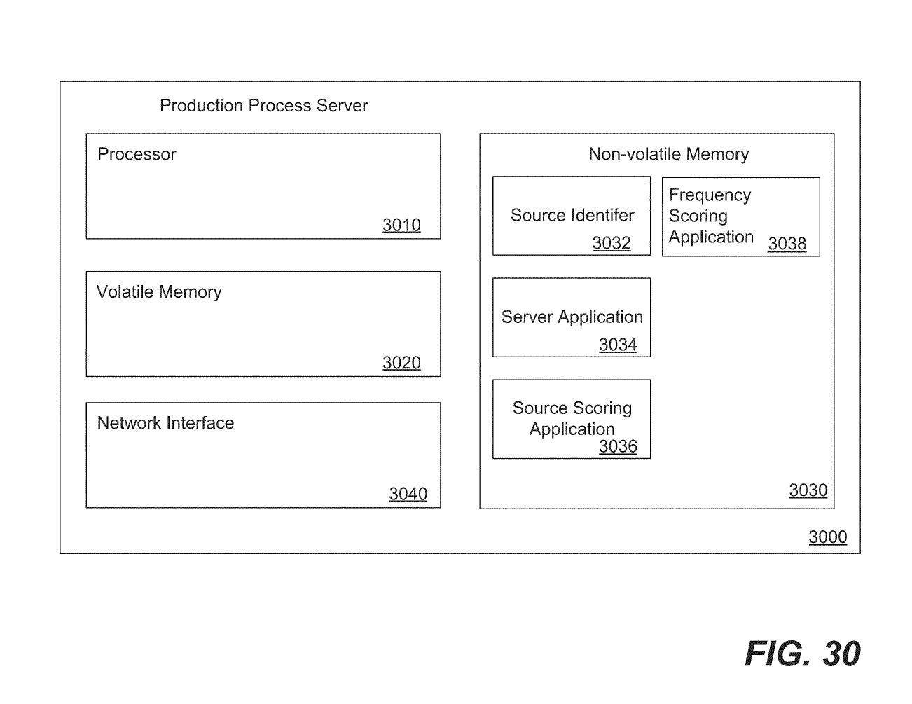

An architecture of a production process server in accordance with an embodiment of the invention is illustrated in FIG. 30. The production process server generates authoritative information sets for named entities. The production process server 3000 includes a processor 3010 in communication with non-volatile memory 3030, volatile memory 3020, and a network interface 3040. In the illustrated embodiment, the non-volatile memory includes source identifier 3032, a server application 3034, a source scoring application 3036, and a frequency scoring application 3038. The source 3032 identifies sources for sets of information. The server application 3034 provides the run-time, support, and/or operating systems functionality necessary to run the production process server 3000. The source scoring application 3036 compares and scores sources for information sets. The frequency scoring application 3038 scores the frequency of identical or at least similar attribute values across information sets. In several embodiments, the network interface 3040 may be in communication with the processor 3010, the volatile memory 3020, and/or the non-volatile memory 3030. Although a specific production process server architecture is illustrated in FIG. 30, any of a variety of architectures including architectures where the production process is located on disk or some other form of storage and is loaded into volatile memory at runtime can be utilized to implement production process servers in accordance with embodiments of the invention.

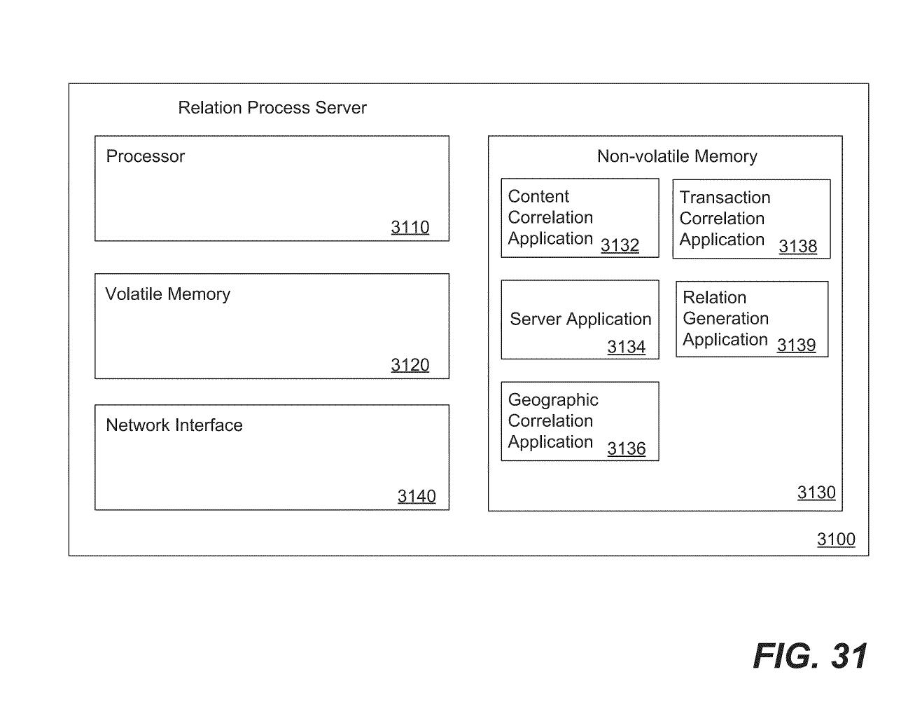

An architecture of a relation process server in accordance with an embodiment of the invention is illustrated in FIG. 31. The relation process server establishes relationships between information sets. The relation process server 3100 includes a processor 3110 in communication with non-volatile memory 3130, volatile memory 3120, and a network interface 3140. In the illustrated embodiment, the non-volatile memory includes a content correlation application 3132, a server application 3134, a geographic correlation application 3136, a transaction correlation application 3138, and a relation generation application 3139. The content correlation application 3132 identifies content correlations between information sets. Content correlations can be mentioning of entity names in multiple information sets, discussion of businesses in reviews by consumers, similar times and listed locations for information sets, and/or similar metadata. The server application 3134 provides the run-time, support, and/or operating systems functionality necessary to run the relation process server 3100. The geographic correlation application 3136 identifies geographic correlations between information sets, such as where information sets share similar geocodes. The transaction correlation application 3138 identifies transactions between information sets of different named entities. The relation generation application 3139 generates relationships between information sets and/or named entities based on the correlations identified by the other applications of the relation process server. In several embodiments, the network interface 3140 may be in communication with the processor 3110, the volatile memory 3120, and/or the non-volatile memory 3130. Although a specific relation process server architecture is illustrated in FIG. 31, any of a variety of architectures including architectures where the relation process is located on disk or some other form of storage and is loaded into volatile memory at runtime can be utilized to implement relation process servers in accordance with embodiments of the invention.

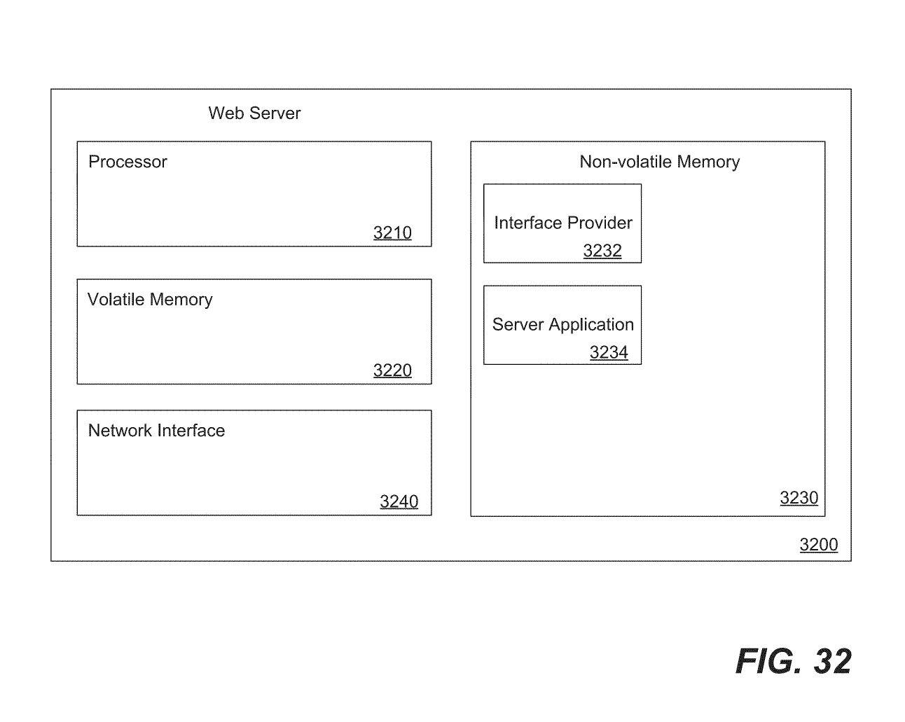

An architecture of a web server in accordance with an embodiment of the invention is illustrated in FIG. 32. The web server provides web and internet functionality for an associated CI system. The web server 3200 includes a processor 3210 in communication with non-volatile memory 3230, volatile memory 3220, and a network interface 3240. In the illustrated embodiment, the non-volatile memory includes an interface provider 3232 and a server application 3234. The interface provider 3232 provides interfaces and returns required information for customer lists, customer profiles, typical customer profiles, automated campaign message services, reputation management applications, business listings management applications, and social media inboxes. The server application 3234 provides the run-time, support, and/or operating systems functionality necessary to run the web server 3200. In several embodiments, the network interface 3240 may be in communication with the processor 3210, the volatile memory 3220, and/or the non-volatile memory 3230. Although a specific web server architecture is illustrated in FIG. 32, any of a variety of architectures including architectures where an application that generates a user interface and/or provides data for generation of a user interface with a client application is located on disk or some other form of storage and is loaded into volatile memory at runtime can be utilized to implement web servers in accordance with embodiments of the invention.

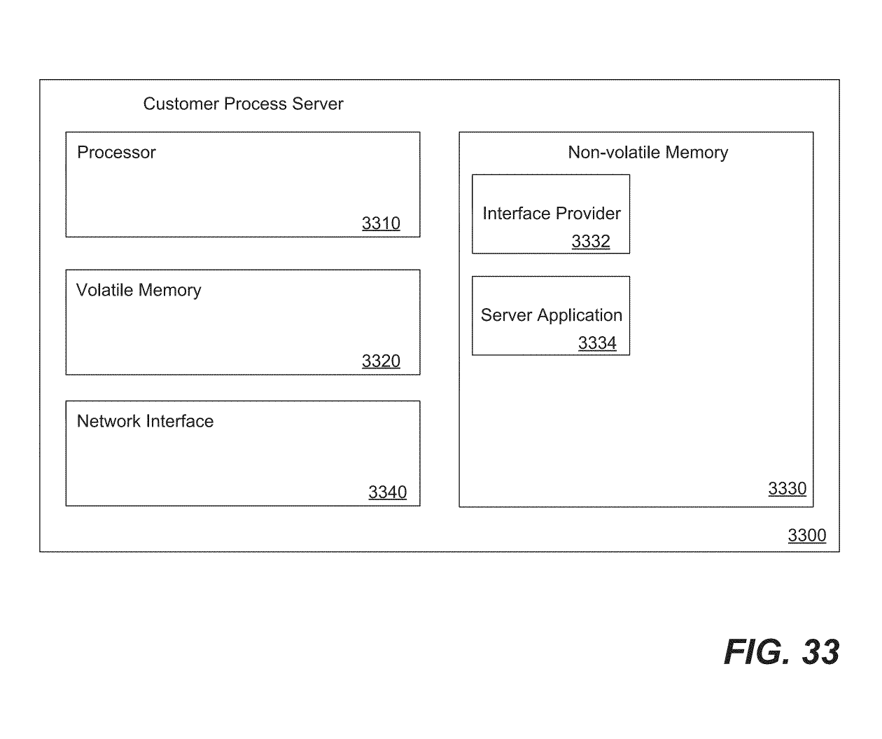

An architecture of a customer process server in accordance with an embodiment of the invention is illustrated in FIG. 33. The customer process server identifies current and/or potential customers of businesses. The customer process server 3300 includes a processor 3310 in communication with non-volatile memory 3330, volatile memory 3320, and a network interface 3340. In the illustrated embodiment, the non-volatile memory includes an interface provider 3332 and a server application 3334. The interface provider 3332 provides interfaces and returns required information for customer information. The server application 3334 provides the run-time, support, and/or operating systems functionality necessary to run the customer process server 3300. In several embodiments, the network interface 3340 may be in communication with the processor 3310, the volatile memory 3320, and/or the non-volatile memory 3330. Although a specific customer process server architecture is illustrated in FIG. 33, any of a variety of architectures including architectures where an application that generates a user interface and/or provides data for generation of a user interface with a client application is located on disk or some other form of storage and is loaded into volatile memory at runtime can be utilized to implement customer process servers in accordance with embodiments of the invention.

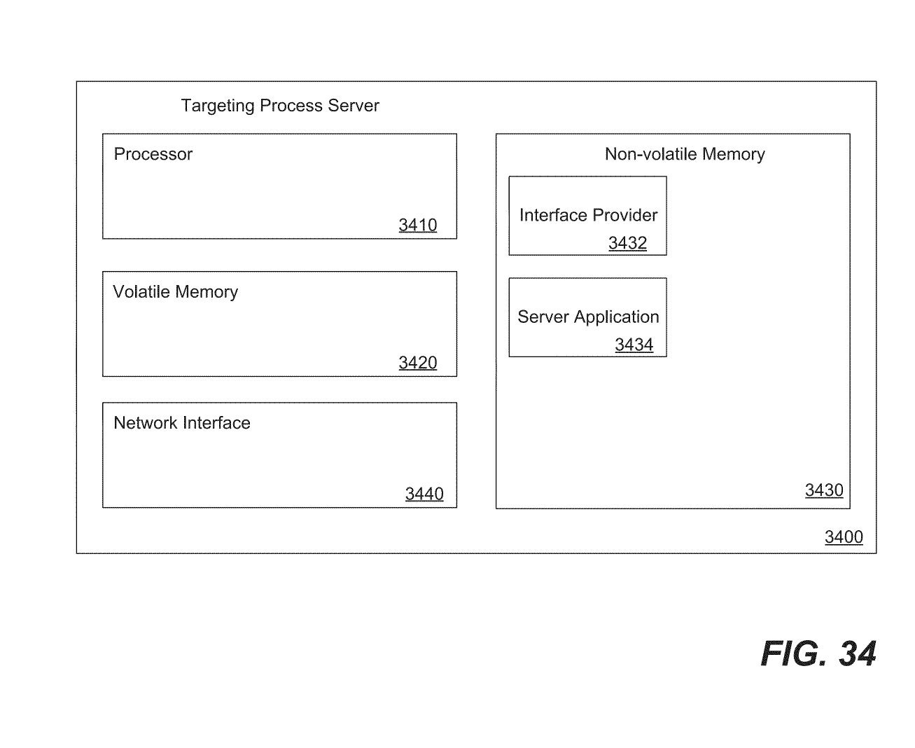

An architecture of a targeting process server in accordance with an embodiment of the invention is illustrated in FIG. 34. The targeting process server generates advertising targeting data. The targeting process server 3400 includes a processor 3410 in communication with non-volatile memory 3430, volatile memory 3420, and a network interface 3440. In the illustrated embodiment, the non-volatile memory includes an interface provider 3432 and a server application 3434. The interface provider 3432 provides interfaces and outputs generated advertising targeting data. The server application 3434 provides the run-time, support, and/or operating systems functionality necessary to run the targeting process server 3400. In several embodiments, the network interface 3440 may be in communication with the processor 3410, the volatile memory 3420, and/or the non-volatile memory 3430. Although a specific targeting process server architecture is illustrated in FIG. 34, any of a variety of architectures including architectures where an application that generates a user interface and/or provides data for generation of a user interface with a client application is located on disk or some other form of storage and is loaded into volatile memory at runtime can be utilized to implement targeting process servers in accordance with embodiments of the invention.

The various process servers discussed above can be implemented as singular, discrete servers. Alternatively, they can each be implemented as shared and/or discrete servers on any number of physical, virtual, or cloud computing devices. For instance, the merge and production process servers can be implemented as a single cluster of physical machines whereas the relation process server can be implemented as a distinct physical machine. Persons of ordinary skill in the art will recognize that various implementations methods may be used to implement the process servers of embodiments of the invention.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

1. A method of generating user targeting data, the method comprising:
gathering sets of characteristic data from a plurality of different types of remote electronic information sources using a targeting data generation system, wherein the characteristic data comprises data selected from the group comprising unique identifiers, geographic location data, and text data;
storing the gathered sets of characteristic data in a crawler database using the targeting data generation system;
receiving information using the targeting data generation system, where the received information includes:
advertising targeting information defining at least one targeting criterion; and
information identifying a specific service configured to present programmatic advertisements targeted toward individual users of the service that are identified using user identifiers;
merging sets of characteristic data stored in the feeds database and gathered by the targeting data generation system to create merged information sets for given named entities, where the merged information sets are associated with specific named entities in a customer database maintained by the targeting data generation system, where the merged information sets associated with a specific named entity in the customer database include characteristic data describing the specific named entity and the characteristic data includes user identifiers for users of the specific service, and wherein merging sets of characteristic data to create merged information sets further comprises:
merging sets of characteristic data in the feeds database that contain matching unique identifiers;
merging sets of characteristic data in the feeds database that do not contain matching unique identifiers based on a comparison of geographical location data, wherein the comparison of geographic location data comprises:
determining a distance between geographic locations contained in geographic location data included in a first set of characteristic data and a second set of characteristic data in the feeds database; and
merging the first set of characteristic data with the second set of characteristic data to create a merged information set when the determined distance is within a threshold distance;
identifying, using the targeting data generation system, named entities in the customer database satisfying the at least one targeting criterion, wherein the at least one targeting criterion is selected from a group comprising demographic targeting criteria, location targeting criteria, and keyword targeting criteria;
retrieving characteristic data describing the named entities in the customer database identified as satisfying the at least one targeting criterion using the targeting data generation system;
determining at least one user identifier for a user of the specific service from the retrieved characteristic data using the targeting data generation system; and
generating user targeting data for an online advertising campaign on the specific service based upon the at least one user identifier for a user of the specific service using the targeting data generation system.

2. The method of claim 1, wherein retrieving characteristic data describing the named entities in the customer database comprises retrieving characteristic data describing at least one user identifier for a user of the specific service selected from the group consisting of: a user identity on a service associated with one of the identified named entities; a mobile phone number associated with one of the identified named entities; and an email address associated with one of the identified named entities.

3. The method of claim 2, wherein generating user targeting data for an online advertising campaign on the specific service using the at least one user identifier for a user of the specific service comprises generating at least one piece of user targeting data selected from the group consisting of: a user identity on the service, a user identifier (ID), a value generated using a mobile phone number associated with one of the identified named entities; and a value generated using an email address associated with one of the identified named entities.

4. The method of claim 1, wherein:
the at least one targeting criterion includes a location criterion identifying a specific location;
characteristic data describing named entities in the customer database includes geographic location data; and
identifying named entities in the customer database satisfying the location criterion comprises identifying relationships between named entities in the customer database and the specific location based upon the merged information sets for a particular named entity comprising characteristic data including geographic location data corresponding to the specific location.

5. The method of claim 4, wherein the geographic location data is at least one piece of geographic location data selected from the group consisting of: a country, a state, a residential address, an employment address, a zone improvement plan (ZIP) code, an Internet Protocol (IP) address, a Global Positioning System measurement, cell tower identifiers (IDs), a list of Medium Access Control (MAC) addresses for wireless networking (WIFI) access points, a geocode, a location history reported by a mobile device, a location history associated with a MAC address used by a mobile device, registering at a specific location via a location based service, a search query related to a specific location, a search query bounded to a specified geographic location, a navigation request, a transportation record generated by a shared ride service, a transaction record associated with a specific geographic location and a universal resource locator (URL) corresponding to a specific geographic location.

6. The method of claim 4, wherein identifying relationships between named entities in the customer database and the specific location further comprises identifying named entities in the customer database that are likely to be present at the specific location at a future time using the targeting data generation system.

7. The method of claim 6, wherein identifying named entities in the customer database that are likely to be present at the specific location at a future time comprises:
retrieving characteristic data describing residential addresses of the identified named entities from the customer database;
retrieving characteristic data describing geographic location data indicating locations of the identified named entities from the customer database at times within a specific time period;
identifying named entities from the customer database as having a relationship with the specific location when at least on condition is satisfied from the group consisting of:
a residential address of a named entity corresponds to the specific location; and
the geographic location data indicates that a named entity was located within the specific location during the specific time period.

8. The method of claim 1, wherein:
the at least one targeting criterion includes a demographic criterion identifying a specific demographic;
the characteristic data describing named entities in the customer database includes demographic information; and
identifying named entities in the customer database satisfying the demographic criterion comprises:
retrieving characteristic data describing demographic information concerning specific named entities from the customer database; and
identifying specific named entities that are within the specific demographic based upon the retrieved characteristic data.

9. The method of claim 8, wherein the characteristic data describing demographic information concerning specific named entities retrieved from the customer database comprises characteristic data describing at least one characteristic of a named entity selected from the group consisting of language, age, and gender.

10. The method of claim 8, wherein the characteristic data describing demographic information concerning specific named entities retrieved from the customer database comprises characteristic data describing at least one interest of a named entity.

11. The method of claim 1, wherein:
the at least one targeting criterion includes a keyword criterion identifying a specific keyword;
characteristic data describing named entities in the customer database includes at least one keyword; and
identifying named entities in the customer database satisfying the keyword criterion comprises identifying specific entities that are described by characteristic data that includes the specific keyword.

12. The method of claim 11, wherein the characteristic data that includes the specific keywords comprises characteristic data selected from the group consisting of characteristic data having values describing interests of the identified named entities; and characteristic data having values describing activities performed by the identified named entities.

13. The method of claim 1, wherein identifying named entities in the customer database satisfying the at least one targeting criterion further comprises filtering named entities in accordance with at least one filtering criterion.

14. The method of claim 13, wherein the at least one filtering criterion is selected from the group consisting of a score, an average transaction value, a transaction frequency, and a residential address.

15. The method of claim 1, wherein merging sets of characteristic data gathered by a targeting data generation system from multiple remote electronic information sources to create merged information sets for given named entities comprises:
obtaining at least one initial piece of identifying information for a given named entity using the targeting data generation system;
building an identifying information set based on the at least one initial piece of identifying information using the targeting data generation system by gathering additional identifying information that describes characteristics of the given named entity from a plurality of information sources, where the identifying information set includes geographic location data;
repeatedly:
querying a plurality of remote electronic information sources using the targeting data generation system, where queries provided to the plurality of remote electronic information sources contain at least the geographic location data included in the identifying information set;
receiving at least one information set from the plurality of remote electronic information sources using the targeting data generation system, where the at least one received information set comprises characteristic data describing at least the given named entity and the characteristic data includes geographic location data; and
merging at least a subset of the received at least one information set with the identifying information set for the given named entity to create merged information sets for the given named entity that are stored in the feeds database using the targeting data generation system, where the targeting data generation system merges at least one given information set with the identifying information set for the given named entity based upon a comparison of geographic location data included in the at least one given information set and geographic location data included within the identifying information set.

16. The method of claim 15, wherein merging sets of characteristic data gathered by a targeting data generation system from multiple remote electronic information sources to create merged information sets for given named entities further comprises:
selecting characteristic data from the merged information sets to be used in an authoritative information set for the given named entity using the targeting data generation system, where the targeting data generation insight system selects at least one piece of characteristic data as part of an authoritative information set based upon at least one factor including a comparison of geographic location data associated with each of a plurality of different pieces of characteristic data that provide conflicting descriptions of a specific characteristic of the given named entity; and
storing the authoritative information set in a production database using the targeting data generation system, wherein the production database stores authoritative information sets for a plurality of named entities generated using the merged information sets for the plurality of named entities maintained in the feeds database.

17. The method of claim 16, where the targeting data generation system selects at least one piece of characteristic data as part of the authoritative information set based upon at least one factor including:
counting the number of times a characteristic data value is repeated within the merged information sets for the given named entity using the targeting data generation system; and
weighting the counts of the number of times a characteristic data value is repeated within the merged information sets for the given named entity based upon scores of the relative reliability of remote electronic information sources of the characteristic data within the merged information sets using the targeting data generation system, where the targeting data generation system maintains and updates the scores of the relative reliability of remote electronic information sources over successive query operations.

18. The method of claim 16, where the targeting data generation system merges at least one given information set with the identifying information set for the given named entity based upon a comparison of geographic location data included in the at least one given information set and geographic location data included within the identifying information set by:
determining at least one distance between the geographic location data included in the at least one given information set and the geographic location data included within the identifying information set using the targeting data generation system; and
comparing the determined at least on distance to a threshold for merging sets of characteristic data using the targeting data generation system.

19. The method of claim 18, where determining at least one distance using the targeting data generation system comprises generating geographic coordinates from the geographic location data included in the at least one given information set and the geographic location data included within the identifying information set.

20. The method of claim 16, wherein the identifying information set includes at least one name, at least one address, and at least one phone number for the given named entity.

21. The method of claim 16, wherein the geographic location data included in the identifying information set comprises at least one piece of information selected from the group consisting of an address, a geographic coordinate, a latitude and longitude coordinate pair, and relative location information.

22. The method of claim 16, wherein selecting characteristic data from the merged information sets to be used in the authoritative information set further comprises selecting a first piece of characteristic data from a first information set received from a first remote electronic information source and a second piece of characteristic data describing a different characteristic of the given named entity from a second remote electronic information source using the targeting data generation system.

23. The method of claim 16, wherein:
the feeds database and the production database include named entity type definitions for different types of entities; and
each type definition include a base set of characteristic data fields.

24. The method of claim 23, wherein the named entity type definitions include at least one named entity type definition selected from the group consisting of a business named entity, a person named entity, a location named entity, a customer entity, an event entity, a brand entity, and an object named entity.

25. The method of claim 1, wherein the remote electronic information sources include at least one remote electronic information source selected from the group consisting of a search engine service, an online directory, a review website, a website, a server log, an email service, a messaging service, and a social media service.

26. The method of claim 1, wherein the merged information sets of a given named entity in the feeds database include at least one piece of information selected from the group consisting of: scrapes of web pages containing descriptions of a named entity; email messages obtained from email accounts associated with a named entity; phone logs for telephone accounts associated with a named entity; reviews associated with a named entity; checkins via location based social media services; likes, follows, and/or followers of user identities on social media services associated with a named entity; mentions of a named entity in posts to social media services; mobile application data from mobile devices associated with a named entity; and server logs of servers associated with a named entity.

27. The method of claim 1, wherein the at least one targeting criterion comprises a plurality of targeting criteria selected from the group consisting of a location criterion, a demographic criterion, and a keyword criterion.

28. The method of claim 1, further comprising outputting the user targeting information as part of an online advertising campaign built using the targeting data generation system to at least one advertising network selected from the group consisting of a display advertising network, a search advertising network, a social media service advertising network, and a location based advertising network using the targeting data generation system.

29. A targeting data generation system, comprising:
at least one processing unit;
a memory storing a targeting data generation application;
wherein the targeting data generation application directs the at least one processing unit to:
gather sets of characteristic data from a plurality of different types of remote electronic information sources, wherein the characteristic data comprises data selected from the group comprising unique identifiers, geographic location data, and text data;
store the gathered sets of characteristic data in a crawler database;
receive information including:
advertising targeting information defining at least one targeting criterion; and
information identifying a specific service configured to present programmatic advertisements targeted toward individual users of the service that are identified using user identifiers;
merge sets of characteristic data gathered to create merged information sets for given named entities, where the merged information sets are associated with specific named entities in a customer database, where the merged information sets associated with a specific named entity in the customer database include characteristic data describing the specific named entity and the characteristic data includes user identifiers for users of the specific service, and wherein merging sets of characteristic data to create merged information sets further comprises:
merging sets of characteristic data in the feeds database that contain matching unique identifiers;
merging sets of characteristic data in the feeds database that do not contain matching unique identifiers based on a comparison of geographical location data, wherein the comparison of geographic location data comprises:
determining a distance between geographic locations contained in geographic location data included in a first set of characteristic data and a second set of characteristic data in the feeds database; and
merging the first set of characteristic data with the second set of characteristic data to create a merged information set when the determined distance is within a threshold distance;
identify named entities in the customer database satisfying the at least one targeting criterion, wherein the at least one targeting criterion is selected from a group comprising demographic targeting criteria, location targeting criteria, and keyword targeting criteria;
retrieve characteristic data describing the named entities in the customer database identified as satisfying the at least one targeting criterion;
determine at least one user identifier for a user of the specific service from the retrieved characteristic data; and
generate user targeting data for an online advertising campaign on the specific service based upon the at least one user identifier for a user of the specific service.

30. (canceled)
